(19) United States
(12) Patent Application Publication
(10) Pub. No.: US 2026/0295436 A1
(43) Pub. Date: Oct. 1, 2026

(54) SYSTEM AND METHOD FOR INTERFACING DIGITAL PLATFORM WITH EXISTING ECOSYSTEM TO ENABLE PEER-TO-PEER INTERACTIONS

(71) Applicant: Pony Up, LLC, Dallas, TX (US)

(72) Inventors: Brian Despie, Dallas, TX (US); Connor Despie, Dallas, TX (US); Mark Stanley, University Park, TX (US)

(21) Appl. No.: 19/574,583

(22) Filed: Mar. 23, 2026

Related U.S. Application Data
(60) Provisional application No. 63/779,972, filed on Mar. 28, 2025.
(60) Provisional application No. 63/903,737, filed on Oct. 22, 2025.

(51) Int. Cl. A63F 13/71; A63F 13/73; A63F 13/792; G06N 3/044; G06N 3/0464

(52) U.S. Cl. CPC A63F 13/71; A63F 13/73; A63F 13/792; G06N 3/044; G06N 3/0464

(57) ABSTRACT

A method includes receiving, via an encrypted connection and based on a determination that an application programming interface (API) integration is not available for gameplay content, a video stream of the gameplay content captured from a client device. The method also includes processing the video stream by an encoder to extract key frames from the video stream. The method also includes applying, using at least one machine learning model and the extracted key frames, machine learning classifiers trained on game-specific visual patterns to determine a gameplay result associated with the video stream. The method also includes generating, using the at least one machine learning model, a confidence score for the determined gameplay result. The method also includes transmitting, to the client device based on a determination that the confidence score is above a threshold, an outcome of a peer-to-peer challenge corresponding to the determined gameplay result.

### CROSS-REFERENCE TO RELATED APPLICATION AND PRIORITY CLAIM

This application claims priority under 35 U.S.C. § 119(e) to U.S. Provisional Patent Application No. 63/779,972 filed on Mar. 28, 2025, and U.S. Provisional Patent Application No. 63/903,737, filed on Oct. 22, 2025, which are hereby incorporated by reference in their entirety.

### TECHNICAL FIELD

This disclosure generally relates to internet communications systems and artificial intelligence systems. More specifically, this disclosure relates to a system and method for interfacing a digital platform with an existing ecosystem to enable peer-to-peer interactions.

### SUMMARY

This disclosure provides a system and method for interfacing a digital platform with an existing ecosystem to enable peer-to-peer interactions.

In some embodiments, a method includes receiving, via an encrypted connection and based on a determination that an application programming interface (API) integration is not available for gameplay content, a video stream of the gameplay content captured from a client device. The method also includes processing the video stream by an encoder to extract key frames from the video stream. The method also includes applying, using at least one machine learning model and the extracted key frames, machine learning classifiers trained on game-specific visual patterns to determine a gameplay result associated with the video stream. The method also includes generating, using the at least one machine learning model, a confidence score for the determined gameplay result. The method also includes transmitting, to the client device based on a determination that the confidence score is above a threshold, an outcome of a peer-to-peer challenge corresponding to the determined gameplay result.

In some embodiments, an electronic device includes at least one processor configured to receive, via an encrypted connection and based on a determination that an application programming interface (API) integration is not available for gameplay content, a video stream of the gameplay content captured from a client device. The at least one processor is also configured to process the video stream by an encoder to extract key frames from the video stream. The at least one processor is also configured to apply, using at least one machine learning model and the extracted key frames, machine learning classifiers trained on game-specific visual patterns to determine a gameplay result associated with the video stream. The at least one processor is also configured to generate, using the at least one machine learning model, a confidence score for the determined gameplay result. The at least one processor is also configured to instruct transmission, to the client device based on a determination that the confidence score is above a threshold, of an outcome of a peer-to-peer challenge corresponding to the determined gameplay result.

In some embodiments, a method for interfacing a digital platform with an existing ecosystem to enable peer-to-peer interactions includes interfacing an application plugin with one or more applications stored on an electronic device. The method also includes receiving, via the application plugin from a plurality of client devices, an agreement to perform a peer-to-peer interaction between the plurality of client devices. The method also includes confirming parameters for the peer-to-peer interaction. The method also includes receiving a communication regarding an outcome of one of the one or more applications stored on the electronic device. The method also includes reconciling the peer-to-peer interaction and communicating the reconciliation of the peer-to-peer interaction to the plurality of client devices.

In some embodiments, the peer-to-peer interaction includes a wager between at least two of the plurality of client devices, and the reconciliation of the peer-to-peer interaction includes providing, via the application plugin, funds associated with an amount of the wager to a selected one of the client devices.

In some embodiments, the method also includes converting, using the application plugin, the funds from one format associated with the application plugin to another format usable by the selected one of the client devices.

This disclosure provides various embodiments related to an application and an associated application programming interface (API) that can communicate with various electronic devices and digital platforms, such as digital platforms including personal computers (PCs), video game console hardware systems, mobile phones or other portable systems, operating systems, gaming or game application software, cloud based systems, etc.

The application of this disclosure allows user (e.g., players in a video game) to engage in friendly peer-to-peer interactions, such as wagering. The application can be web-, cloud- and/or application-based wagering platform with an API (Application Program Interface) that can be used as a plugin to other applications. To facilitate wagering, the application allows users to securely sign up and create a wallet used to wager.

Once a wager is solicited and accepted between users/players, the funds are placed in a secure escrow account until a winner is declared. In some embodiments of this disclosure, after a winner is declared, both parties must agree to release the funds, less any transactions fees to use the application. For example, in some embodiments, users can agree to a set a particular percentage transaction fee ahead of time, such as a part of agreeing to a EULA when setting up an account.

In some embodiments, the application acts as a plugin application and uses the API to confirm the winner and redistributed funds immediately. The systems described in this disclosure allow for conducting online (web), app-based, and digital wagering through a plugin or portal either independently or integrated into gaming platforms.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

As used here, terms and phrases such as “have,” “may have,” “include,” or “may include” a feature (like a number, function, operation, or component such as a part) indicate the existence of the feature and do not exclude the existence of other features. Also, as used here, the phrases “A or B,” “at least one of A and/or B,” or “one or more of A and/or B” may include all possible combinations of A and B. For example, “A or B,” “at least one of A and B,” and “at least one of A or B” may indicate all of (1) including at least one A, (2) including at least one B, or (3) including at least one A and at least one B. Further, as used here, the terms “first” and “second” may modify various components regardless of importance and do not limit the components. These terms are only used to distinguish one component from another. For example, a first user device and a second user device may indicate different user devices from each other, regardless of the order or importance of the devices. A first component may be denoted a second component and vice versa without departing from the scope of this disclosure.

It will be understood that, when an element (such as a first element) is referred to as being (operatively or communicatively) “coupled with/to” or “connected with/to” another element (such as a second element), it can be coupled or connected with/to the other element directly or via a third element. In contrast, it will be understood that, when an element (such as a first element) is referred to as being “directly coupled with/to” or “directly connected with/to” another element (such as a second element), no other element (such as a third element) intervenes between the element and the other element.

As used here, the phrase “configured (or set) to” may be interchangeably used with the phrases “suitable for,” “having the capacity to,” “designed to,” “adapted to,” “made to,” or “capable of” depending on the circumstances. The phrase “configured (or set) to” does not essentially mean “specifically designed in hardware to.” Rather, the phrase “configured to” may mean that a device can perform an operation together with another device or parts. For example, the phrase “processor configured (or set) to perform A, B, and C” may mean a generic-purpose processor (such as a CPU or application processor) that may perform the operations by executing one or more software programs stored in a memory device or a dedicated processor (such as an embedded processor) for performing the operations.

The terms and phrases as used here are provided merely to describe some embodiments of this disclosure but not to limit the scope of other embodiments of this disclosure. It is to be understood that the singular forms “a,” “an,” and “the” include plural references unless the context clearly dictates otherwise. All terms and phrases, including technical and scientific terms and phrases, used here have the same meanings as commonly understood by one of ordinary skill in the art to which the embodiments of this disclosure belong. It will be further understood that terms and phrases, such as those defined in commonly-used dictionaries, should be interpreted as having a meaning that is consistent with their meaning in the context of the relevant art and will not be interpreted in an idealized or overly formal sense unless expressly so defined here. In some cases, the terms and phrases defined here may be interpreted to exclude embodiments of this disclosure.

Examples of an “electronic device” according to embodiments of this disclosure may include at least one of a smartphone, a tablet, a personal computer (PC), a mobile phone, a video phone, an e-book reader, a desktop PC, a laptop computer, a netbook computer, a workstation, a personal digital assistant (PDA), a portable multimedia player (PMP), an MP3 player, a mobile medical device, a camera, or a wearable device (such as smart glasses, a head-mounted device (HMD), electronic clothes, an electronic bracelet, an electronic necklace, an electronic accessory, an electronic tattoo, a smart mirror, or a smart watch). Other examples of an electronic device include a smart home appliance. Examples of the smart home appliance may include at least one of a television, a digital video disc (DVD) player, an audio player, a refrigerator, an air conditioner, a cleaner, an oven, a microwave oven, a washer, a dryer, an air cleaner, a set-top box, a home automation control panel, a security control panel, a TV box, a smart speaker or speaker with an integrated digital assistant, a portable or home gaming console (such as an XBOX, PLAYSTATION, STEAM, or NINTENDO console), cloud based gaming consoles such a STEAM, Netflix Gaming, NVIDIA GEFORCE NOW, XBOX CLOUD GAMING, GOOGLE STADIA, PLAYSTATION PLUS and AMAZON LUNA, an electronic dictionary, an electronic key, a camcorder, or an electronic picture frame. Still other examples of an electronic device include at least one of various medical devices (such as diverse portable medical measuring devices (like a blood sugar measuring device, a heartbeat measuring device, or a body temperature measuring device), a magnetic resource angiography (MRA) device, a magnetic resource imaging (MRI) device, a computed tomography (CT) device, an imaging device, or an ultrasonic device), a navigation device, a global positioning system (GPS) receiver, an event data recorder (EDR), a flight data recorder (FDR), an automotive infotainment device, a sailing electronic device (such as a sailing navigation device or a gyro compass), avionics, security devices, vehicular head units, industrial or home robots, automatic teller machines (ATMs), point of sales (POS) devices, or Internet of Things (IoT) devices (such as a bulb, various sensors, electric or gas meter, sprinkler, fire alarm, thermostat, street light, toaster, fitness equipment, hot water tank, heater, or boiler). Other examples of an electronic device include at least one part of a piece of furniture or building/structure, an electronic board, an electronic signature receiving device, a projector, or various measurement devices (such as devices for measuring water, electricity, gas, or electromagnetic waves). Note that, according to various embodiments of this disclosure, an electronic device may be one or a combination of the above-listed devices. According to some embodiments of this disclosure, the electronic device may be a flexible electronic device. The electronic device disclosed here is not limited to the above-listed devices and may include new electronic devices depending on the development of technology.

In the following description, electronic devices are described with reference to the accompanying drawings, according to various embodiments of this disclosure. As used here, the term “user” may denote a human or another device (such as an artificial intelligent electronic device) using the electronic device.

Definitions for other certain words and phrases may be provided throughout this patent document. Those of ordinary skill in the art should understand that in many if not most instances, such definitions apply to prior as well as future uses of such defined words and phrases.

None of the description in this application should be read as implying that any particular element, step, or function is an essential element that must be included in the claim scope. The scope of patented subject matter is defined only by the claims. Moreover, none of the claims is intended to invoke 35 U.S.C. § 112(f) unless the exact words “means for” are followed by a participle. Use of any other term, including without limitation “mechanism,” “module,” “device,” “unit,” “component,” “element,” “member,” “apparatus,” “machine,” “system,” “processor,” or “controller,” within a claim is understood by the Applicant to refer to structures known to those skilled in the relevant art and is not intended to invoke 35 U.S.C. § 112(f).

### BRIEF DESCRIPTION OF THE DRAWINGS

For a more complete understanding of this disclosure and its advantages, reference is now made to the following description taken in conjunction with the accompanying drawings, in which like reference numerals represent like parts:

FIG. 1 illustrates an example networked system in accordance with various embodiments of this disclosure;

FIG. 2 illustrates an example peer-to-peer interaction process in accordance with this disclosure;

FIGS. 3A-3D illustrate an example set of screens of a gaming system user interface in accordance with this disclosure;

FIG. 4 illustrates an example method for a wallet reloading process in accordance with this disclosure;

FIG. 5 illustrates an example peer-to-peer API interfacing process in accordance with this disclosure;

FIG. 6 illustrates another example peer-to-peer API interfacing process in accordance with this disclosure;

FIG. 7 illustrates an end-to-end wager lifecycle process in accordance with this disclosure;

FIG. 8 illustrates an example system architecture in accordance with this disclosure;

FIG. 9 illustrates an example escrow sequence diagram in accordance with this disclosure;

FIG. 10 illustrates an example age and skill verification system in accordance with this disclosure;

FIG. 11 illustrates an example wallet pay-out system in accordance with this disclosure;

FIG. 12 illustrates a multi-factor authentication process for wallets in accordance with this disclosure;

FIGS. 13A-13C illustrate an example system architecture in accordance with this disclosure; and

FIGS. 14A and 14B illustrate an example system architecture in accordance with this disclosure;

FIG. 15 illustrates an example peer-to-peer game wagering activity diagram in accordance with this disclosure;

FIG. 16 illustrates an example matched wager creation process in accordance with this disclosure;

FIG. 17 illustrates an example wager invitation acceptance process in accordance with this disclosure;

FIGS. 18A and 18B illustrate an example match performance and result reporting process in accordance with this disclosure;

FIG. 19 illustrates an example escrow release and settlement process in accordance with this disclosure;

FIG. 20 illustrates an example dual-path result determination process in accordance with this disclosure;

FIG. 21 illustrates an example ML/AI-based stream analysis pipeline process in accordance with this disclosure;

FIG. 22 illustrates an example confirmation engine system architecture in accordance with this disclosure;

FIG. 23 illustrates an example spatial classification ML model architecture in accordance with this disclosure;

FIG. 24 illustrates an example temporal sequence ML model architecture in accordance with this disclosure;

FIG. 25 illustrates an example adaptive ensemble process in accordance with this disclosure; and

FIG. 26 illustrates an example confidence calibration and decision routing architecture in accordance with this disclosure.

### DETAILED DESCRIPTION

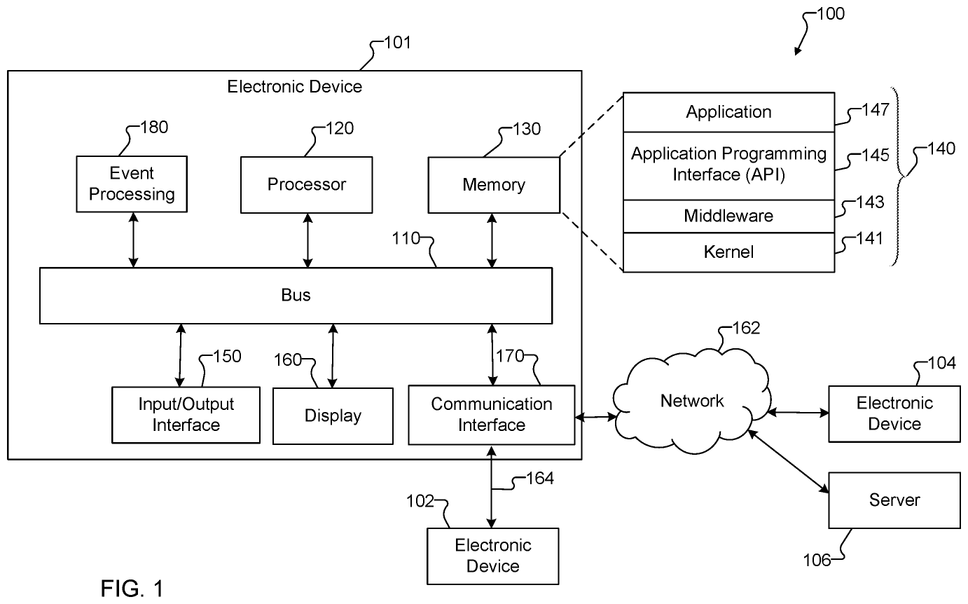

FIGS. 1 through 26, discussed below, and the various embodiments of this disclosure are described with reference to the accompanying drawings. However, it should be appreciated that this disclosure is not limited to the embodiments and all changes and/or equivalents or replacements thereto also belong to the scope of this disclosure. The same or similar reference denotations may be used to refer to the same or similar elements throughout the specification and the drawings.

As noted above, the systems and methods of this disclosure include an application that can be a web- and app-based system or platform allowing peer-to-peer interactions between users. In various embodiments, the system or platform allows users to perform various interactions, such as wagering in the outcome of events, such as skill-based video games.

For example, the platform allows for players to create an online account and set up a digital wallet. A player can then search for friends and other competitors alike, sending them a text or direct message via platform's chat function and a wager request. If the wager is accepted, both players place the agreed upon wager into the platform's secure escrow account protecting the wager and ensuring a fair outcome. The wager is released once both competitors agree to release the funds, minus a potential transaction fee, or the API engages and verifies the winner and calls back, authorizing the release of funds.

In addition to a stand-alone system, the platform, through a unique and exclusive plugin or portal, can communicate and engage with any digital gaming platform. Such digital gaming platforms and associated devices can include PC, PLAYSTATION, XBOX, STEAM, NINTENDO, NVIDIA, GOOGLE, NETFLIX, META, ANDROID, APPLE IOS, etc.

In various embodiments, the peer-to-peer platform of this disclosure includes an exclusive plugin that connects to the gaming platform operating system or a game's software code, causing the peer-to-peer platform to be initiated and connected with the gaming platforms' operating system or the game software code. This then allows for players to perform interactions such as sending wagers to fellow players. Once the game has concluded, the system will either recognize the winner and clear the funds or will operate to require both parties to agree to the release of funds, less any transaction fee.

In various embodiments, this disclosure provides for a comprehensive multi-layer system architecture for performing wagering between users. In various embodiments, this disclosure also provides a dual path result determination system that combines API integration and machine learning (ML)/artificial intelligence (AI)-based analysis. In various embodiments, this disclosure also provides a platform-agnostic ML stream analysis for game result verification that can be performed without publisher integration. In various embodiments, this disclosure also provides an enhanced security and compliance architecture with automated regulatory features. \

Prior approaches had various drawbacks, including, for example, that they were mobile-only, required manual verification, and could be used only on limited platforms. Existing solutions also require manual verification, such as requiring screenshots, spectator betting on professional matches, and require game developer integration.

The various embodiments of this disclosure provide a cross-platform approach with dual-path ML/API verification, a detailed multi-layer architecture, automated ML-based verification from video streams, with no manual submission required, peer-to-peer participant wagering with novel result determination, and wagering without developer involvement. This disclosure also provides for ML-based platform-agnostic verification, dual-path intelligent routing, a comprehensive multi-layer architecture, automated regulatory compliance providing real-world deployability, and cross-platform SDK/GDK integration.

FIG. 1 illustrates an example network configuration 100 in accordance with various embodiments of this disclosure. The embodiment of the network configuration 100 shown in FIG. 1 is for illustration only. Other embodiments of the network configuration 100 could be used without departing from the scope of this disclosure.

According to embodiments of this disclosure, an electronic device 101 is included in the network configuration 100. The electronic device 101 can include at least one of a bus 110, a processor 120, a memory 130, an input/output (IO) interface 150, a display 160, a communication interface 170, or an event processing module 180. In some embodiments, the electronic device 101 may exclude at least one of the components or may add another component.

The bus 110 includes a circuit for connecting the components 120 to 180 with one another and transferring communications (such as control messages and/or data) between the components. The processor 120 includes one or more of a central processing unit (CPU), an application processor (AP), or a communication processor (CP). The processor 120 is able to perform control on at least one of the other components of the electronic device 101 and/or perform an operation or data processing relating to communication. In some embodiments, the processor can be a graphics processor unit (GPU). In accordance with various embodiments of this disclosure, the processor 120 can process data and facilitate sending or receiving messages pertaining to services provided by a plugin application, as described in further detail in this disclosure. In various embodiments of this disclosure, the application, application platform, and/or application plugin may be referred to herein as the “Pony Up” application or “Pony Up” platform. The Pony Up platform may also be referred to herein as the “PUP”.

In various embodiments, Pony Up a cross-platform, peer-to-peer wagering system housed in an integrated application, plug-in, and API suite that enables users to stake value on verifiable competitive outcomes across gaming, fitness, educational, creative, and professional domains and digital competitions. The system is designed to operate across all major digital gaming ecosystems, including PLAYSTATION NETWORK, XBOX LIVE, NINTENDO SWITCH, STEAM, WINDOWS/MAC, IOS, ANDROID, emerging VR/AR platforms, and cloud-based gaming systems, as well as non-gaming platforms including fitness wearables, mobile GPS applications, and enterprise software systems. In various embodiments, the Pony Up platform features its own digital currency, Pony Up Coins, which are managed within a multi-currency wallet supporting fiat, crypto, and in-game credits.

The memory 130 can include a volatile and/or non-volatile memory. For example, the memory 130 can store commands or data related to at least one other component of the electronic device 101. According to embodiments of this disclosure, the memory 130 can store software and/or a program 140. The program 140 includes, for example, a kernel 141, middleware 143, an application programming interface (API) 145, and/or an application program (or “application”) 147. At least a portion of the kernel 141, middleware 143, or API 145 may be denoted an operating system (OS).

The kernel 141 can control or manage system resources (such as the bus 110, processor 120, or a memory 130) used to perform operations or functions implemented in other programs (such as the middleware 143, API 145, or application program 147). The kernel 141 provides an interface that allows the middleware 143, the API 145, or the application 147 to access the individual components of the electronic device 101 to control or manage the system resources. The application 147 can include a plugin application that can coordinate with other applications, such as a video game application, and enable peer-to-peer communications and interactions, such as wagering on an outcome of a video game session.

The middleware 143 can function as a relay to allow the API 145 or the application 147 to communicate data with the kernel 141, for example. A plurality of applications 147 can be provided. The middleware 143 is able to control work requests received from the applications 147, for example, by allocating the priority of using the system resources of the electronic device 101 (such as the bus 110, the processor 120, or the memory 130) to at least one of the plurality of applications 147.

The API 145 is an interface allowing the application 147 to control functions provided from the kernel 141 or the middleware 143. For example, the API 145 includes at least one interface or function (such as a command) for filing control, window control, image processing or text control.

The IO interface 150 serves as an interface that can, for example, transfer commands or data input from a user or other external devices to other component(s) of the electronic device 101. Further, the IO interface 150 can output commands or data received from other component(s) of the electronic device 101 to the user or the other external device.

The display 160 includes, for example, a liquid crystal display (LCD), a light emitting diode (LED) display, an organic light emitting diode (OLED) display, a microelectromechanical systems (MEMS) display, or an electronic paper display. The display 160 can also be a depth-aware display, such as a multi-focal display. The display 160 is able to display, for example, various contents (such as text, images, videos, icons, or symbols) to the user. The display 160 can include a touchscreen and may receive, for example, a touch, gesture, proximity, or hovering input using an electronic pen or a body portion of the user.

The communication interface 170, for example, is able to set up communication between the electronic device 101 and an external electronic device (such as a first electronic device 102, a second electronic device 104, or a server 106). For example, the communication interface 170 can be connected with the network 162 or 164 through wireless or wired communication to communicate with the external electronic device. The communication interface 170 can be a wired or wireless transceiver or any other component for transmitting and receiving signals, such as signals received by the communication interface 170 regarding operations performed by a plugin application.

The electronic device 101 further includes one or more sensors that can meter a physical quantity or detect an activation state of the electronic device 101 and convert metered or detected information into an electrical signal. For example, a sensor can include one or more buttons for touch input, one or more cameras, a gesture sensor, a gyroscope or gyro sensor, an air pressure sensor, a magnetic sensor or magnetometer, an acceleration sensor or accelerometer, a grip sensor, a proximity sensor, a color sensor (such as a red green blue (RGB) sensor), a bio-physical sensor, a temperature sensor, a humidity sensor, an illumination sensor, an ultraviolet (UV) sensor, an electromyography (EMG) sensor, an electroencephalogram (EEG) sensor, an electrocardiogram (ECG) sensor, an IR sensor, an ultrasound sensor, an iris sensor, a fingerprint sensor, etc. The sensor(s) can further include a control circuit for controlling at least one of the sensors included therein. Any of these sensor(s) can be located within the electronic device 101.

The wireless communication is able to use at least one of, for example, long term evolution (LTE), long term evolution-advanced (LTE-A), 5th generation wireless system (5G), mm-wave or 60 GHz wireless communication, Wireless USB, code division multiple access (CDMA), wideband code division multiple access (WCDMA), universal mobile telecommunication system (UMTS), wireless broadband (WiBro), or global system for mobile communication (GSM), as a cellular communication protocol. The wired connection can include at least one of universal serial bus (USB), high definition multimedia interface (HDMI), recommended standard 232 (RS-232), or plain old telephone service (POTS). The network 162 may include at least one communication network, such as a computer network (like a local area network (LAN) or wide area network (WAN), the Internet, or a telephone network.

The first and second external electronic devices 102 and 104 and server 106 each can be a device of the same or a different type from the electronic device 101. According to certain embodiments of this disclosure, the server 106 includes a group of one or more servers. Also, according to certain embodiments of this disclosure, all or some of operations executed on the electronic device 101 can be executed on another or multiple other electronic devices (such as the electronic devices 102 and 104 or server 106). Further, according to certain embodiments of this disclosure, when the electronic device 101 should perform some function or service automatically or at a request, the electronic device 101, instead of executing the function or service on its own or additionally, can request another device (such as electronic devices 102 and 104 or server 106) to perform at least some functions associated therewith. The other electronic device (such as electronic devices 102 and 104 or server 106) is able to execute the requested functions or additional functions and transfer a result of the execution to the electronic device 101. The electronic device 101 can provide a requested function or service by processing the received result as it is or additionally. To that end, a cloud computing, distributed computing, or client-server computing technique may be used, for example. While FIG. 1 shows that the electronic device 101 includes the communication interface 170 to communicate with the external electronic device 104 or server 106 via the network 162, the electronic device 101 may be independently operated without a separate communication function, according to embodiments of this disclosure.

The server 106 can include the same or similar components 110-180 as the electronic device 101 (or a suitable subset thereof). The server 106 can support to drive the electronic device 101 by performing at least one of operations (or functions) implemented on the electronic device 101. For example, the server 106 can include a processing module or processor that may support the processor 120 implemented in the electronic device 101. The server 106 can also include an event processing module (not shown) that may support the event processing module 180 implemented in the electronic device 101. For example, the event processing module 180 can process at least a part of information obtained from other elements (such as the processor 120, the memory 130, the input/output interface 150, or the communication interface 170) and can provide the same to the user in various manners.

While in FIG. 1 the event processing module 180 is shown to be a module separate from the processor 120, at least a portion of the event processing module 180 can be included or implemented in the processor 120 or at least one other module, or the overall function of the event processing module 180 can be included or implemented in the processor 120 or another processor. The event processing module 180 can perform operations according to embodiments of this disclosure in interoperation with at least one program 140 stored in the memory 130.

Although FIG. 1 illustrates one example of a network configuration 100, various changes may be made to FIG. 1. For example, the network configuration 100 could include any number of each component in any suitable arrangement. In general, computing and communication systems come in a wide variety of configurations, and FIG. 1 does not limit the scope of this disclosure to any particular configuration. While FIG. 1 illustrates one operational environment in which various features disclosed in this patent document can be used, these features could be used in any other suitable system.

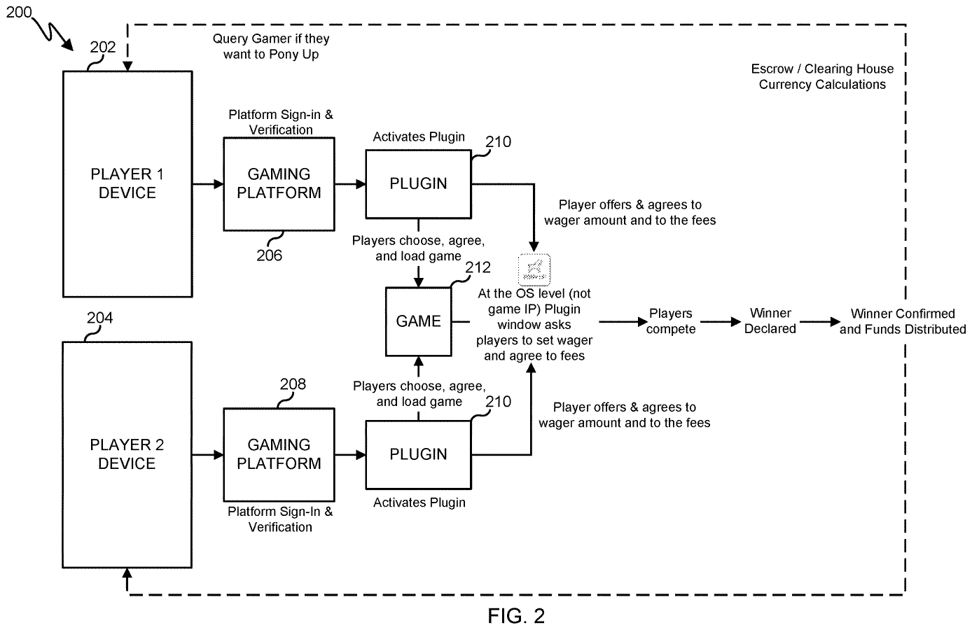

FIG. 2 illustrates an example peer-to-peer interaction process 200 in accordance with this disclosure. For ease of explanation, the process 200 shown in FIG. 2 can be described as being performed using the electronic device 101, or one or more electronic devices 101, in the network configuration 100 of FIG. 1. However, the process 200 could be performed using any other suitable device(s), such as the server 106 or a combination of devices, and in any other suitable system(s).

As shown in FIG. 2, a first player device 202 and a second player device 204 engage in the process 200. As described in the various embodiments of this disclosure, the first and second player devices 202, 204 can be any type of gaming device including gaming consoles, PCs, or cloud gaming-enabled devices, such as PLAYSTATION, XBOX, NVIDIA, WINDOWS PC, MACOS PC, and NINTENDO devices, as well as mobile devices.

Each of the first and second player devices 202, 204 can sign-in and go through verification processes with a first gaming platform 206 and a second gaming platform 208, respectively. The first and second gaming platforms 206, 208 can be various platforms such as PLAYSTATION NETWORK (PSN), XBOX LIVE, NVIDIA ONLINE, STEAM, etc. It will be understood that the first and second gaming platforms 206, 208 can be different platforms or the same platform.

Once signed-in to the first and second gaming platforms 206, 208, the first and second player devices 202, 204 can activate respective plugin applications 210 (e.g., the “Pony Up” application plugin), which can be stored as an application on each of the first and second player devices 202, 204. Activating the plugin applications 210 can also involve loading the respective user/player profiles into the plugin applications 210, verifying whether funds are available for the respective players, and the amount of funds, etc.

As shown in FIG. 2, the players then use their respective first and second player devices 202, 204 to, via the plugin 210, choose and agree on a game to play, and the chosen game 212 is loaded. FIG. 2 further illustrates the steps the players take to wager on the outcome of the game. First, each of the players offers, and subsequently agrees after potential negotiations, on a wager amount. This may also include agreeing to any transaction fee required for use of the plugin. This can include, at the OS level of the first and second player devices 202, 204, displaying a window of the plugin 210 asking the players to set and agree to the fees.

As further shown in FIG. 2, once the players agree, the players compete and, eventually, a winner is declared. In various embodiments of this disclosure, the plugin 210 can detect the outcome of the game by monitoring the game code of, or network traffic associated with, the game 212. Once the winner is declared, the winner is confirmed and the funds can be distributed to the winner, less transactions fees. This can include an escrow or clearing house performing currency calculations and withdrawing funds from the losing player's account and applying the funds to the winning player's account. In some embodiments, a confirmation query can be sent to the player(s) asking them to confirm, or “Pony Up” for, the transaction. In various embodiments of this disclosure, users/players may have a funds account (e.g., a wallet) associated with the plugin application 210's platform. In various embodiments, the funds account of the platform of the plugin application 210 can be integrated with the gaming platform 206 or 208, such that players can transfer funds from the plugin application 210's funds account to an account of the gaming platform. This can allow users/players to convert “Pony Up” funds into gaming platform funds to allow the users/players to use their winnings on buying other video games, gaming accessories, downloadable content, in-game items, avatar images, OS themes, etc., provided by the gaming platforms. In various embodiments, the process 200 can involve more than two players.

Although FIG. 2 illustrates one example of a peer-to-peer interaction process 200, various changes may be made to FIG. 2. For example, various components and functions in FIG. 2 may be combined, further subdivided, replicated, or rearranged according to particular needs. Also, one or more additional components and functions may be included if needed or desired.

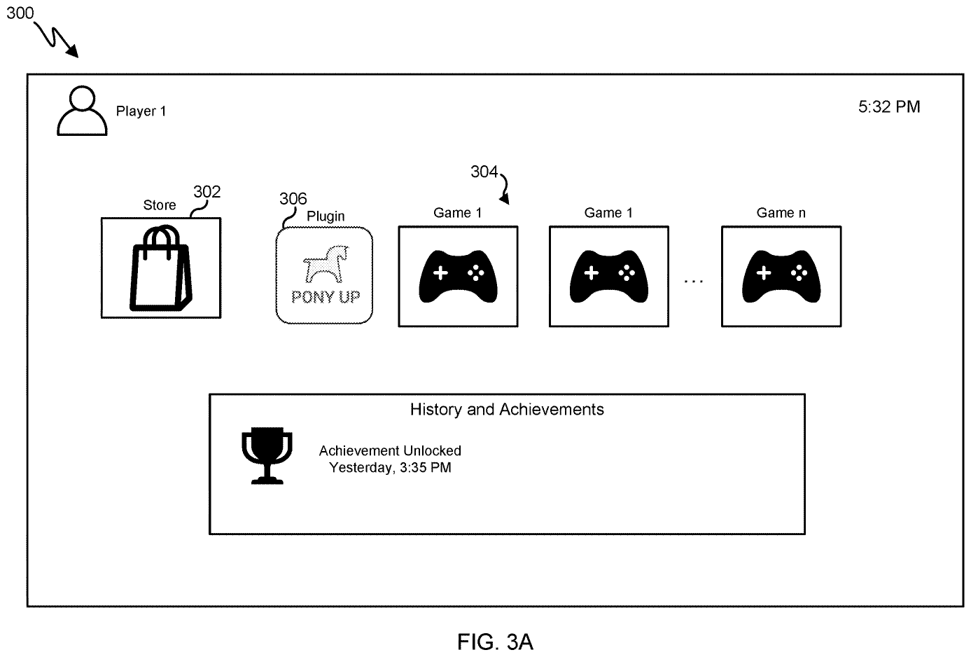

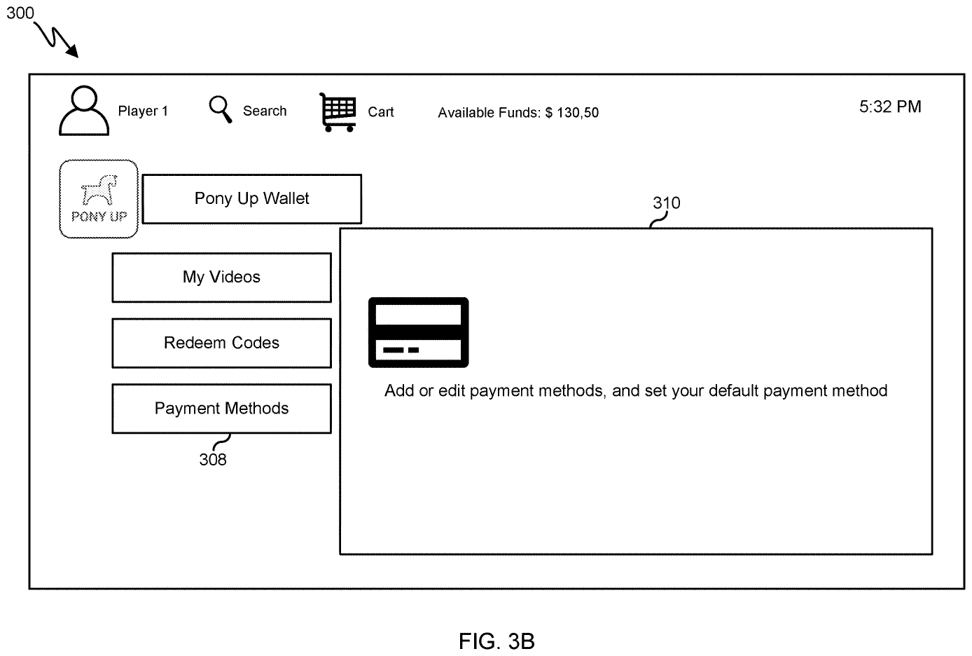

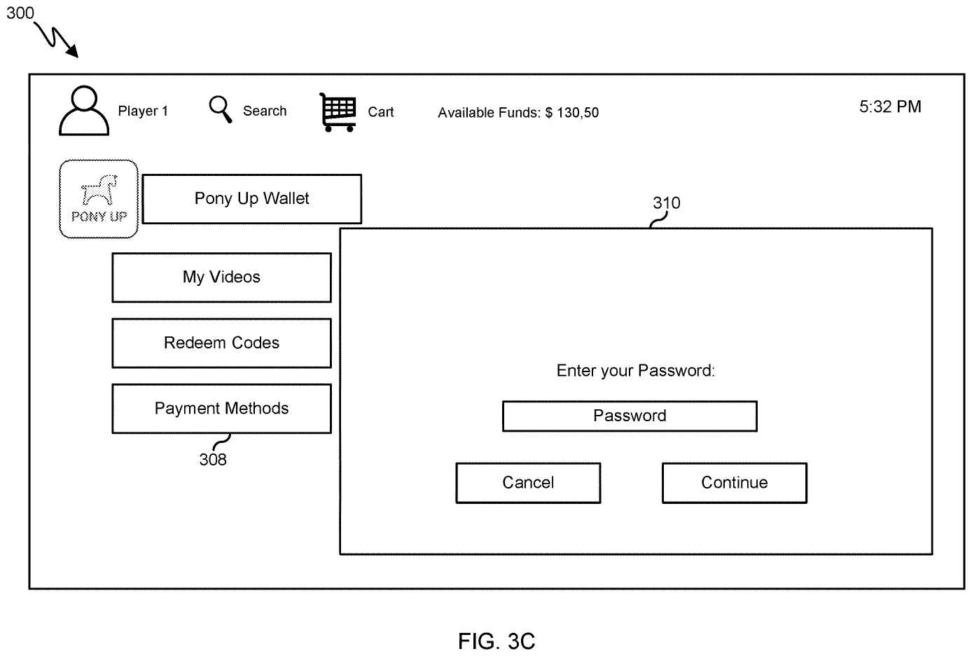

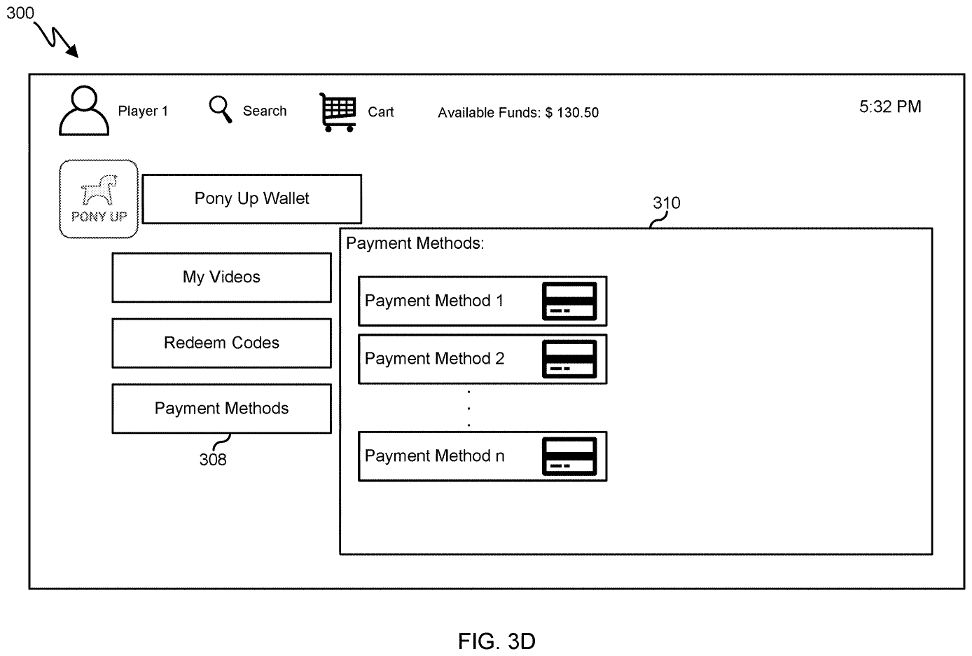

FIGS. 3A-3D illustrate an example set of screens 300 of a gaming system user interface in accordance with this disclosure. As shown in FIG. 3A, the user interface can be a gaming system's user interface, such as the interface of a PLAYSTATION, XBOX, or NINTENDO console. As shown in the example of FIG. 3A, the user interface includes a store tile 302 that can pull up a digital marketplace associated with the gaming system, such as a digital store to buy and download video games or other digital items associated with the gaming system. The user interface shown in FIG. 3A also includes a plurality of game tiles 304 that are configured to launch a video game application. The user interface shown in FIG. 3A also includes a tile 306 for the peer-to-peer plugin application (e.g., the “Pony Up” application). As described in this disclosure, the peer-to-peer plugin application can be installed on the gaming system so that it can be accessed by users to interact with their account (e.g., to add/transfer/convert funds) and so that the plugin application can facilitate betting between peers with respect to the games installed on the gaming system.

FIG. 3B illustrates another example user interface related to the peer-to-peer plugin application. For example, a user may select the tile 306 associated with the peer-to-peer plugin application as shown on FIG. 3A, and then, as shown in FIG. 3B, use the peer-to-peer plugin application to manage payment methods associated with the user's peer-to-peer platform account. For instance, as shown in FIG. 3B, a payment methods button 308 could be selected by the user to bring up a window 310 regarding the user's payment methods. However, prior to viewing the user's payment methods, the window 310 may require the user to input a password, as shown in FIG. 3C. Once the user correctly inputs the user's password, the user can be taken to a list of payment options displayed in the window 310, such as shown in FIG. 3D.

Although FIGS. 3A-3D illustrate an example set of screens 300 of a gaming system user interface, various changes may be made to FIGS. 3A-3D. For example, various components, functions, and/or UI elements in FIGS. 3A-3D may be combined, further subdivided, replicated, or rearranged according to particular needs. Also, one or more additional components, functions, and/or UI elements may be included if needed or desired.

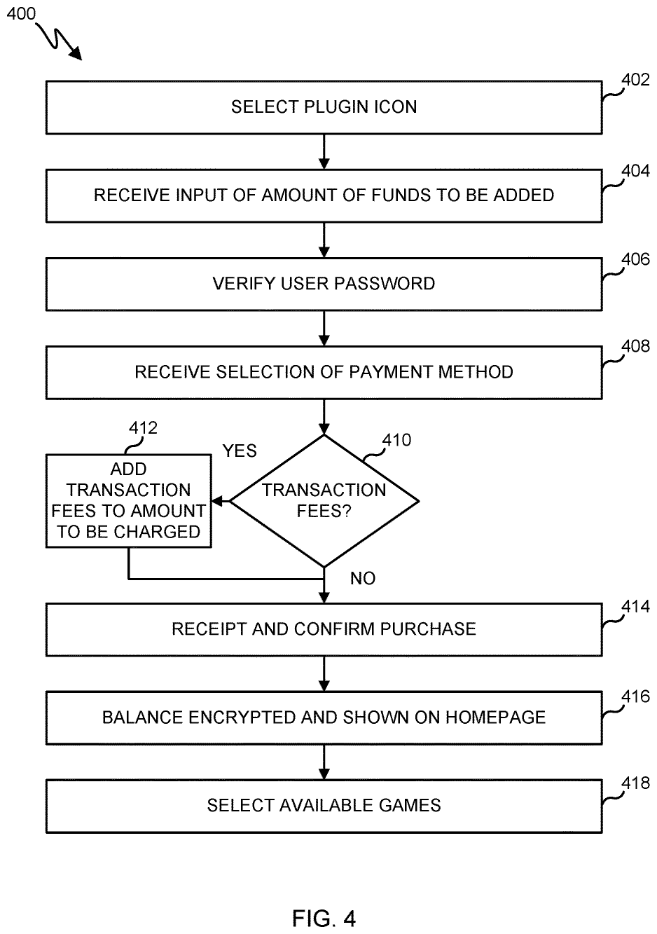

FIG. 4 illustrates an example method 400 for a wallet reloading process in accordance with this disclosure. For ease of explanation, the method 400 shown in FIG. 4 is described as being performed using the electronic device 101 in the network configuration 100 of FIG. 1. However, the method 400 could be performed using any other suitable device(s), such as the server 106 or a combination of devices, and in any other suitable system(s).

As described with respect to FIGS. 3A-3D, users can use the peer-to-peer application plugin described in this disclosure to manage wallet funds associated with the peer-to-peer platform. At step 402, a displayed icon for the peer-to-peer plugin application, such as shown in FIG. 3A, is selected. At step 404, the peer-to-peer plugin application receives input with respect to an amount of funds a user wishes to add to the user's wallet. At step 406, prior to proceeding with allowing the user to add funds to the user's wallet, the peer-to-peer plugin application provides prompt requesting a password (such as shown in FIG. 3C), and the peer-to-peer plugin application verifies a password provided by a user.

At step 408, the peer-to-peer plugin application then receives a selection of a payment method to be used to add funds to the user's wallet. At step 410, it is determined whether transactions fees should be imposed on the user's attempt to add funds to the user's wallet. If so, the transaction fees are added at step 412. In some embodiments, a fee percentage may be charged whenever user's add funds. In some embodiments, fees may only be imposed when a wager is completed. For example, if the user lost a wager, and needed to add funds to the user's account to cover the wager amount, processing fees associated with the wager could be imposed at step 412 when the user attempts to add funds to cover the wager.

At step 414, the peer-to-peer plugin application provides a receipt to the user and confirms the purchase. At step 416, the user's balance is stored in an encrypted manner, and can also be shown to the user on the user's homepage of a gaming system's user interface, such as shown in FIGS. 3A-3D. At step 418, the user can select an available game to play using the gaming system and can use the funds added to the user's account to wager with respect to the selected game.

Although FIG. 4 illustrates one example of a method 400 for a wallet reloading process, various changes may be made to FIG. 4. For example, while shown as a series of steps, various steps in FIG. 4 could overlap, occur in parallel, occur in a different order, or occur any number of times (including zero times).

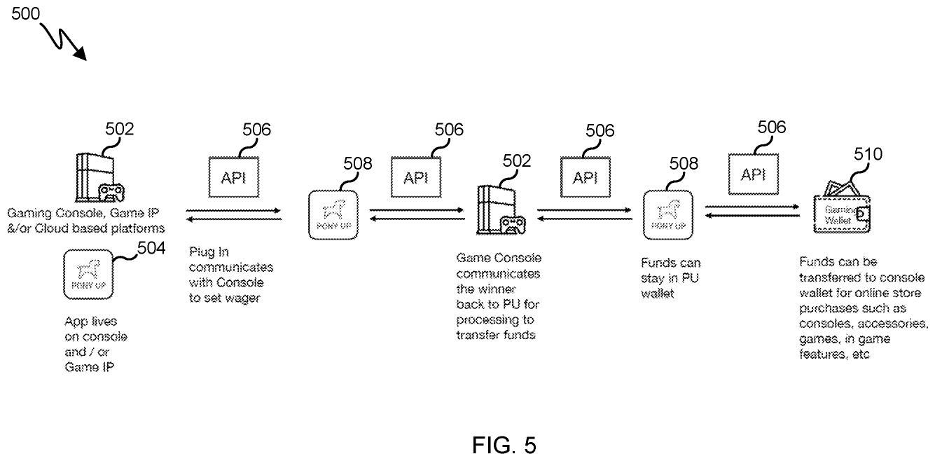

FIG. 5 illustrates an example peer-to-peer API interfacing process 500 in accordance with this disclosure. For ease of explanation, the process 500 shown in FIG. 5 can be described as being performed using the electronic device 101, or one or more electronic devices 101, in the network configuration 100 of FIG. 1. However, the process 500 could be performed using any other suitable device(s), such as the server 106 or a combination of devices, and in any other suitable system(s).

As shown in FIG. 5, a gaming console, or a game application residing on and executed by the gaming console, can include the peer-to-peer plugin application 504, e.g., as an application on the gaming console and/or integrated with the game code of the game executed by the gaming console. As further shown in FIG. 5, an API 506 is used by the peer-to-peer plugin application 504 on the gaming console 502 to communicates with a peer-to-peer platform service 508 associated with the peer-to-peer plugin application 504 to set a wager.

Then, as further shown in FIG. 5, the peer-to-peer platform service 508, using the API 506, communicates confirmation of the wager back to the game console 502, and the game console 502 eventually communicates, via the application 504 and the API 506, the winner of the game back to the peer-to-peer platform service 508. The peer-to-peer platform service 508 can also, using the API 506, manage funds in the user's wallet, such as confirming funs in the users wallet (and communicating the balance for display using the application 504 on the gaming console 502), or the peer-to-peer platform service 508 can, using the API 506, convert funds from the peer-to-peer platform's wallet to a wallet of the gaming console so that funds can be used by the user to purchase items available through the gaming console's online store.

Although FIG. 5 illustrates one example of a peer-to-peer interaction process 500, various changes may be made to FIG. 5. For example, various components and functions in FIG. 5 may be combined, further subdivided, replicated, or rearranged according to particular needs. Also, one or more additional components and functions may be included if needed or desired.

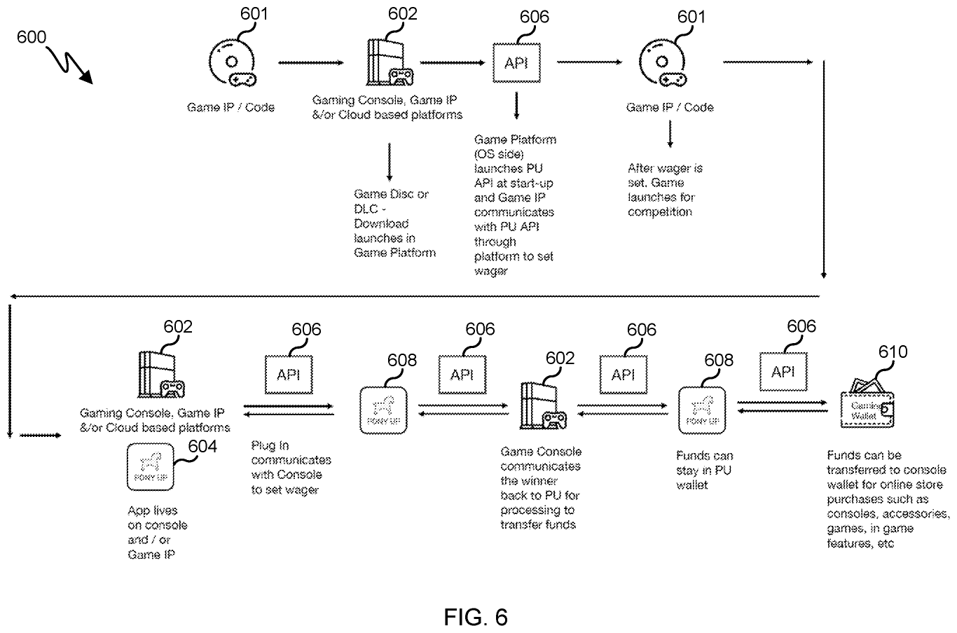

FIG. 6 illustrates another example peer-to-peer API interfacing process 600 in accordance with this disclosure. For ease of explanation, the process 600 shown in FIG. 6 can be described as being performed using the electronic device 101, or one or more electronic devices 101, in the network configuration 100 of FIG. 1. However, the process 600 could be performed using any other suitable device(s), such as the server 106 or a combination of devices, and in any other suitable system(s).

As shown in FIG. 6, a game application 601 can be executed by a gaming console or platform 602. The gaming console 602 can launch an API 606 associated with a peer-to-peer platform service 608 and with a peer-to-peer plugin application 604. Launching the API 606 by the gaming console 602 can be performed at startup of the game application 601, to allow for communication with the API 606 during execution of the game application 601, such as to set a wager.

As further shown in FIG. 6, when a wager is set using the API 606, this triggers the game application 601 to launch a competitive mode of the game application 601. Then, as further shown in FIG. 6, the game console 602 eventually communicates, via the application 604 and the API 606, the winner of the game back to the peer-to-peer platform service 608. The peer-to-peer platform service 608 can also, using the API 606, manage funds in the user's wallet, such as confirming funs in the users wallet (and communicating the balance for display using the application 604 on the gaming console 602), or the peer-to-peer platform service 608 can, using the API 606, convert funds from the peer-to-peer platform's wallet to a wallet of the gaming console so that funds can be used by the user to purchase items available through the gaming console's online store.

FIG. 6, as well as FIG. 5, demonstrates that any digital based gaming platform, game application, or other software that wants to engage with the player and a platform for the purposes of peer-to-peer interactions such as wagering can use the peer-to-peer platform's API to communicate back and forth. The API thus acts as the communications channel to establish the wager between players, the platform, and the game.

Although FIG. 6 illustrates one example of a peer-to-peer interaction process 600, various changes may be made to FIG. 6. For example, various components and functions in FIG. 6 may be combined, further subdivided, replicated, or rearranged according to particular needs. Also, one or more additional components and functions may be included if needed or desired.

As described in this disclosure, the “Pony Up” platform includes a digital software plug-in or portal that can communicate with any online and digital gaming platforms to promote, enable, and engage friendly competitive wagering globally. The plug-in can communicate and can be found on the welcome screen within the gaming hardware/platform operating system and/or the game code itself. In various embodiments, the plugin works with similar platforms (i.e.: PLAYSTATION 5 vs PLAYSTATION 5) and across other platforms known as “cross” platform in the gaming industry (i.e.: PLAYSTATION 5 vs XBOX vs PC).

The plug-in allows players to set friendly wagers through the app on video games played between each other. In various embodiments, the peer-to-peer system/platform enables competitors to wager both through an app and via the app plug-in into digital and gaming platforms. In various embodiments, the peer-to-peer platform will have the potential to operate in all currencies including crypto and provide for real time conversion into local currencies or to Pony Up Coins. The peer-to-peer platform will also be able to communicate and transfer dollars from the peer-to-peer platform's wallet to the gaming platform wallet, allowing for platforms and software to retain the captured revenue in their respective stores for hardware, accessories, in game items, merchandise (hats, shirts, stickers, figurines), etc.

In various embodiments, the plug-in can communicate between the peer-to-peer platform's app and the digital gaming platform to allow for secure wagering to occur across multiple digital gaming platforms. The peer-to-peer platform wallet is a secure location (sign-in required) that holds a player's wagers/money. The peer-to-peer platform enables a player to solicit a wager amongst fellow competitors/other players through the peer-to-peer platform app and/or through the gaming platform OS.

In various embodiments, once players select a game to compete and agree to a wager, the competition can be locked and funds from the players' wallets get transferred to escrow. The peer-to-peer platform can act as an escrow account protecting the interest of both players. The peer-to-peer platform can also include an online payment portal that allows competitive gamers to engage in friendly wagers peer-to-peer. The portal thus can operate as an online payment transaction service.

As described in this disclosure, the peer-to-peer platform thus allows for users/players to download and sign-up for the “Pony Up” service, fund their account, find friends, send friendly wagers, where the wager is agreed to by both parties or multiple parties, and the funds go into a secure escrow account. The platform can also incorporate a text feature that allows for users to find friends, send invites, receive alerts from the application about low balances, receive information on community matches, etc. The winner can send a request to friend to release funds. The peer-to-peer platform receives authorization and releases funds to winner, less a fee, such as a 5% processing fee. If funds are not approved for release, the peer-to-peer platform escrow account holds funds until released. In some embodiments, a penalty can be imposed if a user waits a certain period of time without releasing the funds. For example, in some embodiments, if funds are not released within 30 days, fees can go up to 10%. In some embodiments, if funds are not approved for release within 90 days, fees can go up to 75% and the net balance can be returned to each account.

In various embodiments, the peer-to-peer platform can also be used outside of video game platforms, such as in sports betting between peers, Esports betting between peers, casino and card game betting between peers, fantasy sports and simulated sports betting between peers, reality TV & entertainment outcome betting between peers, and various other peer-to-peer betting such as betting on political race outcomes, legislative outcomes, the weather, financial markets (e.g., the stock market), etc.

For example, embodiments of the peer-to-peer platform of this disclosure could be used for a “Fantasy Wagering” application. In this example, for a monthly subscription, the peer-to-peer platform can provide users with a certain currency value, e.g., a number of “Pony Coins,” which can be attached to a user's wallet and used to place friendly, fantasy wagers. To incentivize subscription engagement, at the end of a period of time, e.g., a month, the player with the most currency can win a real prize. In some embodiments, instead of the player with the most currency, other metrics could be used, such as the player with the largest growth in currency, a Rookie of the Month award, the player with the most participation, etc. This example provides a balance between real money wagering and a fantasy option made available to all players.

Thus, the peer-to-peer platform can be used in a variety of scenarios. One example scenario is as follows. Two friends love to watch international soccer. One friend says to the other: “I think Kylian Mbappé will touch the ball more than 100 times in tomorrow's game.” Second friend says: “No way, that's way too many touches.” Frist friend replies: “OK let's put a wager on it . . . will send you a Pony Up invite.”

Another example scenario is as follows. The Yelnats family is all together for their annual Thanksgiving dinner. Grandpa loves to set up potato sack races with all the grandkids. As there are four sets of grandkids, he says to his two sons and daughters: “how about we place a friendly wager on which set of grandkids will win this year?” They all love the idea, so Grandpa opens his Pony Up app, sets himself up as the wager host, and sends an invite to his kids. As they accept the wager, $20 from each of their Pony Up wallet gets transferred to the wager escrow, which Grandpa can release once he certifies the results of the race.

Another example scenario is as follows. Connor is located in San Diego, CA and his best friend Nathan is located in Cleveland, OH. They play online video games almost every night. Their favorite is MLB The SHOW. They often compete in the Home Run Derby. Connor uses the VOIP technology in the gaming system to ask Nathan if he wants to put a friendly wager on who hits the most home runs. Nathan verbally agrees. Connor uses the digital Pony Up plug-in within the gaming system or software to send Nathan a wager of $5. Nathan receives the offer and accepts. Both Connor's and Nathan's Pony Up wallets transfer $5 to the escrow account until the game is over. Once the game is over and a winner declared, the API is sent a signal from the game console/software on who won and the funds are released to that winner less a transaction fee.

Another example scenario is as follows. A group of 12 friends located all over the globe decide to play Fortnite online. One of them sends a wager request of $5 per player and the winner takes all. So, all 12 players open the Pony Up plug in on their gaming console and accept the wager request. $5 is deducted for each of their wallets and placed in the escrow account. Once the game is over and a winner declared, the API is sent a signal from the game console/software on who won and the funds are released to that winner less a processing fee.

Another example scenario is as follows. Players/Gamers can set up community tournaments in which numerous people can compete at the same skill levels for one big purse. For example, Jonny loves baseball and loves hitting home runs, he sets up a weekly home run tournament on MLB The Show where any and all players with the same skill level can enter. Johnny sets the time window from 8 am-8 pm EST on April 10^{th}. The player with the most home runs when time expires wins the total purse. Another example is Sergio loves Formula One racing and sets up a community event for the fastest time on a certain track. He sets the date, time, track, payout percentages and sends an alert to the entire PUP community. The races occur and the fastest 3 times are declared at which the API sends a signal to release funds based on winning percentages

Another example scenario is as follows. Jimmy and Joey are avid investors. One is very Bullish on the stock market and the other is Bearish. Over coffee and bagels, their debates heat up and Jimmy says well, then let's wager on it. Jimmy claims the S&P 500 will close above 6,000 by February 28. Joey says your crazy. The geo-political world is very unstable. Jimmy, not trusting his lifelong friend, sends Joey a Pony Up wager invite for $1. Joey accepts and the money is placed in the escrow account. The declared winner then sends a request to release the funds less a processing fee.

As described in this disclosure, this disclosure pertains to a cross-platform, peer-to-peer wagering system housed in an integrated application, plug-in, and API suite that enables users to place skill-based wagers on digital competitions, primarily within the gaming ecosystem. The system is designed to operate across all major digital gaming ecosystems, including PLAYSTATION NETWORK, XBOX LIVE, NINTENDO SWITCH, STEAM, WINDOWS/MAC, IOS, ANDROID, emerging VR/AR platforms, and cloud-based gaming systems, and features its own digital currency, Pony Up Coins, which are managed within a multi-currency wallet supporting fiat, crypto, and in-game credits. Its core innovation lies in the integration of a secure escrow wallet, a multi-currency digital wallet, and an API-based plug-in that can be embedded within game operating systems or game code, ensuring seamless and fair wagering experiences across disparate platforms. Pony Up unlocks new monetization channels for players, publishers, game developers, creators, and investors, while maintaining full transparency for regulators.

The system architecture is multi-layered, comprising user devices, game platforms, a secure application layer, and backend services. The application layer handles account management, wallet services, wager initiation, and KYC/AML compliance. The backend includes an API gateway, matchmaking, risk management, logging, and audit services. The wallet service supports custody, tokenization, and real-time currency conversion, while the escrow service manages the holding and release of funds, fee application, and dispute resolution. Security protocols such as multi-factor authentication and end-to-end encryption can be used for the platform.

In an escrow and settlement workflow, the wagering process is governed by a robust escrow mechanism. When a wager is initiated, both parties digitally consent, and their funds are pre-authorized and moved into escrow. The match is played, and the outcome is verified either automatically (via API callback) or through dual-consent. Upon verification, fees and taxes are applied, and the winner's wallet is credited. All transactions are recorded in a ledger with a full audit trail, ensuring transparency and dispute defensibility.

In cross-platform and plug-in integration, a distinguishing feature of this disclosure is its ability to facilitate wagers across different gaming platforms through a plug-in or API that interfaces with the game OS or code. This allows, for example, a PLAYSTATION user to wager against an XBOX user, with the system handling all aspects of fund custody, match tracking, and outcome verification. The plug-in architecture also enables developers to integrate Pony Up's functionality into their games, broadening the platform's reach and utility.

The embodiments of this disclosure include enabling peer-to-peer wagering, the software plug-in, and the wallet system, and address real-time currency conversion, dispute resolution, and security features.

It will be understood that Pony Up is designed for a variety of use cases, including esports, family competitions, and global play, with built-in mechanisms for regulatory compliance. The system distinguishes between skill-based wagering and games of chance, allowing for adaptation to different legal jurisdictions. Optional sweepstakes models and compliance strategies for restricted regions are also considered, ensuring the platform's global scalability and legal defensibility.

In various embodiments, the Pony Up architecture can combine the following.

TABLE 1
Architecture Details

| Feature | Purpose | Impact |
|---|---|---|
| Escrow Engine | Locks funds from | Minimizes fraud; creates |
| | counterparties, releases only | defensible revenue via fees |
| | on verified outcomes | |
| Multi-Currency Wallet | Supports fiat, crypto, Pony | Maximizes global |
| | Up Coins, and in-game | addressable market and |
| | credits with real-time FX | regulatory compliance |
| | conversion and automated | |
| | management of local digital | |
| | tax regulations | |
| Cross-Platform Plug-in & | Embeds wagering function | Enables rapid adoption and |
| API | natively into game OS or IP | developer network effects |
| Reg-Tech Layer | Ensures jurisdictional | De-risks regulatory exposure |
| (KYC/AML + Geo-Fencing) | compliance | |

The result is a frictionless wagering experience that unlocks new monetization channels for players, publishers, game developers, creators, and investors, while maintaining full transparency for regulators. Pony Up's plug-in architecture reduces publisher and developer integration to a minimal number of lines of code, supported by a comprehensive code library for quick implementation and testing.

The systems of this disclosure fill gaps in the technological field. For example, cross-platform liquidity is limited; most incumbents are siloed to a single console, mobile OS, or lack cloud-based support, trust deficits stem from manual result verification, disputed payouts, and lack of automated arbitration, and regulatory uncertainty where many offerings blur the line between skill-based competition, games of chance, and community challenges. This disclosure thus provides that the integrated escrow removes counterparty risk and automates settlement, including best-in-class session settlement times, the plug-in architecture and code library reduce publisher and developer integration overhead to a minimal number of lines of code, with easy implementation and testing, the reg-tech toolkit provides out-of-the-box KYC/AML, geo-blocking, audit trails, and automated management of FX and local digital tax regulations, accelerating market entry across jurisdictions, the multi-currency wallet supports fiat, crypto, and Pony Up Coins, with options for users to transfer funds to partner platform wallets (PLAYSTATION, XBOX, etc.) or cash out directly, that Pony Up features its own game for onboarding and demonstration and provides tools for developers to integrate their own games and achievements, and automated arbitration and dispute resolution are fully integrated, ensuring seamless defensibility and compliance.

In various embodiments, the platform can be logically partitioned into Presentation, Application, Services, and Infrastructure layers, each hardened by end-to-end encryption and zero-trust principles. In various embodiments, Pony Up supports user devices, game platforms, and cloud-based platforms, ensuring device-agnostic and cloud-native operation, such as shown below.

TABLE 2
Architecture Layers

| Layer | Modules | Description |
|---|---|---|
| Presen- | Mobile/Web App, Console | User onboarding, wallet |
| tation | Overlay, SDK Widgets, | management, wager |
| | Cloud Platform Support | initiation, achievement |
| | | integration, and social media |
| | | promotional features |
| Appli- | Wager UI, KYC/AML, | Business logic, compliance |
| cation | Matchmaking, FX Engine, | enforcement, and frictionless |
| | Age and Skill-Level | user identification and |
| | Verification | verification |
| Services | Wallet Service (custody, | Stateless micro-services |
| | conversion, Pony Up Coins, | exposed via REST/GraphQL, |
| | partner wallet integration), | with results reporting for |
| | Escrow Service (hold/release, | synchronous and |
| | fee engine, arbitration), Risk | asynchronous (community) |
| | & Fraud (ML-driven), Audit | gaming sessions |
| | & Analytics, Reporting, Tax | |
| | and FX Management | |
| Infra- | API Gateway, Audit Ledger | Scalable cloud-native |
| structure | (immutable), Security (HSM, | backbone (Kubernetes, IaC) |
| | MFA), Observability Stack | |

Core components of the platform can include:
Escrow Service: Atomic hold-and-release smart-contract logic for fiat, crypto, and Pony Up Coins, with automated arbitration and dispute resolution, and best-in-class settlement times.
Wallet Service: Tokenized sub-wallets providing per-user segregation; supports ISO-20022 and ERC-20 rails, Pony Up Coins, and partner wallet interoperability for seamless currency transfer and purchases in partner digital stores.
API/Plug-in SDK: Lightweight client library (~150 kB) delivering wager prompts, balance checks, outcome callbacks, and results reporting for synchronous and asynchronous (community) gaming sessions.
Compliance Engine: Real-time sanction screening, transaction monitoring, jurisdictional ruleset evaluation, and automated FX and tax management.
Audit & Analytics: Append-only ledger with SHA-512 hashes; BigQuery-compatible analytics for anomaly detection, reporting, and regulatory audit.
Developer Integration Tools: Code library and integration options for game developers to onboard their games and achievements, with minimal effort.

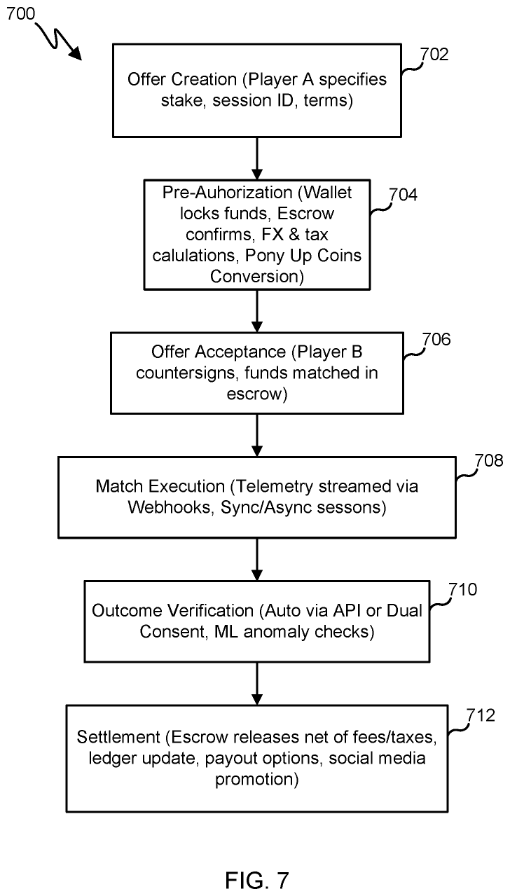

FIG. 7 illustrates an example end-to-end wager lifecycle process 700 in accordance with this disclosure. For ease of explanation, the process 700 shown in FIG. 7 is described as being performed using the electronic device 101 in the network configuration 100 of FIG. 1. However, the process 700 could be performed using any other suitable device(s), such as the server 106 or a combination of devices, and in any other suitable system(s).

As shown in FIG. 7, the process includes, at step 702, an offer creation operation is performed in which a user specifies parameters for a wager. For example, a Player A could specify a stake (in fiat, crypto, or Pony Up Coins), game session ID, and terms. At step 704, a pre-authorization process is performed where, for example, a wallet service locks funds and an escrow service confirms the wager, including FX conversion and tax calculations.

At step 706, an offer acceptance operation is performed. For example, a Player B countersigns digitally and funds are matched and held in escrow. At step 708, a match execution operation is performed, where, for example, telemetry is streamed to Pony Up via secure Webhooks, supporting both synchronous and asynchronous (turn-based/community) gaming sessions.

At step 710, an outcome verification is performed, which may include performing Auto-(API callback) or Dual-Consent, machine learning (ML) flagging for anomalies, and/or results reporting for asynchronous sessions. At step 712, a settlement operation is performed, which may include the escrow releasing a net of fees/taxes, users selecting payout options, including transfer to partner platform wallets, direct cashout, or purchases in partner digital stores, updating the ledger, notifying the parties, and/or enabling of social media promotional features.

Although FIG. 7 illustrates one example of an end-to-end wager lifecycle process 700, various changes may be made to FIG. 7. For example, while shown as a series of steps, various steps in FIG. 7 could overlap, occur in parallel, occur in a different order, or occur any number of times (including zero times).

An example of the cross-platform nature of the platform includes, for instance, a PLAYSTATION 5 user challenges XBOX SERIES X user in FIFA. The SDK mediates session IDs across PSN and XBOX LIVE, normalizes telemetry, and finalizes settlement in an expedited timeframe post-match. Users can select payout options, including transferring winnings to their PLAYSTATION or XBOX wallet, or using Pony Up Coins for purchases in partner stores.

Example non-gaming extensions can include Fantasy sports prop bets, professional, competitive, multiplayer digital competitions and tournaments, community challenge events (e.g., wagering $10 against your neighbor on who can finish a 1 mile run fastest), and/or family events (e.g., holiday sack race) using QR code invites.

Moreover, in various embodiments, a security, compliance and regulatory framework can include one or more of the following:

TABLE 3
Compliance and Regulatory Details

| Domain | Controls | Standards |
|---|---|---|
| Identity | Tiered KYC (SSN/Passport + | FATF, FinCEN |
| | biometric selfie, ID provider), | |
| | 2FA/MFA, Risk scoring, Age | |
| | and Skill-Level Verification, | |
| | Frictionless user | |
| | identification | |
| Access | JWT/OAuth 2.0, Role-based | OAuth 2.0, OWASP |
| | access control (RBAC), API | |
| | rate limiting, Geo-blocking | |
| Data Security/ | Data at rest (AES-256), end- | ISO 27001, GDPR, |
| Data Protection | to-end encryption (TLS 1.3) | CCPA, PCI-DSS |
| | in transit, personally | |
| | identifiable information (PII) | |
| | tokenization, general data | |
| | protection regulation (GDPR) | |
| | compliance, hardware | |
| | security module (HSM)- | |
| | based key management | |
| Transaction | Atomic transactions, | ACID compliance |
| Security | Idempotency keys, | |
| | Distributed locking, Event | |
| | sourcing | |
| Transaction | Dual-entry ledger, L2 hash | SOC 1/2 |
| Integrity | anchoring to public | |
| | blockchain for immutability, | |
| | automated arbitration and | |
| | dispute defensibility | |
| Fraud | Machine learning anomaly | Custom PUP ML |
| Prevention | detection, Velocity checks, | models |
| | Device fingerprinting, | |
| | Behavioral analysis | |
| Compliance | Real-time sanction screening | OFAC, Local tax |
| | (OFAC), Automated tax | codes |
| | calculation, Jurisdictional | |
| | rulesets, Audit trail | |
| | (immutable ledger) | |
| Geo-Compliance | Real-time IP/GPS fencing, | OFAC, EU-MLD5 |
| | state/region rule engine, | |
| | automated FX and local | |
| | digital tax management | |
| Dispute | Automated arbitration | Internal PUP |
| Resolution | workflows, Evidence | policies |
| | collection (video, telemetry), | |
| | Multi-tier escalation, Third- | |
| | party arbitration integration | |
| Responsible | Deposit limits, cooldown | UKGC, iGaming regs |
| Play | periods, self-exclusion APIs, | |
| | feature opt-ins for social | |
| | media and promotional tools | |

The PUP can also provide enhanced compliance features such as automated tax management that provides real-time tax calculations based on user jurisdiction, automated withholding for reporting, integration with tax reporting systems, support for 1099 generation (US) or equivalent international forms, and/or cryptocurrency tax tracking and reporting. The enhanced compliance features can include jurisdictional compliance including real-time geo-location verification, a jurisdiction-specific ruleset engine, dynamic feature enabling/disabling per region, automated compliance reporting per market, and/or support for skill-based vs. chance-based determination per jurisdiction. The enhanced compliance features can include AML/KYC automation including continuous transaction monitoring, pattern recognition for suspicious activity, automated SAR (Suspicious Activity Report) filing, integration with third-party KYC providers, and/or periodic re-verification workflows.

The modular reg-tech layer allows rapid policy configuration for new jurisdictions without code redeploys, preserving velocity while maintaining legal hygiene. The system automatically manages FX conversion, local digital tax compliance, and regulatory reporting for all supported regions. The system will also integrate currently available and future Artificial Intelligence for added security, verification, callbacks, currency transfer, platform, social and other features.

This disclosure thus provides a platform with a unique combination of a native plug-in, escrow wallet, multi-currency wallet with Pony Up Coins, automated compliance, FX/tax management, developer integration tools, partner wallet interoperability, social media features, and support for synchronous, asynchronous, and community challenge events—an architecture and feature set absent from existing technologies and/or solutions in the industry.

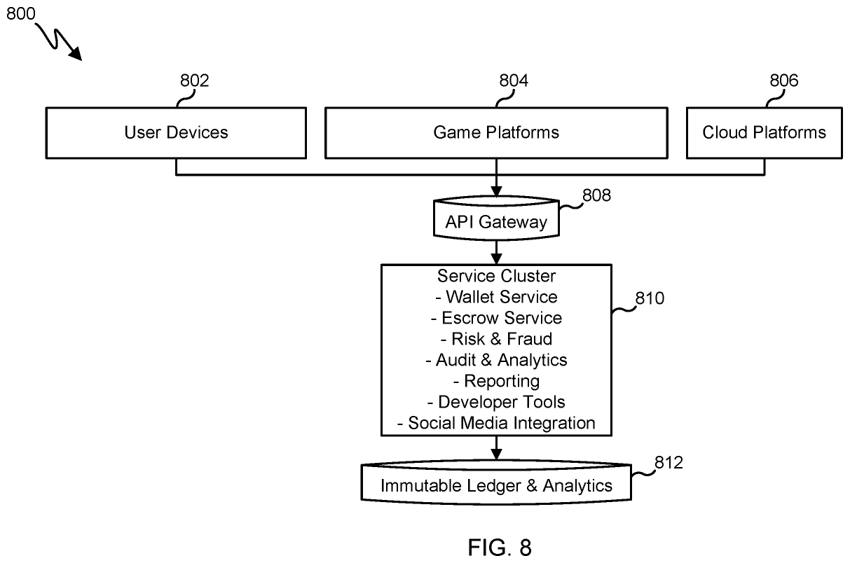

FIG. 8 illustrates an example system architecture 800 in accordance with this disclosure. For ease of explanation, the architecture 800 shown in FIG. 8 can be described as being performed or implemented by using the electronic device 101, or one or more electronic devices 101, in the network configuration 100 of FIG. 1. However, the architecture 800 could be performed or implemented using any other suitable device(s), such as the server 106 or a combination of devices, and in any other suitable system(s).

As shown in FIG. 8, the architecture 800 includes user devices 802, such as mobile devices, console devices, PC devices, and/or virtual reality (VR) and/or augmented reality (AR) devices. The architecture 800 also include game platforms 804, such as PSN, XBOX LIVE, STEAM, and/or SWITCH game platforms. The architecture 800 can also include cloud platforms 806. The user devices 802, the game platforms 804, and the cloud platforms 806 (e.g., NVIDIA GEFORCE NOW) are connected to an API Gateway 808. The API Gateway 808 is connected to a services cluster 810 that can include various platform services, such as wallet, escrow, risk, audit, analytics, reporting, developer tools, and/or social media integration services. The service cluster 810 is in turn connected to an immutable ledger and analytics service 812.

Although FIG. 8 illustrates one example of a system architecture 800, various changes may be made to FIG. 8. For example, various components and functions in FIG. 8 may be combined, further subdivided, replicated, or rearranged according to particular needs. Also, one or more additional components and functions may be included if needed or desired.

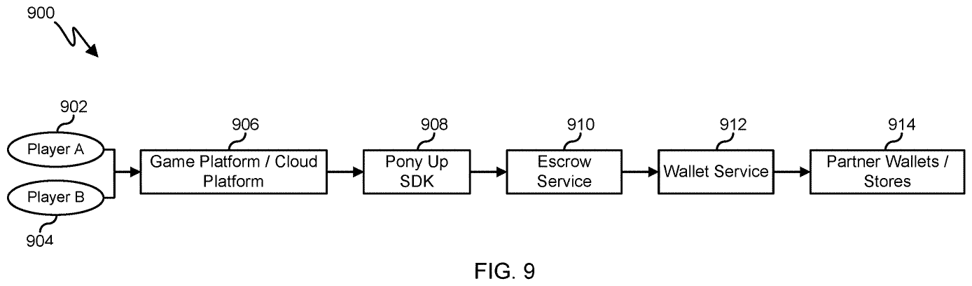

FIG. 9 illustrates an example escrow sequence diagram 900 in accordance with this disclosure. For ease of explanation, the escrow sequence diagram 900 shown in FIG. 9 can be described as being performed or implemented by using the electronic device 101, or one or more electronic devices 101, in the network configuration 100 of FIG. 1. However, the escrow sequence diagram 900 could be performed or implemented using any other suitable device(s), such as the server 106 or a combination of devices, and in any other suitable system(s).

As shown in FIG. 9, a swim-lane from a first player 902 (Player A) and a second player 904 (Player B) moves to a Game Platform/Cloud Platform 906, a Pony Up SDK 908, an Escrow Service 910, a Wallet Service 912, and Partner Wallets/Stores 914.

Although FIG. 9 illustrates one example of an escrow sequence diagram 900, various changes may be made to FIG. 9. For example, while shown as a series of steps, various steps in FIG. 9 could overlap, occur in parallel, occur in a different order, or occur any number of times (including zero times).

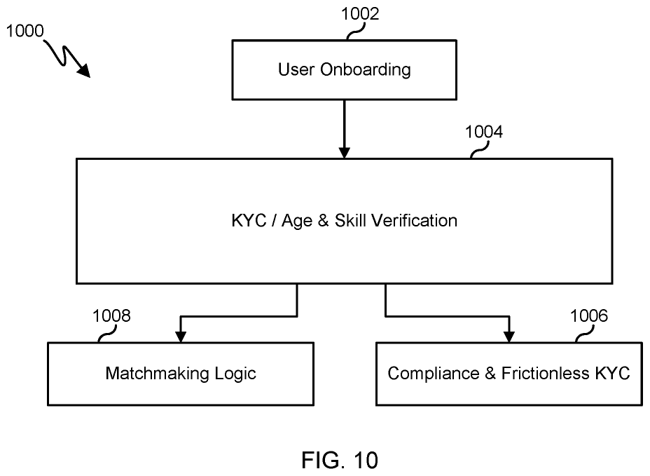

FIG. 10 illustrates an example age and skill verification system 1000 in accordance with this disclosure. For ease of explanation, the system 1000 shown in FIG. 10 can be described as being performed or implemented by using the electronic device 101, or one or more electronic devices 101, in the network configuration 100 of FIG. 1. However, the system 1000 could be performed or implemented using any other suitable device(s), such as the server 106 or a combination of devices, and in any other suitable system(s).

As shown in FIG. 10, the system 1000 includes user onboarding processes 1002, KYC/age and skill-level verification processes 1004, compliance and frictionless KYC processes 1006, and matchmaking logic processes 1008.

Although FIG. 10 illustrates one example of an age and skill verification system 1000, various changes may be made to FIG. 10. For example, various components and functions in FIG. 10 may be combined, further subdivided, replicated, or rearranged according to particular needs. Also, one or more additional components and functions may be included if needed or desired.

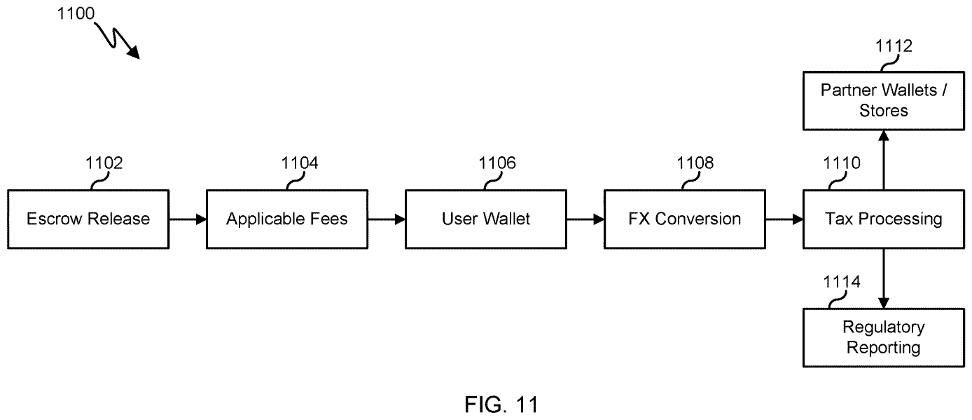

FIG. 11 illustrates an example wallet pay-out process 1100 in accordance with this disclosure. For ease of explanation, the process 1100 shown in FIG. 11 is described as being performed using the electronic device 101 in the network configuration 100 of FIG. 1. However, the process 1100 could be performed using any other suitable device(s), such as the server 106 or a combination of devices, and in any other suitable system(s).

As shown in FIG. 11, the process 1100 includes performing payouts that can include an escrow release operation 1102, an applicable fee payment process 1104, payout to a user wallet process 1106, an FX conversion process 1108, a tax processing process 1110, a partner wallet/store integration process 1112, and a regulatory reporting process 1114.

Although FIG. 11 illustrates one example of a wallet pay-out process 1100, various changes may be made to FIG. 11. For example, while shown as a series of steps, various steps in FIG. 11 could overlap, occur in parallel, occur in a different order, or occur any number of times (including zero times).

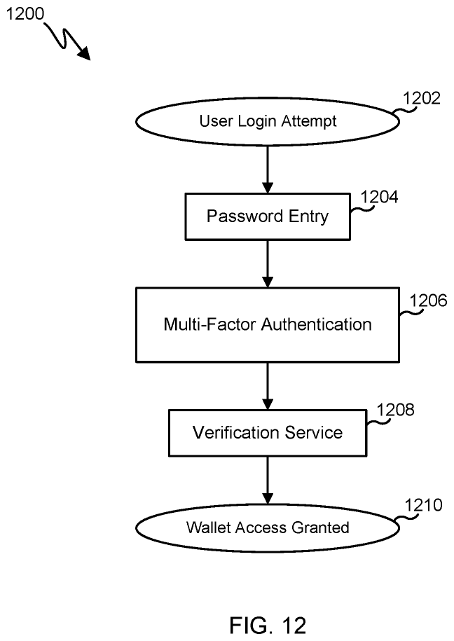

FIG. 12 illustrates a wallet access authentication process 1200 for wallets in accordance with this disclosure. For ease of explanation, the process 1200 shown in FIG. 12 is described as being performed using the electronic device 101 in the network configuration 100 of FIG. 1. However, the process 1200 could be performed using any other suitable device(s), such as the server 106 or a combination of devices, and in any other suitable system(s).

As shown in FIG. 12, the process 1200 includes, at step 1202, a user login attempt. AT step 1204, a password entry is received, which is followed, at step 1206, by a multi-factor authentication process, such as using short-message service (SMS), email, application, and/or biometric checks. At step 1208, a verification service verifies the user's credentials, and, at step 1210, wallet access is granted to the user.

Although FIG. 12 illustrates one example of a wallet access authentication process 1200, various changes may be made to FIG. 12. For example, while shown as a series of steps, various steps in FIG. 12 could overlap, occur in parallel, occur in a different order, or occur any number of times (including zero times).

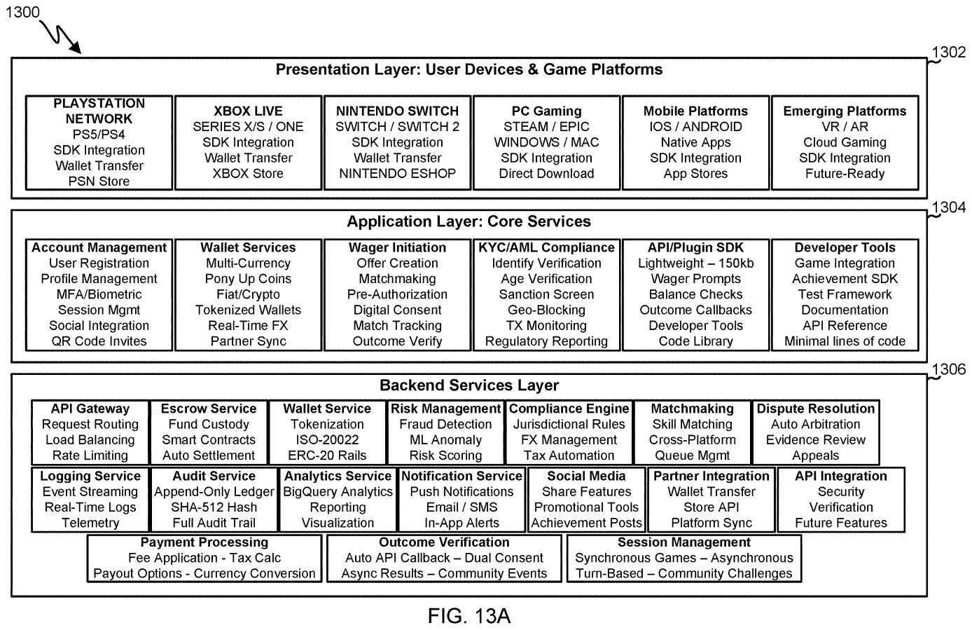

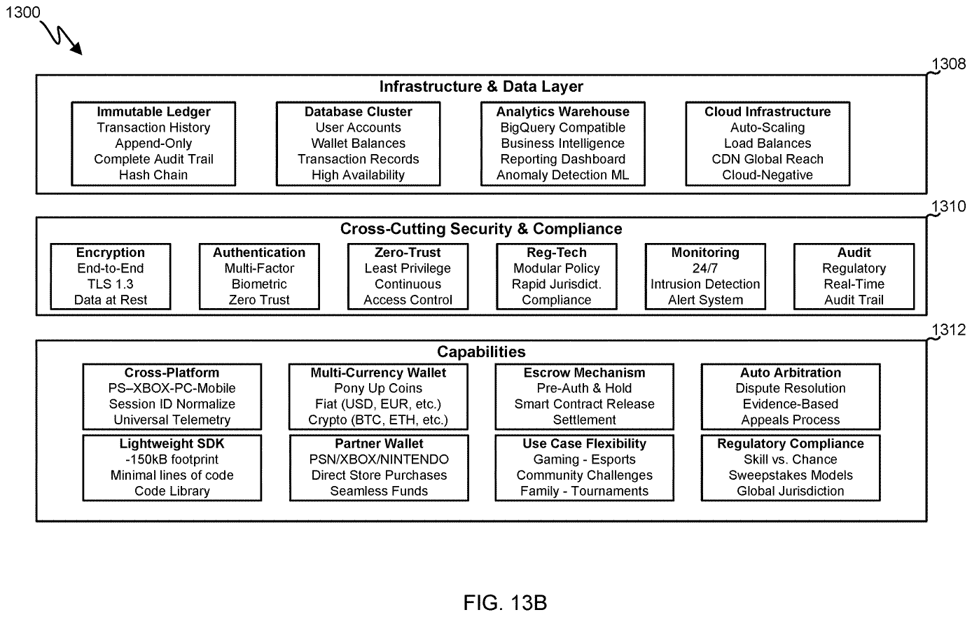

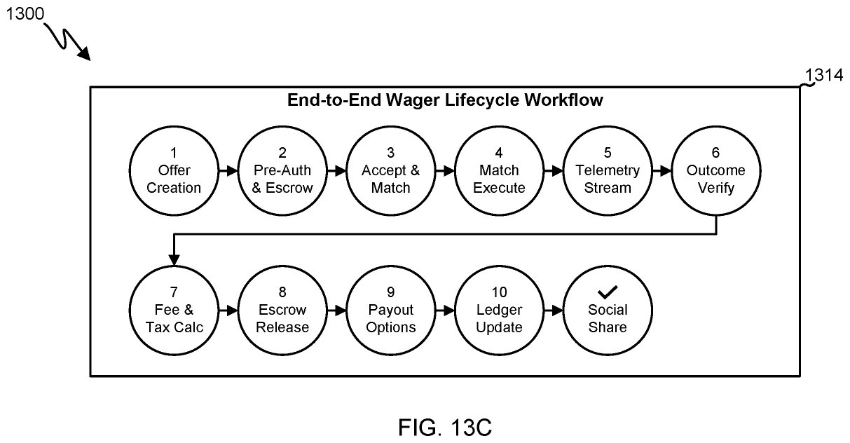

FIGS. 13A-13C illustrate an example system architecture 1300 in accordance with this disclosure. For ease of explanation, the architecture 1300 shown in FIGS. 13A-13C can be described as being performed or implemented by using the electronic device 101, or one or more electronic devices 101, in the network configuration 100 of FIG. 1. However, the architecture 1300 could be performed or implemented using any other suitable device(s), such as the server 106 or a combination of devices, and in any other suitable system(s).

As shown in FIG. 13A, the system architecture 1300 can include a presentation layer 1302 that includes various user devices and game platforms, such as PSN, XBOX LIVE, NINTENDO SWITCH, PC gaming platforms, mobile platforms, and emerging platforms. The system architecture 1300 also includes an application layer 1304 that includes core services like account management, wallet services, wager initiation, KYC/AML compliance, API/plugin SDKs, and developer tools. The system architecture 1300 also includes a backend services layer 1306 that can include an API gateway, an escrow service, a wallet service, risk management, a compliance engine, matchmaking, dispute resolution, a logging service, an audit service, an analytics service, a notification service, a social media service, partner integration, API integration, payment processing, outcome verification, and session management.

As shown in FIG. 13B, the system architecture 1300 can also include an infrastructure and data layer 1308 that can include an immutable ledger, a database cluster, an analytics warehouse, and cloud infrastructure. The system architecture 1300 can also include a cross-cutting security and compliance layer 1310 that can include encryption, authentication, zero-trust, reg-tech, monitoring, and auditing. The system architecture 1300 can also include capabilities 1312, such as cross-platform, multi-currency wallet, escrow mechanism, auto-arbitration, lightweight SDK, partner wallet, use case flexibility, and regulatory compliance capabilities.

As shown in FIG. 13C, the system architecture 1300 can also include or perform an end-to-end wager lifecycle workflow 1314. The workflow 1314 can include over creation, pre-authorization and escrow, acceptance and matching, match execution, telemetry streams, outcome verification, fee and tax calculations, escrow release, payout options, ledger update, and social media sharing of outcomes.

Although FIGS. 13A-13C illustrates one example of a system architecture 1300, various changes may be made to FIGS. 13A-13C. For example, various components and functions in FIGS. 13A-13C may be combined, further subdivided, replicated, or rearranged according to particular needs. Also, one or more additional components and functions may be included if needed or desired.

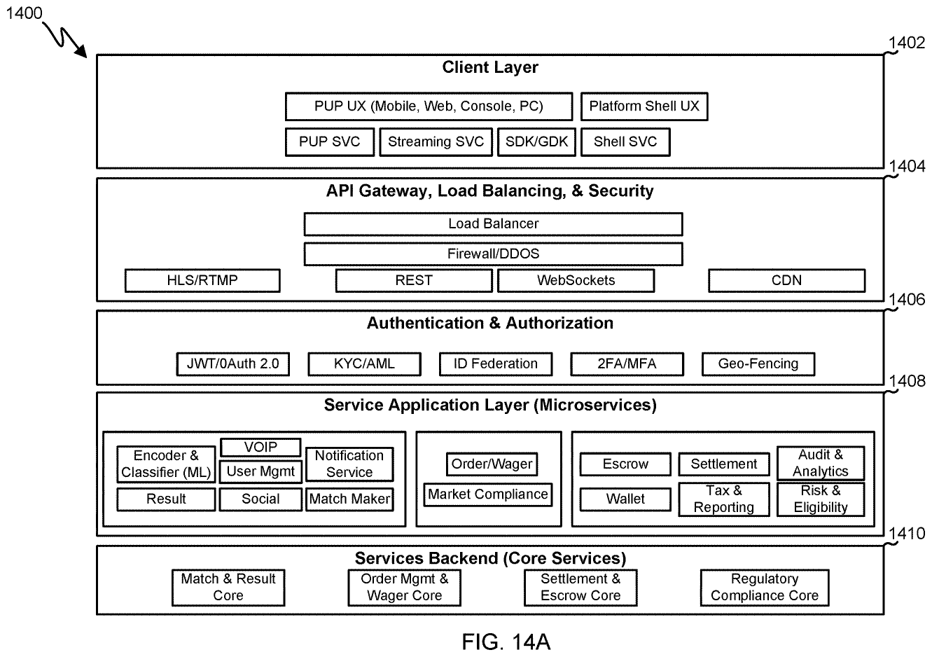

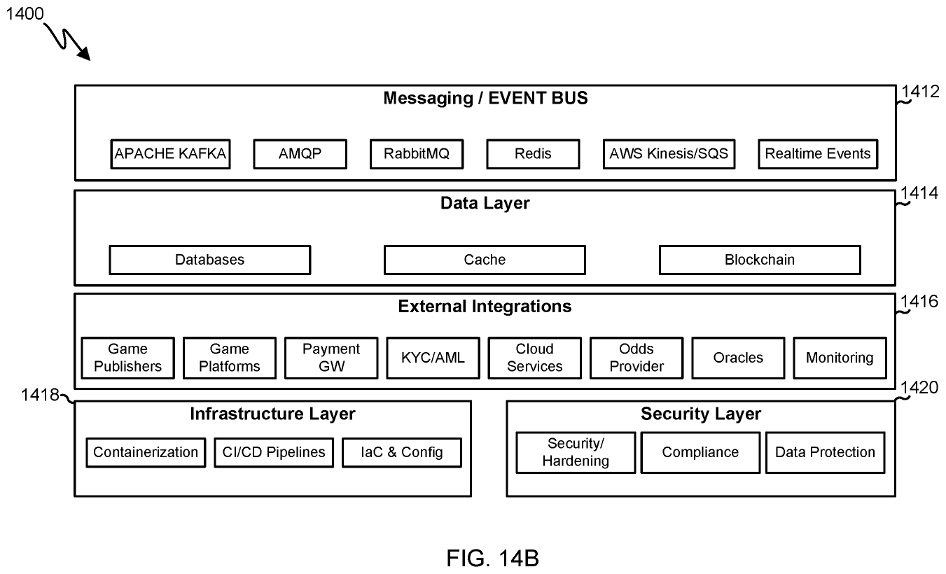

FIGS. 14A and 14B illustrate an example system architecture 1400 in accordance with this disclosure. For ease of explanation, the architecture 1400 shown in FIGS. 14A and 14B can be described as being performed or implemented by using the electronic device 101, or one or more electronic devices 101, in the network configuration 100 of FIG. 1. However, the architecture 1400 could be performed or implemented using any other suitable device(s), such as the server 106 or a combination of devices, and in any other suitable system(s). In various embodiments, the system architecture 1400 used alternatively or in addition to the system architecture 1300.

As shown in FIG. 14A, the system architecture 1400 includes a client layer 1402. The client layer 1402 may include a PUP user experience (UX) for applications such as web, mobile, desktop, and console applications and an associated PUP service (SVC). This provides Cross-platform applications built with modern web technologies providing PUP functionality: sign-in/up, wager creation/management, wallet operations, and/or social sharing. The architecture 1400 can also provide for platform-specific overlays for gaming platforms such as PLAYSTATION, XBOX, and NINTENDO integrating PUP into the gaming experience.

The client layer 1402 may also include a platform shell UX and an associated shell SVC for providing overlays and notifications. This provides native platform integration providing overlays, modals, dialogs, notifications using platform SDKs. The client layer 1402 may also include a streaming SVC that is used as a streaming client service for video capture of games being executed in association with the PUP applications. This provides for capturing a gameplay video feed and streaming the feed to PUP services for ML/AI-based results determination, as described in various embodiments of this disclosure. The client layer 1402 may also include SDK and/or game development kit (GDK) integration for platform native features. This can provide interfaces with 3rd party platform SDKs (e.g., PLAYSTATION SDK, XBOX GDK) to enable platform-native features like party creation, invites, and/or matchmaking.

The system architecture 1400 can also include an API gateway, load balancing, and security layer 1404 to provide user experiences across all supported platforms and devices. The API gateway provides a single entry point with authentication, rate limiting, and request routing. The layer 1404 can include a load balancer to distribute requests across service instances, firewall and distributed denial of service (DDOS), HTTP live streaming (HLS) and/or real-time messaging protocol (RTMP), Representational State Transfer (REST), WebSockets, and content distribution network (CDN) functionalities.

The system architecture 1400 can also include an authentication and authorization layer 1406 to ensure secure access and compliance with regulatory requirements. The layer 1406 can include JavaScript Object Notation (JSON) web token (JWT) and/or OAuth 2.0 for secure token-based authorization for secure API access, ID Federation for single sign-on using trusted 3rd party identity providers (GOOGLE, FACEBOOK, MICROSOFT), KYC/AML compliance verification for identity verification (one-time or periodic) using government ID, payment instruments, device fingerprinting, and/or IP analysis, as well as continuous monitoring for anti-money laundering, multi-factor authentication (e.g., two-factor authentication (2FA)/multi-factor authentication (MFA)) for account security, and/or geo-fencing for jurisdictional compliance that uses IP-based location detection to ensure the system is only being used in allowed jurisdictions.

The system architecture 1400 can also include a service application layer 1408 to provide scalable, stateless microservices handling user requests. In various embodiments, the service application layer 1408 can be stateless and act as a front door for the architecture 1400. The layer 1408 can include an encoder & classifier service for ML/AI video processing that encodes video streams from clients, applies ML/AI models to classify game outcomes (win/loss/draw), and generates confidence scores, as described in various embodiments of this disclosure. The layer 1408 can also include a results service (multi-method result determination) that determines match results using multiple methods, e.g., publisher API callback, ML/AI stream analysis, and user dual-consent. The results service can provide Intelligent routing based on the game and availability.

The layer 1408 can also include a user management service that provides sign-in/up, profiles, reputation scoring, preferences, account linking, notifications, and consents. The layer 1408 can also include a social service that provides friends lists, stats, leaderboards, and social media integration. The layer 1408 can also include notification services for multi-channel notifications (in-app, push, email) for transactional (match coordination) and non-transactional communications. The layer 1408 can also include a match maker service that coordinates match sessions, generates events, manages lobby/party creation, and sends invites. The layer 1408 can also include an order and wager service that provides for order creation, validation, position management, cancellation, and wager matching.

The layer 1408 can also include a market compliance service that provides real-time sanction screening, transaction monitoring, jurisdictional ruleset evaluation, and automated FX and tax management. The layer 1408 can also include a wallet service that deposits, withdrawals, transfers, PUP Coin balance management, transaction history, payment processing, FX conversion, and partner wallet integration (all existing and future platform wallets). The layer 1408 can also include an escrow service that allocates, reserves, holds, and releases funds as trustee following defined rules.

The layer 1408 can also include a settlement service that calculates awards after deduction of fees and taxes following local regulations. The layer 1408 can also include a tax and reporting service that structures data for automatic reporting and regulatory enforcement. The layer 1408 can also include a risk and eligibility service that provides fraud detection, AML checks, exposure calculation, reputation management, and audit trails. The layer 1408 can also include an audit and analytics service that provides market statistics, user analytics, wagering volumes, liquidity metrics, and performance monitoring.

The system architecture 1400 can also include a services backend layer 1410 (or core services layer) to provide stateful core engines with strict access controls. For example, the layer 1410 can include an order and wager core engine that provides a real-time order book per market, matches opposing wagers, handles partial fills and cancellations, and emits events for matched bets. The layer 1410 can also include a match and result core engine that provides automated arbitration and dispute resolution and authoritative result determination and recording. This can include performing ML/AI match determination, as described in the various embodiments of this disclosure. In addition to and as part of the backend and AI verification, in various embodiments, voice over IP (VOIP) can be integrated to confirm wagers as well as winners. The layer 1410 can also include a settlement and escrow core engine (atomic transactions) that provides bet settlement, payout calculation, fee deduction, taxation, atomic balance updates, and transaction safety guarantees. The layer 1410 also can include a regulatory compliance core that provides a centralized compliance rules engine and audit trail management. The layer 1410 can also provide restricted access via a dedicated security tenant.

The system architecture 1400 can also include various other infrastructure and data layers, such as a messaging and event bus layer 1412, a data layer 1414, an external integrations layer 1416, an infrastructure layer 1418, and a security layer 1420. The messaging and event bus layer 1412 can include various services such as APACHE KAFKA, Advanced Message Queuing Protocol (AMQP), RABBITMQ, a remote dictionary server (REDIS), AMAZON WEB SERVICES (AWS) KINESIS/SIMPLE QUEUE SERVICE (SQS), and real-time events services. The data layer 1414 can provide database, cache, and blockchain services. The external integrations layer 1416 can provide integrations with game publishers, game platforms, payment gateways, KYC/AML, cloud services, odds providers, oracles, and monitoring services. The infrastructure layer 1418 can prove containerization, continuous integration (CI)/continuation delivery (CD) pipelines, and infrastructure as code (IaC) services. The infrastructure and data layers can thus provide various features such as a hot path using in-memory data structures, REDIS, real-time streaming, etc., a warm path using cache layers, search indices, time-series database(s), etc., a cold path using a data warehouse(s), an audit trail, and ML/AI training data, and event streaming (e.g., via KAFKA), message queues, external integrations, etc.

The layered architecture of the system architecture 1400 provides technical sophistication not found in the existing approaches and enables complete system implementation with software engineering patterns.

Although FIGS. 14A and 14B illustrate one example of a system architecture 1400, various changes may be made to FIGS. 14A and 14B. For example, various components and functions in FIGS. 14A and 14B may be combined, further subdivided, replicated, or rearranged according to particular needs. Also, one or more additional components and functions may be included if needed or desired.

The various embodiments of this disclosure provide for a plurality of innovative systems and processes. For example, the PUP architecture includes a dual-path result determination process that enables both API-based and ML-based verification with intelligent fallback. This includes an ML stream analysis engine that is platform-agnostic and determines game outcomes from video streams without publisher integration. The PUP architecture can also include an escrow engine that locks funds from counterparties and releases only on verified outcomes to minimize fraud and provides defensible revenue. The PUP architecture can also include a multi-currency wallet that Supports fiat, crypto, Pony Up Coins, and in-game credits with real-time FX to maximize global addressable market. The PUP architecture can also include a cross-platform plug-in and API that embeds wagering function natively into a game OS or IP, enabling rapid adoption of the PUP systems and processes. The PUP architecture can also include a reg-tech layer that provides for various services such as KYC, AML, and geo-fencing to ensure jurisdictional compliance automatically. The PUP architecture also includes a microservices architecture that provides a stateless front-door and a stateful core with security tenant isolation, instilling a scalable production system. The PUP architecture can also include a generalized verification framework that enables outcome verification across gaming, fitness, educational, creative domains. The PUP architecture can also include GPS trace verification that verifies physical location-based challenges with anti-spoofing. The PUP architecture can also include a multi-modal ML pipeline that provides a unified architecture for video, audio, text, and biometric verification. The PUP architecture can also provides for future platform abstraction, as the architecture can supporting brain computer interfaces (BCIs), holographic platforms, quantum platforms, etc.

Current issues in the industry include that cross-platform liquidity is limited, as most incumbents are siloed to a single console, mobile OS, or lack cloud-based support. There also exist trust deficits stemming from manual result verification, disputed payouts, and lack of automated arbitration. Also, there is regulatory uncertainty where many offerings blur the line between skill-based competition, games of chance, and community challenges. Integration barriers tend to prevent support for most games.

The various embodiments of the PUP systems and processes of this disclosure, however, provide for an integrated escrow that removes counterparty risk and automates settlement, a dual-path result determination that enables instant multi-game support, ML-based verification that eliminates publisher integration barriers, a plug-in architecture that reduces integration to minimal lines of code, a reg-tech toolkit that provides out-of-the-box KYC/AML, geo-blocking, and audit trails, a multi-currency wallet that supports fiat, crypto, and Pony Up coins, and automated arbitration and dispute resolution that fully integrated with the system.

It will be understood that the benefits provided by the PUP systems and processes of the various embodiments of this disclosure are not limited to only video games, but can be expanded to a variety of other domains. For example, the PUP architecture provides a generalizable infrastructure for peer-to-peer skill-based competitions across numerous domains by providing, as a component across various possible domains, automated result verification combined with trustless escrow settlement. This applies whenever two or more parties wish to stake value on a verifiable outcome, the outcome depends on participant skill rather than chance, and/or objective determination of results is possible through digital means.

As one non-limiting example domain, the PUP architecture can be used in fitness and athletic challenges. For example, this could include a community running challenge. Take, as one example, a first user (Sarah) challenging a second user (Sarah's neighbor, Mike) to see who can run around their neighborhood block faster. Using the PUP architecture, Sarah creates a challenge specifying the route (GPS coordinates), stake ($20), and time window (Saturday morning), Mike accepts the challenge, and both stakes get held in escrow. Both participants then run the route with the PUP mobile app tracking them via GPS. The ML verification analyzes GPS traces to confirm route completion and timing, and a winner is automatically determined, with settlement executed within seconds. Social sharing of the outcome can then be shared to a neighborhood community group. This scenario thus involves using GPS trace verification using ML analysis of movement patterns, anti-fraud detection for GPS spoofing (accelerometer correlation, cellular tower triangulation, impossible speed detection), route boundary geofencing for completion verification, and photo/video checkpoint verification at designated waypoints.

Other possible fitness applications of the PUP architecture could include step count challenges (verified via APPLE HEALTH/GOOGLE FIT API integration, etc.), cycling distance/speed challenges (such as using STRAVA API integration or native GPS), swimming lap challenges (such as using smartwatch integration), weightlifting challenges (such as using video verification of lifts), yoga/flexibility challenges (such as using a pose estimation machine learning model), and/or CROSSFIT workout competitions (such as using video verification).

As another non-limiting example domain, the PUP architecture can be used in educational competitions. For instance, the PUP architecture could be used to facilitate a spelling bee challenge, such as at a homeschool co-op that organizes weekly spelling competition with small prizes. In such a scenario, an organizer could create a tournament with an entry fee and a prize pool, parents could register children with age-appropriate word lists, live video of spelling rounds can be obtained with ML speech recognition verification, automated advancement and bracket management could be provided, and prize distribution could be provided to winners. This type of challenge can be implemented with age-gated pools with appropriate difficulty scaling, parental consent workflows for minor participants, and educational exemptions for regulatory compliance. Other educational examples could include math competition tournaments, typing speed challenges (keyboard input verification), language learning challenges (pronunciation scoring), trivia competitions (timed response verification), coding challenges (automated test case verification), and/or chess and strategy game tournaments.

As another non-limiting example, the PUP architecture can be used in creative competitions. For instance, the PUP architecture could be used to facilitate a Photography Contest where, for example, a photography club runs a monthly themed photo competition. In such a competition, an organizer could set themes, deadlines, entry fees, and judging criteria, and participants could submit photos with a stake. Community voting or judge panel scoring could be used, with prize distribution provided to winners. Also, ML verification of photo authenticity (e.g., not AI-generated, not previously published) could be used in the competition. This type of challenge can be implemented with image authenticity verification (e.g., AI generation detection, reverse image search), metadata verification (e.g., capture date, device information), a community voting system (e.g., with Sybil resistance), and/or judge panel tools with blind review. Other creative challenges can include music performance competitions (e.g., audio quality scoring), art speed-creation challenges (e.g., timelapse verification), writing competitions (e.g., plagiarism detection, word count verification), video creation challenges (e.g., editing skill evaluation), and/or design competitions (e.g., community voting).

As another non-limiting example, the PUP architecture can be used in professional skill competitions. For instance, the PUP architecture could be used to facilitate a sales performance challenge in which a sales team runs a monthly competition for highest conversion rate. In such an example, a manager can create the competition with defined metrics and a stake pool, participating sales reps can opt in with personal stakes, CRM integration can verify sales performance data, an automated winner determination can be based on defined metrics, and prize distribution can be implemented with tax documentation. This type of challenge can be implemented with enterprise CRM integration (e.g., SALESFORCE, HUBSPOT), data verification and anti-gaming detection, team vs. individual competition modes, and/or corporate compliance and tax reporting. Additional professional application of the PUP architecture can include developer coding sprints (e.g., GITHUB commit verification), customer service performance (e.g., ticket resolution metrics), recruiting competitions (e.g., hire metrics), trading competitions (e.g., paper trading verification), and/or project completion challenges (e.g., milestone verification).

As another non-limiting example, the PUP architecture can be used in prediction markets and forecasting. For instance, the PUP architecture could be used to facilitate a weather Prediction Challenge in which friends compete to predict next week's high temperature. In such a competition, participants submit predictions with stakes, official weather data is obtained from a verified source, closest prediction wins according to defined rules are determined, and an automated settlement is provided. This type of challenge can be implemented with integration with authoritative data sources (e.g., National Oceanic and Atmospheric Administration (NOAA), sports leagues, election results), prediction timestamp verification, partial scoring for near-correct predictions, and/or pool betting mechanics for multi-participant markets. Other prediction markets and forecasting examples can include sports outcome predictions (e.g., score predictions), entertainment predictions (e.g., award shows, chart performance), business metric predictions (e.g., internal forecasting competitions), and/or scientific replication challenges.

As another non-limiting example, the PUP architecture can be used in social challenges and dares. For instance, the PUP architecture could be used to facilitate a New Year's resolution accountability challenge in which a friend group creates accountability stakes for resolutions. In such a challenge, each participant declares a resolution and verification method, stakes are locked for a defined period (e.g., with monthly check-ins), verification via photo evidence, app data, or group attestation can be used, and/or funds can be released to successful participants, whereas failed stakes can be released to charity or winners. This type of challenge can be implemented with flexible verification methods (e.g., photo, API, attestation), multi-party consensus for attestation-based verification, charitable donation integration for failed stakes, and/or long-duration escrow management. Other social challenges and dares examples can include habit tracking challenges, learning goal competitions (e.g., course completion verification), diet/health challenges (with appropriate safeguards), community service hour competitions, and/or reading challenges (e.g., page count or book completion).

The PUP architecture of the various embodiments of this disclosure can be used on various gaming platforms now known or developed in the future. For example, the PUP architecture can be used with PLAYSTATION (PS5/PS6), including providing SDK Integration where PLAYSTATION Partners SDK for overlay rendering, trophy system integration, and party management, video capture using PS5 share functionality API for gameplay recording and/or direct HDMI capture via companion device for ML verification, authentication using PLAYSTATION Network SSO via OAuth 2.0 with PSN token validation, notifications using PSN push notification system for match reminders and settlement confirmations, and where either a closed ecosystem uses publisher partnership for full overlay functionality, or ML provides integration-free alternative.

As another example, the PUP architecture can be used with XBOX (Series X|S/Next-Gen), including SDK Integration using XBOX Game Development Kit (GDK) for overlay rendering, achievement integration, and party chat, video capture using XBOX Game DVR API, AZURE PLAYFAB integration for cloud recording, authentication using MICROSOFT Account SSO, XBOX LIVE token validation, and notifications using XBOX notification system, companion app fallback. As another example, the PUP architecture can be used with NINTENDO SWITCH (Current and Successor(s)), including SDK Integration using NINTENDO SDK for limited overlay functionality, video capture using SWITCH capture button API, HDMI capture for extended recording, and authentication using NINTENDO Account SSO.

As another example, the PUP architecture can be used with PC gaming platforms such as STEAM/VALVE, with SDK Integration using STEAMWORKS SDK for overlay (similar to STEAM overlay), achievement tracking, friend lists, video capture using Native screen capture, STEAMVR integration for VR titles, authentication using STEAM OPENID, and STEAM GUARD 2FA passthrough. As another example, the PUP architecture can be used with PC gaming platforms such as the EPIC GAMES STORE, with SDK Integration using EPIC ONLINE SERVICES (EOS) SDK for account linking, matchmaking, video capture using platform-agnostic capture, EOS leaderboard integration, authentication using EPIC Account SSO. As another example, the PUP architecture can be used with PC gaming platforms such as WINDOWS Native (Non-Store), with a standalone WINDOWS application with DirectX/Vulkan hook for providing an overlay, video capture using WINDOWS.Graphics. Capture API or DXGI desktop duplication. As another example, the PUP architecture can be used with PC gaming platforms such as MACOS, using a native MACOS application with METAL integration, and video capture using ScreenCaptureKit framework (MACOS 12.3+).

As another example, the PUP architecture can be used with mobile gaming platforms such as IOS (IPHONE/IPAD) with SDK Integration using GAMEKIT for Game Center integration, STOREKIT for in-app purchases, video capture using REPLAYKIT for gameplay recording with user consent, authentication using sign in with APPLE, Game Center SSO, and compliance using App Store Review Guidelines Section 3.1.1 (contests requiring skill). As another example, the PUP architecture can be used with mobile gaming platforms such as ANDROID with SDK Integration using Google Play Games Services for achievements, leaderboards, matchmaking, video capture using MEDIAPROJECTION API for screen recording, and authentication using GOOGLE Sign-In, and PLAY GAMES SSO.

As another example, the PUP architecture can be used with cloud gaming platforms such as XBOX CLOUD GAMING (XCLOUD) with AZURE-based, GDK compatible integration, video capture using server-side capture via AZURE MEDIA SERVICES. As another example, the PUP architecture can be used with cloud gaming platforms such as PLAYSTATION NOW/PREMIUM CLOUD video capture using client-side capture of streaming video and can be treated like standard PLAYSTATION integration with network latency considerations. As another example, the PUP architecture can be used with cloud gaming platforms such as NVIDIA GEFORCE NOW with video capture using server-side via NVIDIA encoding and client-side capture. As another example, the PUP architecture can be used with cloud gaming platforms such as AMAZON LUNA with AWS-based and LUNA controller integration and video capture using AWS media services integration.

As another example, the PUP architecture can be used with virtual reality (VR) and/or augmented reality (AR) gaming platforms such as META QUEST (QUEST 3/QUEST PRO/Future Devices) with SDK integration using META XR SDK, video capture using QUEST recording API and META AVATARS for identity verification, authentication using META Account SSO, and motion-based gameplay verification with spatial tracking data as verification signal. As another example, the PUP architecture can be used with VR/AR gaming platforms such as PLAYSTATION VR2 with integration using PS5 SDK with PSVR2 extensions, and video capture using PS5 capture system with eye-tracking data potential. As another example, the PUP architecture can be used with VR/AR gaming platforms such as STEAMVR/VALVE INDEX with integration using the OPENXR standard and/or STEAMVR SDK, and video capture using STEAMVR compositor capture. As another example, the PUP architecture can be used with VR/AR gaming platforms such as APPLE VISION PRO with integration using VISIONOS SDK and/or REALITYKIT, video capture using VISIONOS recording APIs, and authentication using APPLE ID SSO.

As another example, the PUP architecture can be used with emerging and future gaming platforms such as brain-computer interfaces (NEURALINK, KERNEL, OPENBCI), with integration using neural signal APIs for intent verification and thought-controlled wagering confirmation, and verification using neural pattern matching for identity verification and direct game state access via neural link. As another example, the PUP architecture can be used with emerging and future gaming platforms such as holographic/volumetric Displays with integration using spatial UI rendering and gesture-based interaction and verification using volumetric capture for enhanced game state analysis. As another example, the PUP architecture can be used with emerging and future gaming platforms such as advanced haptic systems with integration using haptic feedback for wager confirmation and touch-verified consent and verification using haptic pattern matching for user verification. As another example, the PUP architecture can be used with emerging and future gaming platforms such as autonomous agent gaming where AI agents compete in games on behalf of users with integration using agent API for programmatic wagering and agent identity verification, and compliance using clarification of skill-based determination when agents compete. As another example, the PUP architecture can be used with emerging and future gaming platforms such as quantum gaming platforms such as using quantum random number generation for fair matchmaking and quantum-secured communications.

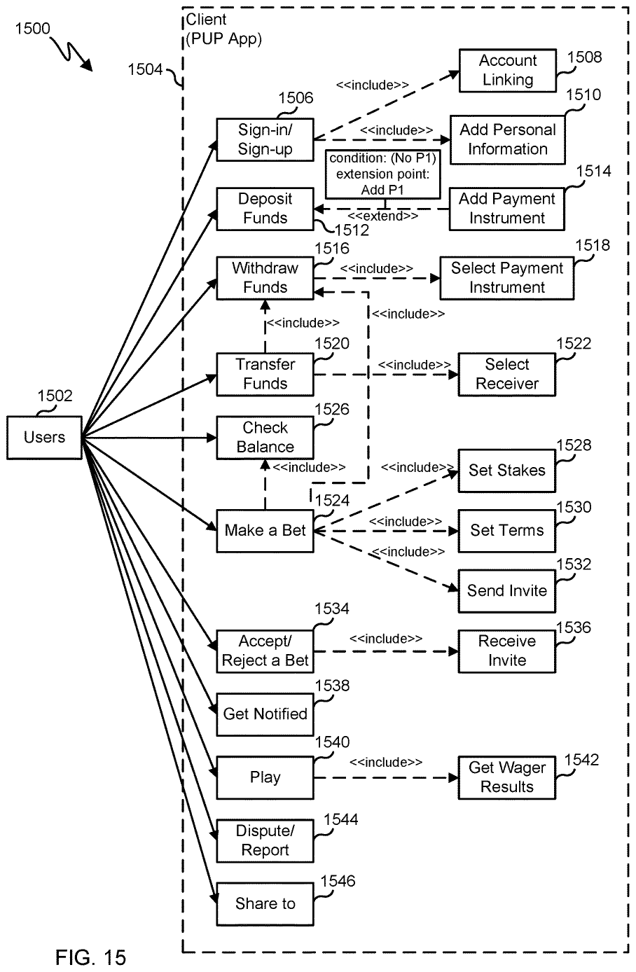

FIG. 15 illustrates an example peer-to-peer game wagering activity diagram 1500 in accordance with this disclosure. For ease of explanation, the functions and operations of the activity diagram 1500 shown in FIG. 15 are described as being performed using the electronic device 101 in the network configuration 100 of FIG. 1. However, the functions and operations of the activity diagram 1500 could be performed using any other suitable device(s), such as the server 106 or a combination of devices, and in any other suitable system(s).

As shown in FIG. 15, users 1502 can interact with various features provided by a client application 1504, e.g., the PUP application. For example, a user 1502 can interact with a sign-in/sign-up operation 1506 provided by the client application 1504 that can include an account linking operation 1508 to link other accounts associated with the user (e.g., PSN, XBOX LIVE, etc. accounts) with the client application 1504. The sign-in/sign-up operation 1506 can also include a personal information addition operation 1510 to allow the user 1502 to provide personal information for setting up an account with the PUP application/platform. The user 1502 can also interact with a deposit funds operation 1512 that can include a payment instrument addition operation 1514 that can be used to add a payment method for the user 1502. As shown in FIG. 15, the deposit funds operation 1512 can be triggered when no player one is registered and a player one needs to be added to conduct the wager.

The user 1502 can also interact with a withdraw funds operation 1516 that can include a payment instruction selection operation 1518. The withdraw funds operation 1516 can be linked with other operations such as a transfer funds operation 1520, that can include a receiver selection operation 1522, and a “make a bet” operation 1524. The “make a bet” operation 1524 allows the user 1502 to perform a check balance operation 1526, as well as a set stakes operation 1528 and a set terms operation 1530 to set the amount of money and parameters of the bet. The “make a bet” operation 1524 can also include a “send invite” operation 1532 to allow the user 1502 to send an invitation to another user to participate in the bet.

The user 1502 can also interact with an accept/reject operation 1534 that can include an invitation receipt operation 1536, to allow a user 1502 to either accept or reject an invitation to participate in a bet. The user 1502 can also interact with a notification operation 1538 that allows a user to choose to receive notifications pertaining to events such as successful setting up of wagers, wager outcomes, fund transfers, etc.

The user 1502 can also interact with a play operation 1540 that can be used in various embodiments to track the outcome of a game/match or other event, and can include a results operation 1542 that determines and provides a result of the game/match or other event. The user 1502 can also interact with a dispute/report operation 1544 that allows the user 1502 to file a dispute in the event the user 1502 believes there was a problem with the parameters of a wager or the outcome of the wager. The user 1502 may also interact with a sharing operation 1546 that allows a user to share a wager and/or the outcome of a wager to another platform, such as a social media platform.

One scenario in accordance with various embodiments of this disclosure can include a scenario in which Gary is an enthusiastic gamer with impressive skills in EA SPORTS FC. He enjoys challenging others and often wagers money to motivate his friends to play, particularly Lara, who insists on being the top player. Previous approaches, however, presented various problems, such as that it is difficult to organize cross-platform matches (Gary on PC, Lara on PLAYSTATION), friends would forgot to join scheduled matches, manual collection and payment of wagers would be needed, there might be disputes over who actually won, and there was no reliable arbitration.

The Pony Up platform, however, alleviates these issues. Using the PUP, Gary can create an account with KYC verification, link his gaming accounts (STEAN, PSN, XBOX LIVE), add a payment instrument to his wallet, create a wager (e.g., EA SPORTS FC, $10 stake, Sunday 2 pm), with funds automatically reserved in escrow, and send an invite link to Lara via a messaging app. Lara receives the invite and clicks the invite link, signs up/signs in to the PUP, and accepts the wager and stake amount, with her $10 matched and placed in escrow. Both Gary and Lara receive confirmation notifications. Then, on the match/wager event day, both players receive reminder notifications, check-in notifications are sent 15 minutes before the match, both players check in within the time window, the PUP coordinates the match session (cross-platform), and the match proceeds in game. A result based on the outcome of the match is then determined. For example, if EA SPORTS has API integration with the PUP, then the game publisher automatically reports the result to the PUP. In some embodiments, if EA SPORTS does not have API integration, Gary's and Lara's clients stream the gameplay of the match, and the PUP ML system determines the winner with a high confidence (e.g., 97% confidence). Then, settlement occurs. For example, if Lara wins, the result is verified and recorded, fees and taxes are calculated (e.g., $0.50 platform fee, $1.50 tax withholding), a net payout (e.g., $18.00) is credited to Lara's wallet, both Gary and Lara receive settlement notifications, and Lara optionally shares her win on social media. A full audit trail is maintained for compliance.

Thus, the PUP provides an end-to-end wager lifecycle sequence. For instance, this sequence can include authentication in which Player A signs up/signs-in (2FA/MFA, JWT tokens), wager order creation in which Player A creates a wager in the PUP application, selects a game from a supported list, defines wager terms (stakes, rules, timing), sets a date/time or an immediate match, specifies a stake amount, and selects currency (USD, EUR, crypto, PUP Coins), wager pre-authorization in which the PUP validates wager parameters, checks Player A eligibility (KYC status, jurisdiction, reputation), reserves funds from wallet and moves the funds to escrow, generates a unique invite link or code, and creates a pending wager order using an order service of the PUP, and wager order acceptance in which Player B receives an invite (messaging, in-game, email), Player B authenticates if needed, the PUP validates Player B eligibility, Player B reviews and accepts wager terms, a digital signature captured (consent record), Player B funds are matched and held in escrow, and both players are notified of the confirmed wager. The lifecycle sequence can also include match creation in which players are reminded of a scheduled match (if not immediate), check-in notifications are sent to both players, both players check in via PUP within a time window, a match maker service coordinates the game session, a platform-specific party/lobby is created (if supported), and the match commences.

The lifecycle sequence can also include match result reporting in which a decision is made on whether publisher API integration is available. If so, the match completes and a publisher service sends an authenticated callback, a results service validates the session and extracts data, and anomaly detection checks for fraud patterns. In various embodiments as described in this disclosure, if publisher API integration is not available, a streaming client captures gameplay video, an encoder service processes the stream of the gameplay video, an ML/AI Classifier detects win/loss patterns, a confidence score is generated, and the results are accepted if the confidence is above a threshold (e.g. 95%). In some embodiments, If the confidence is not above the threshold, the match can be decided via a fallback to manual review by PUP or dual-consent between the players. To achieve dual consent, both players report outcome independently and, if there is agreement, the result is accepted, or, if there is disagreement, arbitration is initiated.

The lifecycle sequence can also include wager outcome determination in which a winner is identified by the chosen method, the result is validated against fraud detection, the outcome is recorded in an immutable ledger, an audit trail is updated, and both parties are notified. The lifecycle sequence can also include wager settlement in which a settlement service calculates awards, platform fees are deducted (e.g., 2.5%), applicable taxes are calculated based on jurisdiction, tax withholding is applied per local regulations, escrow releases net proceeds, the winner's wallet is credited automatically, the loser's wallet is updated (funds released from escrow), the transaction is recorded in a ledger, and a settlement notifications is sent. The lifecycle sequence can also include post-match processes in which social media sharing is enabled (optional), reputation scores are updated, statistics and leaderboards are updated, the wallet allows withdrawal to bank or partner platforms, and a full audit trail is available for regulatory reporting.

Although FIG. 15 illustrates one example of a peer-to-peer game wagering activity diagram 1500, various changes may be made to FIG. 15. For example, various components and functions in FIG. 15 may be combined, further subdivided, replicated, or rearranged according to particular needs. Also, one or more additional components and functions may be included if needed or desired.

In various embodiments, the complete wager lifecycle is broken down into four distinct activity workflows, each demonstrating specific technical implementations and decision logic, such as creating a match wager, accepting a wager invitation, playing a match and reporting results, and releasing escrow and performing settlement.

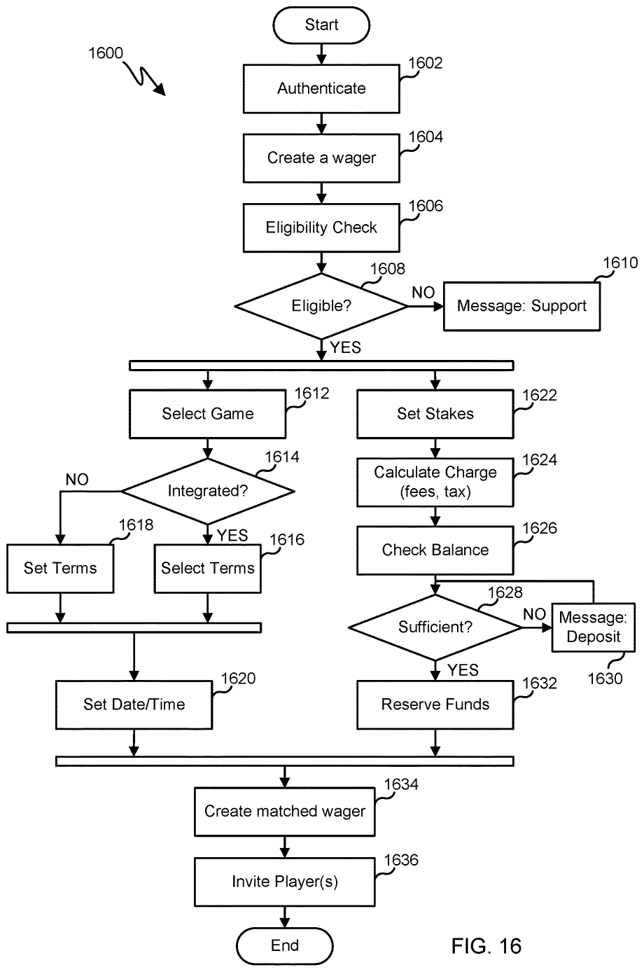

FIG. 16 illustrates an example matched wager creation process 1600 in accordance with this disclosure. For ease of explanation, the functions and operations of the process 1600 shown in FIG. 16 may be described as being performed using the electronic device 101 in the network configuration 100 of FIG. 1. However, the functions and operations of the process 1600 could be performed using any other suitable device(s), such as the server 106 or a combination of devices, and in any other suitable system(s).

The process 1600 demonstrates, for various embodiments, a specific technical implementation of order creation with regulatory compliance checkpoints and secure fund handling. At step 1602, an authentication operation is performed in which at least one player (e.g., a Player A) is authenticated using, for example, multi-factor authentication (2FA/MFA), session token generation (JWT), and/or device fingerprinting for fraud detection. At step 1604, a wager creation operation is performed in which a game is selected, such as from a supported catalog, wager terms are defined (stakes, rules, timing), a date/time for a match or other event is scheduled, or immediate match is initiated, and currency is selected (e.g., fiat, crypto, PUP Coins). At step 1606, an eligibility check/validation operation is performed, which can include performing a KYC status verification, a jurisdiction compliance check, an age verification, and/or an account standing review. If, at step 1608, it is determined the user/player is not eligible, the user may be directed a message from a support service related to the PUP at step 1610.

If, at step 1608, it is determined that the user/player is eligible to create a wager, then the user can select a game for the wager at step 1612. At step 1614, it is determined whether the selected game is integrated with the PUP platform. If so, at step 1616, the user can select terms associated with the game as supported by the PUP platform. If not, at step 1618, the user can set custom terms for the match. In various embodiments, custom terms can be set in addition to, or alternative of, terms provided by the PUP platform for integrated games. At step 1620, the user sets a date/time for the wager/match.

In various embodiments, the PUP platform can perform certain tasks related to the match creation, simultaneously or around the same time as steps 1612-1620. For example, stakes as selected by the user can be set at step 1622. At step 1624, charges are calculated that can include appropriate fees and taxes. At step 1626, a wallet balance associated with the user is checked. At step 1628, it is determined if the balance is sufficient to cover the charges for the wager. If not, at step 1630, the user can be provided a message to deposit additional funds to cover the wager. The process 1600 may loop back to step 1628 after step 1630, or the process 1600 may end if a sufficient deposit is not made. If, at step 1628, it is determined that there are sufficient funds to cover the charges for the wager, at step 1632, the funds are reserved in an escrow account. In various embodiments, the fund reservation process includes using atomic transactions.

At step 1634, a matched wager is created in the PUP system according to the terms and stakes of the wager. At step 1636, one or more other users/players are invited to participate in the created matched wager. This can include generating an invitation with unique invite link/code creation, encryption of wager parameters, setting an expiration time to accept the wager, and sharing mechanism activation.

Although FIG. 16 illustrates one example of a matched wager creation process 1600, various changes may be made to FIG. 16. For example, while shown as a series of steps, various steps in FIG. 16 could overlap, occur in parallel, occur in a different order, or occur any number of times (including zero times).

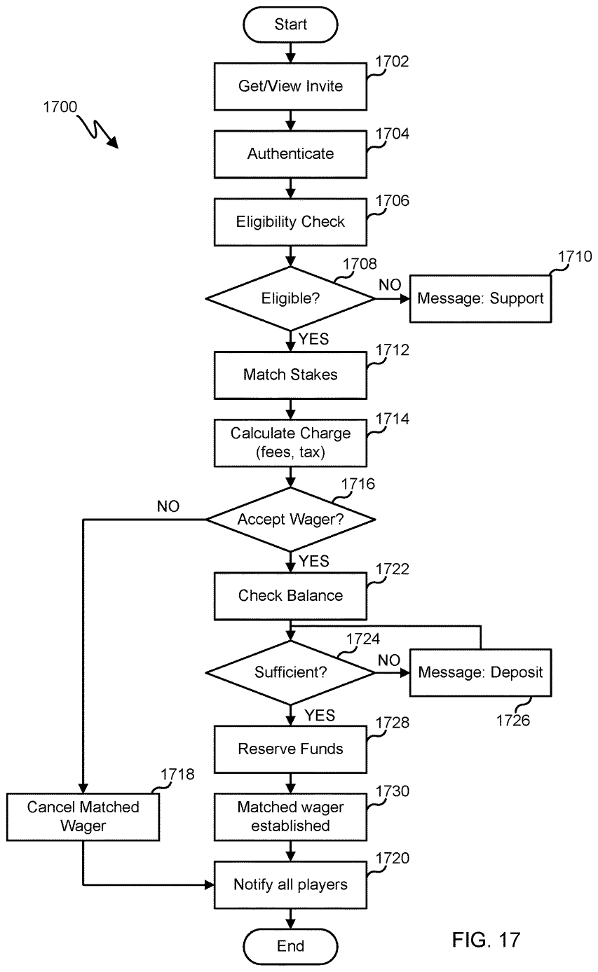

FIG. 17 illustrates an example wager invitation acceptance process 1700 in accordance with this disclosure. For ease of explanation, the functions and operations of the process 1700 shown in FIG. 17 may be described as being performed using the electronic device 101 in the network configuration 100 of FIG. 1. However, the functions and operations of the process 1700 could be performed using any other suitable device(s), such as the server 106 or a combination of devices, and in any other suitable system(s). It will be understood that the process 1700 may occur after the process 1600 in various embodiments.

The process 1700 demonstrates that the PUP system provides bilateral consent mechanisms with sophisticated compliance checks and atomic multi-party escrow funding. At step 1702, a user/player (e.g., a Player B) receives and views an invitation to participate in a matched wager, such as in response to step 1636 of FIG. 16. The invitation can include a clickable/selectable link or a code entry mechanism. Invite validation and decryption, as well as an expiration check, can be performed with respect to the invitation. At step 1704, an authentication operation is performed regarding the user/player who received the invitation. This can include performing a sign-in or registration operation, conducted 2FA/MFA, and/or session establishment.

At step 1706, an eligibility check/verification is performed with respect to the user/player, which can include a geographic location check (geo-fencing), age and identity verification, jurisdiction-specific rule evaluation, and/or sanction screening. If, at step 1708, it is determined the user/player is not eligible, then, at step 1710, the user may be directed a message from a support service related to the PUP. If, at step 1708, the user/player is deemed eligible to participate, then, at step 1712, match stakes may be agreed to or different stakes may be negotiated between the users/players, and relevant charges can be calculated at step 1714. At step 1716, it is determined if the user/player accepts the matched wager. Wager review and acceptance can include display of complete terms to the user/player, risk disclosure presentation, digital signature capture, and consent recording. If, at step 1716, the user does not accept the matched wager, the matched wager is cancelled at step 1718 and all players are notified of the cancellation at step 1720.

If, however, at step 1716, the user/player accepts the wager, at step 1722, the user's wallet balance is checked. At step 1724, it is determined whether the user/player has sufficient funds needed to participate in the wager. If not, at step 1726, the user can be provided a message to deposit additional funds to cover the wager. The process 1700 may loop back to step 1724 after step 1726, or the process 1700 may end if a sufficient deposit is not made. If, at step 1724, it is determined that there are sufficient funds to cover the charges for the wager, at step 1728, the funds are reserved in an escrow account. In various embodiments, this fund matching and reservation process can include the aforementioned wallet balance verification, currency conversion if needed, pre-authorization and escrow transfer, and atomic matching with Player A funds.

At step 1730, the matched wager is established and, at step 1720, all participating players are notified. This can also include setting a wager status set to “Active,” initiating match scheduling/calendaring, and updating an audit trail for the wager.

Although FIG. 17 illustrates one example of a wager invitation acceptance process 1700, various changes may be made to FIG. 17. For example, while shown as a series of steps, various steps in FIG. 17 could overlap, occur in parallel, occur in a different order, or occur any number of times (including zero times).

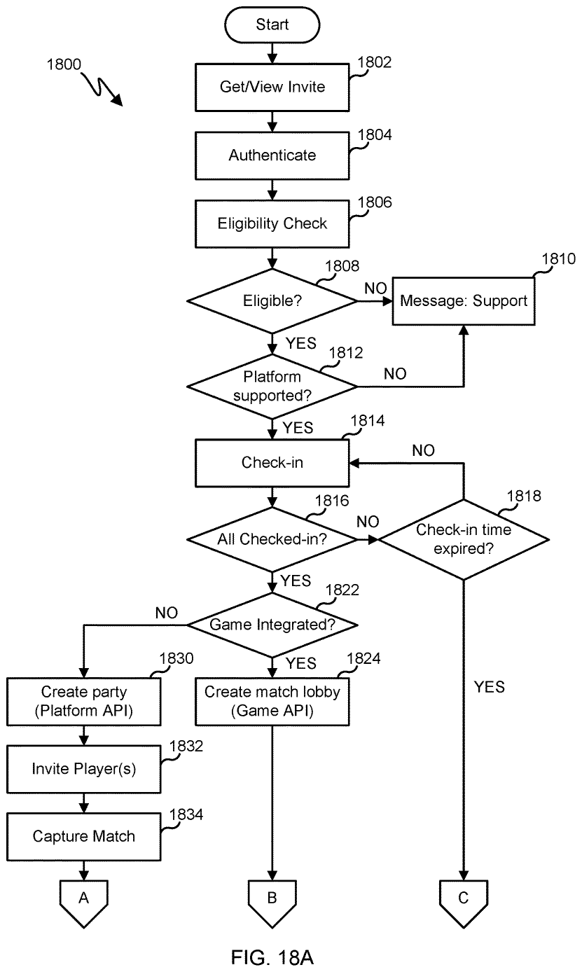

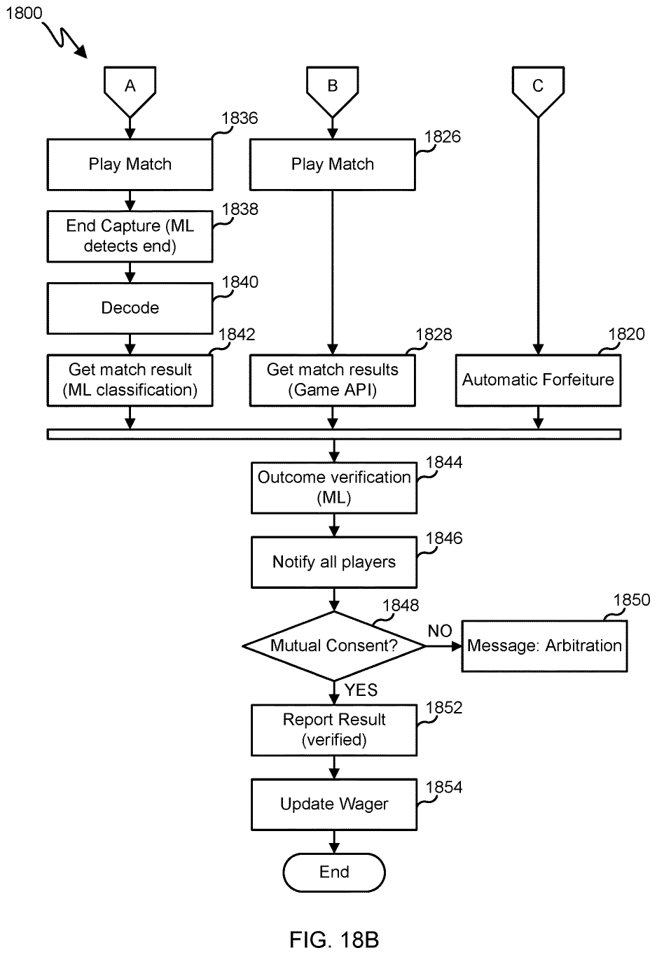

FIGS. 18A and 18B illustrate an example match performance and result reporting process 1800 in accordance with this disclosure. For ease of explanation, the functions and operations of the process 1800 shown in FIGS. 18A and 18B may be described as being performed using the electronic device 101 in the network configuration 100 of FIG. 1. However, the functions and operations of the process 1800 could be performed using any other suitable device(s), such as the server 106 or a combination of devices, and in any other suitable system(s). It will be understood that the process 1800 may occur after the processes 1600 and 1700 in various embodiments.

The process 1800 demonstrates the PUP provides for complete dual-path result determination with specific technical implementations. At step 1802, a user/player receives and views an invitation to participate in a matched wager. In various embodiments, one or more reminder notifications can be sent regarding the scheduled matched wager, with option calendar integration, as well as time zone synchronization. At step 1804, an authentication operation is performed. This can include performing a sign-in or registration operation, conducted 2FA/MFA, and/or session establishment. At step 1806, an eligibility check/verification is performed with respect to the user/player, which can include a geographic location check (geo-fencing), age and identity verification, jurisdiction-specific rule evaluation, and/or sanction screening. If, at step 1808, it is determined the user/player is not eligible, then, at step 1810, the user may be directed a message from a support service related to the PUP.

If, at step 1808, the user/player is deemed eligible to participate, then, at step 1812, it is determined if the platform for the game/wager is supported by the PUP system. If not, a support message may be sent at step 1810. In some embodiments, the platform support check could be performed as part of the process 1600 or 1700. If, at step 1812, it is determined the process is supported, then, at step 1814, a player check-in operation is performed. The player check-in operation can include opening a check-in window (e.g., 15 minutes before a scheduled matched wager), the players confirm readiness, conducting timeout handling for no-shows, and automatic wager cancellation if check-in failed.

For example, at step 1816, it can be determined if all users/players associated with the matched wager have checked-in. If not, at step 1818, it is determined if the check-in window has expired. If not, the process moves back to step 1814. If the check-in window has expired, then, at step 1820, an automatic forfeiture for at least that missing user/player is issued. At step 1816, once all participating players are deemed as checked-in, at step 1822 it is determined whether the game selected for the matched wager is integrated such that the outcome of the match is provided by the game to the PUP system. If so, at step 1824, a match lobby is created via the game's API, the match is played at step 1826, and match results are received by the PUP at step 1828. In various embodiments, performing a matched wager with an integrated game can include receiving a game publisher API callback, service-to-service authentication, match data extraction, and anomaly validation.

If, at step 1822, it is determined that the game is not integrated, then, at step 1830, a party is created via the PUP API, and players are invited to the party at step 1832. In various embodiments, this session coordination provided by either step 1824 or steps 1830-1832 can include using platform-specific SDK calls for match creation, using PUP platform capabilities used for invites and party management, cross-platform lobby coordination, and player authentication within the game environment. At step 1834, a match capturing operation is initiated and, at step 1836, the match is played. The match capturing operation is, in various embodiments, a video capture and streaming function of the PUP application that captures video of the gameplay of the match, e.g., from each user/player, and streams the gameplay video to the PUP system backend to determine an outcome of the match using ML/AI models of the PUP system. Thus, even where a game is not integrated with the PUP system such that the game transmits match outcome results to the PUP system, the PUP system can still determine the outcome of matches. In some embodiments, the match capturing operation 1834 and use of the ML/AI models for match outcome determination may be used when it is determined a game is not integrated, or, in some embodiments, may even be used for integrated games as well to verify game outcomes or to provide training data for the ML/AI models. In various embodiments, the local encoding and optimization of the video feed using an on-device ML model via the PUP application on the user device/gaming device can be used. In various embodiments, streaming transmissions of the captured video gameplay to the PUP system can be encrypted.

At step 1838, the match capturing operation ends, due to detection of an ending of the match. At step 1840, server-side decoding of the streamed gameplay video is performed and, at step 1842, a match determination result is obtained using the ML/AI model(s). In various embodiments, the ML/AI model(s) are trained to perform pattern matching using game result patterns (test data), such as patterns and object identification in game UIs that show game scores, match results, etc. In various embodiments, the ML/AI model(s) can be trained on specific games, or trained to recognize patterns in a variety of games. An ML classifier can thus determine the outcome of the match. In various embodiments, this can include using confidence scoring and determining whether the confidence score is above a threshold confidence level. In various embodiments, correlation and association of the video feed to a matched wager is also performed, and a metadata and results package can be created.

At step 1844, the match outcome is verified by performing wager validation against match data, which can also be performed using the ML/AI model(s). Fraud detection algorithms may also be applied. At step 1846, all participating players are notified of the match outcome. In various embodiments, mutual consent of the match outcome can be obtained from the users/players. For example, at step 1848, it is determined if there is mutual consent between the users/players. If not, at step 1850, an arbitration process can be conducted. If so, at step 1852, the results of the match are reported and the wager is updated at step 1854.

Although FIGS. 18A and 18B illustrates one example of a wager invitation acceptance process 1800, various changes may be made to FIGS. 18A and 18B. For example, while shown as a series of steps, various steps in FIGS. 18A and 18B could overlap, occur in parallel, occur in a different order, or occur any number of times (including zero times).

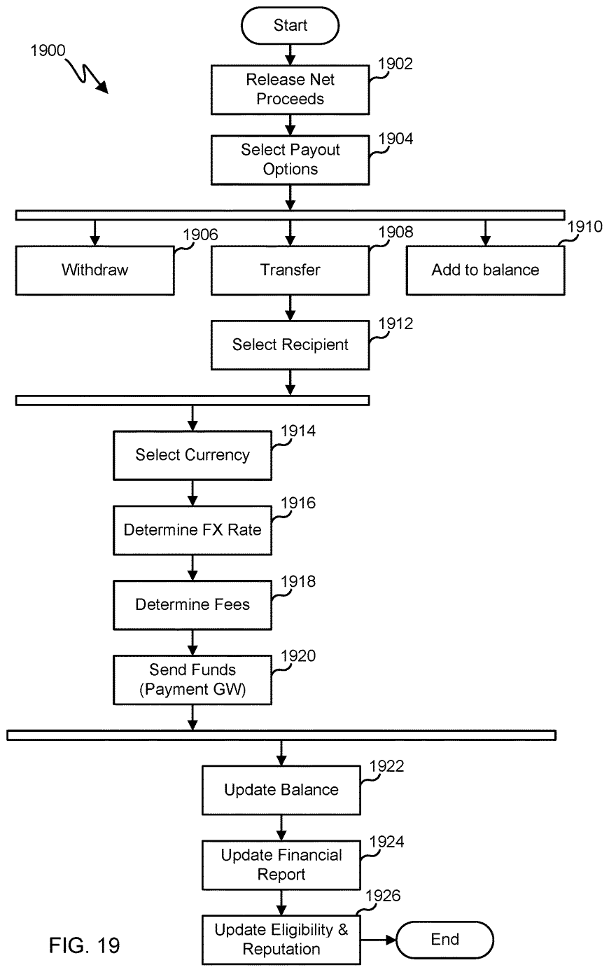

FIG. 19 illustrates an example escrow release and settlement process 1900 in accordance with this disclosure. For ease of explanation, the functions and operations of the process 1900 shown in FIG. 19 may be described as being performed using the electronic device 101 in the network configuration 100 of FIG. 1. However, the functions and operations of the process 1900 could be performed using any other suitable device(s), such as the server 106 or a combination of devices, and in any other suitable system(s). It will be understood that the process 1900 may occur after the process 1600, 1700, and 1800 in various embodiments.

FIG. 19 demonstrates atomic multi-step settlement with regulatory compliance and sophisticated state management and shows how distributed escrow operates with transactional safety guarantees. At step 1902, following a matched wager result determination process, net proceeds are released from escrow, which can include performing an atomic escrow unlock operation. At step 1904, payout options are selected. For example, this can include performing a withdraw from a user's wallet at step 1906, performing a transfer from the user's wallet at step 1908, and/or adding to the user's balance at step 1910. At step 1912, a recipient, e.g., the winner of the match, is selected to receive the payout. At step 1914, a currency type is selected and, at step 1916, an exchange rate is determined, if needed. At step 1918, fees for the transaction are determined. For example, when a winner is determined from the result service of the PUP system, a stake amount is retrieved, and a platform fee calculation (e.g., 2.5%), as well as applicable taxes based on jurisdiction, can be calculated, and a regulatory withholding determination can be performed.

In some embodiments, the escrow release can include performing loser refund handling (if applicable for partial scenarios). It can also include performing wallet operations such as transaction atomicity guarantees, concurrent update protection (distributed locking), and currency conversion if a withdrawal is requested. At step 1920, funds are sent to the winner, such as via a payment gateway, and the users' balances are updated at step 1922. A financial report can also be updated at step 1924, and a user's eligibility and reputation can also be updated at step 1926.

In various embodiments, notifications can also be sent, such as settlement completion messages, detailed breakdowns (stakes, fees, taxes, net payout), transaction receipt generation, and social sharing enablement (optional). An audit trail can also be maintained, audit trail where an Immutable ledger is recorded, timestamps and participant IDs are tracked, complete transaction details are logged, and regulatory reporting data is logged. Various steps may also be performed post-settlement. For example, a rematch can be set up where a user/player sends a rematch invitation, fund withdrawal can be sent to external accounts, transfers can be performed to partner platform wallets, and the settlement can be kept in the PUP wallet for future wagers.

Although FIG. 19 illustrates one example of an escrow release and settlement process 1900, various changes may be made to FIG. 19. For example, while shown as a series of steps, various steps in FIG. 19 could overlap, occur in parallel, occur in a different order, or occur any number of times (including zero times).

In various embodiments of this disclosure, the processes described herein use a state machine architecture in which each activity diagram or flowcharts represents a state machine with defined transitions: —States: Initial, Processing, Validated, Committed, Completed, Failed—Transitions: Triggered by user actions, system events, or timeouts—Rollback mechanisms for failed transitions—Idempotency for safe retries. External integration points can include gaming platform SDKs for native match coordination, a streaming service for video capture and transmission, payment processors for fund movements, an ML classification service for result determination, and regulatory reporting APIs for compliance automation. SDK capabilities can be used for automated invites and party management. The processes can also use PUP streaming service activation, local encoding and optimization, then transmission, pattern matching, correlation, and association with test data, and results validation and handoff to settlement.

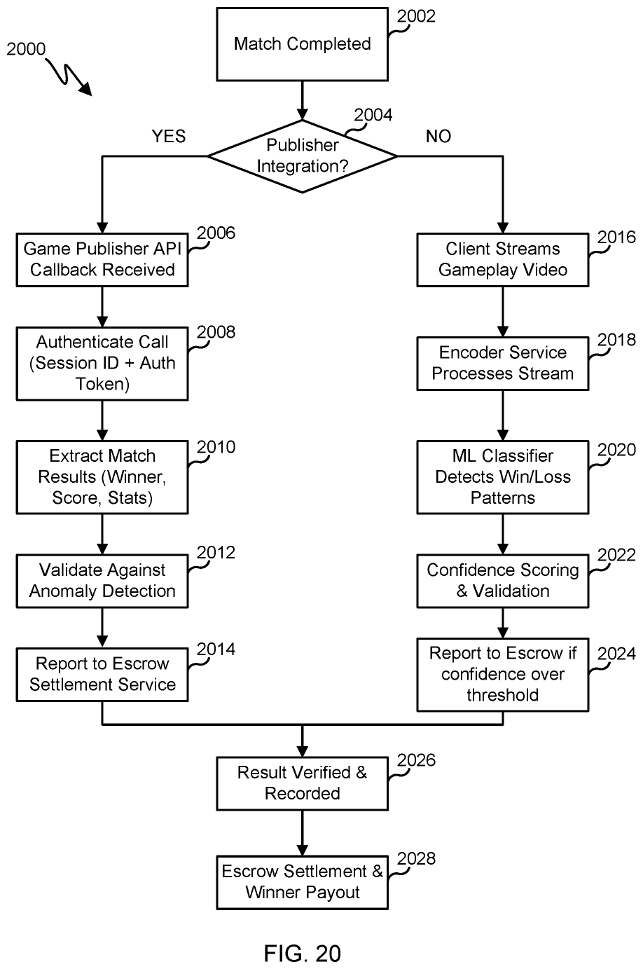

FIG. 20 illustrates an example dual-path result determination process 2000 in accordance with this disclosure. For ease of explanation, the functions and operations of the process 2000 shown in FIG. 20 may be described as being performed using the electronic device 101 in the network configuration 100 of FIG. 1. However, the functions and operations of the process 2000 could be performed using any other suitable device(s), such as the server 106 or a combination of devices, and in any other suitable system(s).

As shown in FIG. 20, at step 2002, a match is completed. At step 2004, it is determined if publisher integration exists with the PUP system for the game from which the match was played. If so, at step 2006, a game publisher API callback is received. At step 2008, the call is authenticated, such as by using a session ID and authorization token. At step 2010, match results (e.g., winner, score, stats) are extracted via the call. At step 2012, the results are validated against an anomaly detection process and the results are reported to an escrow settlement service at step 2014. This provides a direct service-to-service API integration with game publishers using API calls that provides low latency results determination (e.g., less than 500 ms), high accuracy (e.g., 99.9%+), but of course requires a publisher partnership.

If, however, at step 2004, it is determined that the game publisher is not integrated with the PUP system, an ML/AI-based approach can be used to analyze video streams of gameplay to determine a winner for the match. At step 2016, a client (e.g., the PUP application) captures and streams a gameplay video, such as to a server of the PUP, and, at step 2018, an encoder service processes the stream. Then, at step 2020, a ML/AI classifier detects win/loss patterns in the gameplay video, such as UI elements or other indicia of match determination, and, at step 2022, confidence scoring on the results determination is performed and results are validated. For example, if the confidence score is higher than a threshold amount, the results can be validated. Then, at step 2024, the results are reported to the PUP escrow service. This ML/AI-based approach solves any “integration barrier” problems that may limit previous peer-to-peer platforms by enabling result determination without publisher cooperation to support thousands of games. This ML/AI-based approach is platform agnostic, works with any visual game, requires no publisher integration, has high accuracy (e.g., 95-98%) and low latency (e.g., less than 5 seconds).

This provides real-time video stream processing during live gameplay, a multi-model ensemble ML approach for robustness, confidence-based automatic vs. manual routing, fraud detection via anomaly analysis of streaming patterns, and no dependency on publisher cooperation or game-specific APIs

Regardless of which of the two paths are taken for results determination in the process 2000, at step 2026, the results are verified and recorded in the PUP system, and, at step 2028, escrow settlement and winner payout operations are performed.

Although FIG. 20 illustrates one example of a dual-path result determination process 2000, various changes may be made to FIG. 20. For example, while shown as a series of steps, various steps in FIG. 20 could overlap, occur in parallel, occur in a different order, or occur any number of times (including zero times).

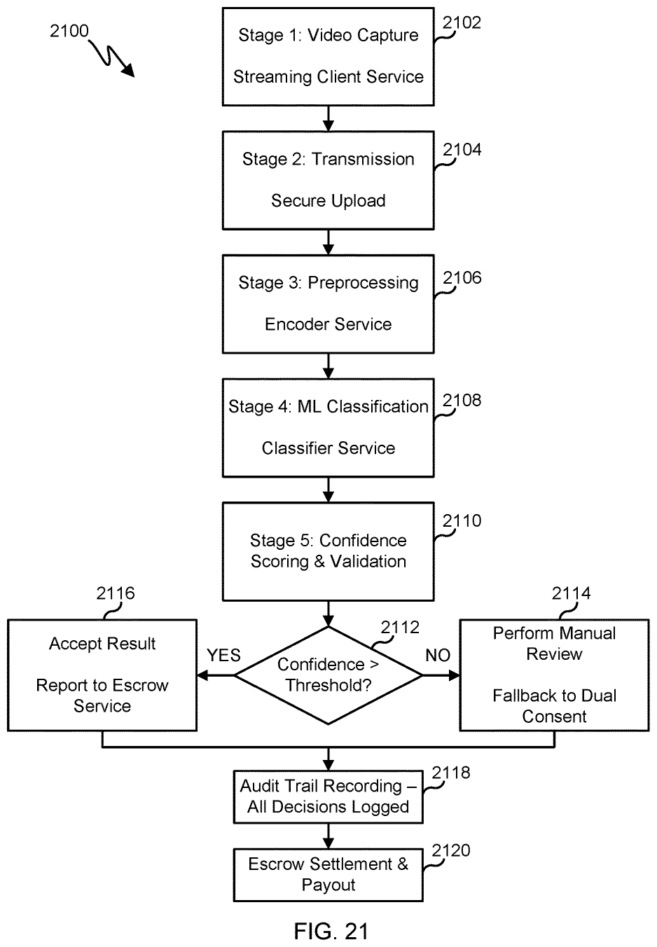

FIG. 21 illustrates an example ML/AI-based stream analysis pipeline process 2100 in accordance with this disclosure. For ease of explanation, the functions and operations of the process 2100 shown in FIG. 21 may be described as being performed using the electronic device 101 in the network configuration 100 of FIG. 1. However, the functions and operations of the process 2100 could be performed using any other suitable device(s), such as the server 106 or a combination of devices, and in any other suitable system(s).

As shown in FIG. 21, at step 2102, as part of a first pipeline stage, video is captured by a streaming client service, such as by the PUP application running on the client gaming device. In various embodiments, the streaming client service captures gameplay video feed and encodes the video, such as via an H.264 or H.265 codec. In some embodiments, the frame rate and resolution for the video can be adaptive based on bandwidth (e.g., variable between 30-60 FPS and 720p-1080p). In some embodiments, the streaming client service can also perform overlay detection to identify game-specific UI elements.

At step 2104, as part of a second pipeline stage, the captured video is transmitted via a secure upload by the streaming client service, such as to a server of the PUP system. The second pipeline stage can include using encryption such as TLS 1.3 encryption, for video data, an adaptive bitrate streaming protocol (e.g., WebRTC or similar), low-latency transmissions (e.g., less than 2 second delay), and is resilient to network interruptions with buffer management.

At step 2106, as part of a third pipeline stage, preprocessing is performed on the uploaded video, such as by an encoder service of a server of the PUP system. This third pipeline stage can include performing frame extraction at key moments (game events, score changes), image normalization and enhancement, region of interest (ROI) detection focusing on score displays or winner announcements, etc., and temporal alignment with known game timing patterns

At step 2108, as part of a fourth pipeline stage, ML/AI classification is performed on the video data to determine a result of a match. This can include performing object detection and/or pattern recognition on the visual video data, such as that described in the various embodiments of this disclosure. In some embodiments, the ML/AI classification can be performed using at least one convolutional neural network (CNN) trained for image recognition of game UI elements, score displays, winner screens, etc. In some embodiments, the ML/AI classification can be performed using at least one Long Short-Term Memory (LSTM) Network trained for temporal pattern recognition (game progression, climactic moments). In various embodiments, transfer learning can be used on pre-trained models to fine-tune the models on specific game visual patterns. In some embodiments, ensemble method can be used to provide multiple model predictions combined with weighted voting. Training Data for training the ML/AI model(s) can include thousands of labeled match recordings across popular games, and the model(s) can be continuously updated with new game releases. Adversarial training examples can also be used to enable fraud pattern detection. The model(s) output a winner determination (e.g., Player A, Player B, or Draw), a confidence score (0-100%), key evidence frames supporting determination, and anomaly flags if suspicious patterns are detected.

At step 2110, as part of a fifth pipeline stage, confidence scoring and validation is performed to determine a final result using the confidence score with respect to the ML/AI results determination. In various embodiments, this can include performing a Bayesian confidence estimation combining multiple model outputs, cross-validation across different model architectures, anomaly detection for potential manipulation or fraud, and historical accuracy tracking per game and model.

Then, at step 2112, it is determined whether the confidence score is above a threshold value. If not, manual review can be performed and/or the system can fallback to dual consent. The process 2100 then moves to step 2118. If, however, at step 2112, it is determined the confidence score is above the threshold, then, at step 2116, the result is accepted and report to the escrow service of the PUP system. For example, decision rules can include that, if the confidence score is ≥95%, there is automatic acceptance and reporting to escrow. If the confidence score is between 80-94%, the results are flagged for quick manual review (e.g., <30 seconds). If the confidence score is <80%, fallback to dual-consent or manual arbitration can be triggered.

In various embodiments, the pipeline's performance can be optimized using GPU acceleration for real-time inference, model quantization for reduced latency, batch processing of frames for efficiency, and edge caching of models for low-latency access.

At step 2118, an audit trail for the wager is recorded and all decisions are logged. At step 2120, escrow settlement and a payout in accordance with the determined match results are performed.

Although FIG. 21 illustrates one example of an ML/AI-based stream analysis pipeline process 2100, various changes may be made to FIG. 21. For example, while shown as a series of steps, various steps in FIG. 21 could overlap, occur in parallel, occur in a different order, or occur any number of times (including zero times).

As described in this disclosure, such as shown in FIGS. 20 and 21, this disclosure provides for a dual-path result determination system in which the PUP system implements an innovative dual-path approach to determining match outcomes, providing both high-accuracy publisher integration and platform-agnostic ML-based analysis. This solves issues with traditional peer-to-peer wagering platforms that may require deep integration with each game publisher to verify match results, which creates a massive barrier to entry, as platforms can only support games where they have established publisher partnerships. This limitation has prevented previous platforms from achieving broad game coverage. The dual-path result determination system of this disclosure solves this through an intelligent dual-path system that can: 1. Use publisher API integration when available (Option A), 2. fall back to ML-based stream analysis when a publisher API is unavailable (Option B), 3. automatically select the optimal verification method for each match, and 4. maintain high accuracy and reliability across both paths.

In various embodiments, the ML/AI models can include various structures, mathematical formulations, training methodologies, ensemble strategies, and per-game optimization procedures for the result confirmation engine. The ML/AI architectures of this disclosure are designed to maximize classification accuracy across heterogeneous game titles, capture modalities, and video quality conditions while preserving calibration integrity for confidence-based routing decisions.

In various embodiments, where a CNN is used for at least part of performing the results determination, the CNN may have an architecture including a base architecture of a ResNet-50 backbone pre-trained on ImageNet, with final classification layers replaced for game-specific fine-tuning, input dimensions: 224×224×3 RGB images (resized from source frames), feature extraction layers, e.g., 50 convolutional layers organized in residual blocks with skip connections, a classification head using Global average pooling, e.g., 2048-unit dense layer→512-unit dense layer with ReLU, 3-unit softmax output (e.g., Player A Win, Player B Win, Draw), regularization using dropout (p=0.5) between dense layers and L2 weight regularization (λ=0.001). The CNN, in various embodiments, can be trained using an Adam optimizer, a learning rate 1e-4 with cosine annealing, a batch size of 32, and 50 epochs with early stopping. It will be understood that the CNN architecture details provided herein are but some examples, and other architectures for the CNN may be used without departing from the scope of this disclosure. The CNN serves as the spatial pattern recognizer. It processes individual video frames to detect game-specific visual signals: victory/defeat overlays, score digits, health bars, timer displays, and match-end UI screens.

Various additional implementation details for embodiments of the CNN model are provided below.

TABLE 4
CNN Input Specification

| RAW | | | CNN | |
|---|---|---|---|---|
| FRAME | RESIZE | NORMALIZE | INPUT | TENSOR SHAPE |
| H × W × 3 | 224 × 224 | μ = [0.485, 0.456, 0.406] | 224 × 224 × 3 | [batch, 3, 224, 224] |
| (any | bilinear | σ = [0.229, 0.224, 0.225] | RGB | (PyTorch NCHW) |
| resolution) | | | | Value |
| | | | | range: ~[−2.1, +2.6] |
| | | | | after norm |

In various embodiments, each box below represents one stage. Numbers in parentheses are output tensor shapes after that stage. Arrows indicate data flow; skip connections are shown with [+].

TABLE 5
CNN Layer-by-Layer Architecture

| STAGE | OPERATION | OUTPUT SHAPE | KEY PARAMS |
|---|---|---|---|
| Input | Raw normalized frame | [B, 3, 224, 224] | RGB channels, |
| | | | ImageNet norm |
| Conv1 | 7 × 7 conv, stride 2, pad 3 → | [B, 64, 112, 112] | 64 filters, 7 × 7 kernel |
| | BN → ReLU | | |
| Pool1 | 3 × 3 MaxPool, stride 2 | [B, 64, 56, 56] | Halves spatial dims |
| Layer1 (×3) | Residual block: | [B, 256, 56, 56] | 64-64-256 channels per |
| | 1 × 1→3 × 3→1 × 1 conv | | block |
| | (bottleneck). Skip: identity | | |
| Layer2 (×4) | Bottleneck blocks + stride-2 | [B, 512, 28, 28] | 128-128-512 channels |
| | downsample Skip: 1 × 1 conv | | |
| | projection | | |
| Layer3 (×6) | Bottleneck blocks + stride-2 | [B, 1024, 14, 14] | 256-256-1024 channels |
| | downsample | | |
| Layer4 (×3) | Bottleneck blocks + stride-2 | [B, 2048, 7, 7] | 512-512-2048 channels |
| | downsample | | |
| GAP | Global Average Pooling | [B, 2048] | Spatial averaging over |
| | (7 × 7→1 × 1) | | 7 × 7 grid |
| FC-1 | Linear(2048→2048) + | [B, 2048] | Pre-trained weights |
| | Dropout(p = 0.5) + ReLU | | FROZEN during Stage |
| | | | 1 training |
| FC-2 | Linear(2048→512) + ReLU | [B, 512] | Fine-tuned |
| FC-out | Linear(512→3) + Softmax | [B, 3] | Classes: {A_win, |
| | | | B_win, Draw} |

In various embodiments, within every ResNet bottleneck block, the computation follows:

TABLE 6
Residual Block Details

Given input x:
F(x) = W3 · ReLU(BN(W2 · ReLU(BN(W1 · x)))) [bottleneck branch]

| | |
|---|---|
| y | = ReLU(F(x) + shortcut(x)) [add skip + activate] |

Where shortcut(x) = W_s · x if channel/stride mismatch,

x otherwise (identity shortcut)

BN(z) = γ · (z − μ_B)/√(σ²_β + ε) + β
μ_B = batch mean, σ²_B = batch variance, γ,β = learned scale/shift

In various embodiments, before the ResNet forward pass, a lightweight Region-of-Interest detector (e.g., a separate 5-layer CNN, ~200K params) identifies the most likely “result indicator zones” in the frame, e.g., scoreboard corner, center-screen announcement area, etc. These regions are cropped and concatenated with the full frame at the FC-1 stage via a learned gating vector.

TABLE 7
ROI Attention Mechanism

gate = sigmoid(W_g · [h_full ; h_roi]) h_full, h_roi ∈ R\hat{ }2048
h_fused = gate ⊙ h_full + (1 − gate) ⊙ h_roi
(⊙ = element-wise multiply)

In various embodiments, a recurrent neural network architecture can be used as at least a part of performing the ML/AI results determination. Such a recurrent neural network architecture can include a temporal analysis component that employs a bidirectional LSTM with an attention mechanism, an input including a sequence of e.g., 60 CNN feature vectors (representing 60 frames sampled across match), hidden dimension, such as 256 units per direction (512 total), attention such as a scaled dot-product attention over a temporal dimension, an output such as a 3-unit softmax aligned with CNN output classes. The recurrent neural network may be trained using the same optimizer configuration as the CNN and trained end-to-end with frozen CNN features.

The LSTM model reasons over time. Where the CNN sees single frames, the LSTM processes a sequence of CNN-derived feature vectors (one per sampled frame) and learns temporal patterns: score trajectories, momentum indicators, and the characteristic “end-of-match” signal profile that precedes winner announcements. It will be understood that the LSTM details provided herein are but some examples, and other architectures and implementation details for the LSTM may be used without departing from the scope of this disclosure. In various embodiments of this disclosure, details of the LSTM model can be as follows.

TABLE 8
Input Construction

| 4VIDEO | FRAME | CNN ENCODER | SEQUENCE | |
|---|---|---|---|---|
| SEGMENT | SAMPLE | (frozen after Stage 1) | TENSOR | LSTM INPUT |
| Full match | 60 frames | h_t = FC-1 output | [70, 2048] per | [B, 70, 2048] |
| recording | evenly | h_t ∈ R\hat{ }2048 | match | (batch, seq_len, |
| (5-90 min) | spaced + 10 | | | features) |
| | final-seg | | | |
| | frames = 70 | | | |
| | total | | | |

TABLE 9
Bidirectional LSTM Layer

| | | | Backward | Concat Output |
|---|---|---|---|---|
| Time Step t | Input x_t | Forward LSTM → | LSTM ← | h_t |
| t = 1 | x_1 ∈ | h→_1 ∈ R\hat{ }256 | h←_1 ∈ | [h→_1; h←_1] ∈ |
| | R\hat{ }2048 | | R\hat{ }256 | R\hat{ }512 |
| . . . | . . . | . . . | . . . | . . . |
| t = T | x_T ∈ | h→_T ∈ R\hat{ }256 | h←_T ∈ | [h→_T; h←_T] ∈ |
| | R\hat{ }2048 | | R\hat{ }256 | R\hat{ }512 |
| ATTENTION | ↓ All h_t | Scaled dot-product | Context c ∈ | |
| | stacked | attention over sequence | R\hat{ }512 | |
| OUTPUT | Context c | FC(512 → 3) + | P_lstm ∈ | |
| | | Softmax | R\hat{ }3 | |

After the BiLSTM produces H=[h_1, . . . , h_T]∈R\hat{ }{T×512}, an attention layer computes a weighted context vector:

TABLE 10
Scaled Dot Product Attention

| | | |
|---|---|---|
| Query: | Q = H · W_Q | W_Q ∈ R\hat{ }{512×64} |
| Keys: | K = H · W_K | W_K ∈ R\hat{ }{512×64} |
| Values: | V = H · W_V | W_V ∈ R\hat{ }{512×512} |

| | | |
|---|---|---|
| Scores: | A = softmax(Q·K\hat{ }T / √64) | A ∈ R\hat{ }{T×T} |
| Context: | c = (A · V).mean(dim=0) | c ∈ R\hat{ }512 |

| | |
|---|---|
| Final: | p_lstm = softmax(W_out · c + b_out) |

p_lstm ∈ R\hat{ }3 (probs for A_win, B_win, Draw)

In various embodiments, ensemble integration can be performed by using a voting mechanism in which a weighted average is taken of softmax outputs of the CNN model and the LSTM model. Weight learning can be performed to optimize weights per-game using validation set performance. A confidence calculation can be performed in which entropy-based confidence is derived from ensemble output distribution. The ensemble integration can also be calibrated using Platt scaling applied to produce well-calibrated probability estimates.

In various embodiments, the weighted ensemble provides a fusion of the CNN model and the LSTM model. Here, neither model alone may be optimal for all games or situations. For example, FPS games have rapid state changes well-captured by CNN frame analysis, while sports simulations have long match arcs better captured by LSTM temporal patterns. The ensemble combines both, with weights tuned per game title.

TABLE 11
Ensemble Prediction Formula

| Let: p_cnn = CNN softmax output | | p_cnn ∈ R\hat{ }3 |
|---|---|---|
| p_lstm = LSTM softmax output | | p_lstm ∈ R\hat{ }3 |
| α | = CNN weight (scalar) | α ∈ [0, 1] |
| β | = LSTM weight (scalar) | β = 1 − α |
| Ensemble prediction: | | |
| p_ens = α · p_cnn + β · p_lstm | | |
| = α · p_cnn + (1−α) · p_lstm | | |
| Predicted class: | | |
| ^{y} = argmax(p_ens) | | |
| = argmax_k { α · p_cnn[k] + (1−α) · p_lstm[k] } | | |
| Confidence score (entropy-based): | | |
| H(p_ens) = −Σ_k p_ens[k] · log(p_ens[k]) | | |
| conf | = 1 − H(p_ens) / log(3) | ∈ [0, 1] |

(log(3) = max entropy for 3-class; conf=1 means certain)

The scalar α is optimized independently for each supported game title using held-out validation data. The optimization minimizes validation cross-entropy loss over a 1D search.

TABLE 12
Per-Game Weight Optimization

```
Objective:
  α* = argmin_{α ∈ [0,1]} L_val(α)
Where:
  L_val(α) = (1/N) Σ_{i=1}\hat{ }{N} CE(y_i, p_ens_i(α))
    = −(1/N) Σ_{i=1}\hat{ }{N} log(p_ens_i(α)[y_i])
N = number of validation matches for this game title
y_i = ground-truth label (0=A_win, 1=B_win, 2=Draw)
Method: Golden Section Search on [0,1] - converges in ~20 evaluations
Fallback: Grid search with step 0.05 if validation set < 200 matches
```

The optimal weight a shifts in response to the following factors, re-evaluated any time model accuracy monitoring triggers a retraining cycle.

TABLE 12
Factors That Drive α Changes

| Factor | Mechanism | Effect on α | Example |
|---|---|---|---|
| Game visual | Games with | α decreases | Battle Royale |
| complexity | minimal/ambiguous UI yield | (more LSTM | end-screens vs. |
| | lower CNN accuracy on val | weight) | Chess board |
| | set → L_val(α) minimized at | | |
| | lower α | | |
| Match duration | Long-form matches provide | α decreases for | MOBA (45 |
| distribution | richer temporal signals → | longer games | min) vs. FPS |
| | LSTM gains relative | | round (5 min) |
| | advantage | | |
| CNN frame accuracy | If CNN val accuracy | α increases | New labeled |
| on val set | improves (new training data | | data for a game |
| | or architecture update), α re- | | patch |
| | optimizes upward | | |
| LSTM accuracy on | If LSTM temporal patterns | α decreases | Sports sim with |
| val set | become stronger (e.g., game | | reliable “match |
| | has consistent endgame | | complete” |
| | sequence), α re-optimizes | | animation |
| | downward | | |
| Validation set | Small N → high variance in | α is less | Newly |
| size | L val → conservative grid | precisely tuned | supported game |
| | search (step 0.05) used | | title with <200 |
| | instead of GSS, resulting in | | labeled |
| | coarser α | | matches |
| Model version | Any CNN or LSTM | α may shift in | Model |
| update | retraining triggers full α re- | any direction | accuracy |
| | optimization from scratch on | | threshold |
| | latest val set | | breach → |
| | | | retrain → re- |
| | | | optimize |
| Adversarial/ | Fraud detection flags | α recalculated | Cheating |
| manipulation | anomalous results → flagged | on clean data | incidents |
| events | matches excluded from α | only | removed from |
| | optimization to prevent | | val set |
| | contamination | | |
| Game patch/ | Publisher updates game UI → | α temporarily | EA Sports FC |
| visual update | CNN accuracy drops → α | decreases, then | seasonal update |
| | shifts toward LSTM until | re-optimizes | changes |
| | CNN retrained | post-retrain | scoreboard UI |

All per-game weights are stored in a centralized Alpha Registry service and versioned with each model release.

TABLE 13
α Registry and Update Protocol

Registry schema (per game title):
{

| | |
|---|---|
| “game_id”: | “eas_fc_25”, |

| | |
|---|---|
| “alpha_cnn”: | 0.72, |
| “alpha_lstm”: | 0.28, |
| “val_accuracy”: | 0.963, |

| | |
|---|---|
| “val n”: | 1842, |

“model_version”: “cnn_v3.1_lstm v2.4”,

| | |
|---|---|
| “updated_at”: | “2026-01-15T03:00:00Z”, |

| | |
|---|---|
| “trigger”: | “scheduled_retrain” |

```
}
Update triggers:
  1. Scheduled weekly refresh (if new val data available)
  2. Accuracy monitoring: if rolling-7d accuracy < (baseline - 3%), trigger immediately
  3. New game title added: cold-start with α = 0.5 until N ≥ 50 validation matches
  4. Manual override by ML ops team (requires two-person approval)
```

Raw ensemble scores are probability estimates but may be overconfident. Platt scaling (a 2-parameter logistic regression over the ensemble log it) is applied post-fusion to produce well-calibrated probabilities.

TABLE 14
Platt Scaling Calibration

| | |
|---|---|
| Raw logit: | z = log(p_ens[ŷ]) − log(1 − p_ens[ŷ]) (one-vs-rest) |
| Calibrated: | p_cal = σ(a · z + b) σ = sigmoid |

```
Parameters a,b fit on calibration set via log-loss minimization.
After calibration:
  conf_final = p_cal[ŷ]
  Route to auto-accept if conf_final ≥0.95
  Route to manual review if 0.80 ≤ conf_final < 0.95
  Route to dual-consent if conf_final < 0.80
```

The ML/AI models can be trained using various loss function and optimizations. Various training details according to embodiments of this disclosure are provided below.

In various embodiments, CNN model training can be performed in two stages, as shown for instance in Tables 15-17 below.

TABLE 15
Stage 1 CNN Training
Stage 1 - Feature Extraction (ResNet-50 backbone frozen)

Only FC-1, FC-2, FC-out layers are trainable.
Loss: Standard cross-entropy (CE) over 3 classes.
Purpose: Rapidly adapt classification head to game domain without
destroying ImageNet features.
Epochs: 10 | Learning Rate: 1e−3 | Batch Size: 64

TABLE 16
Stage 2 CNN Training
Stage 2 - Full Fine-Tuning (all layers trainable)

Backbone unfrozen with layer-wise learning rate decay.
Loss: Label-smoothed cross-entropy + L2 regularization.
Purpose: Optimize every layer end-to-end for game-specific patterns.
Epochs: 40 (early stopping) | LR: 1e−4 with cosine annealing | Batch: 32

TABLE 17
CNN Loss Function (Stage 2 Full Form)

```
Label-smoothed cross-entropy:
L_CE(θ) = −(1/N) Σ_{i=1}\hat{ }{N} Σ_{k=1}\hat{ }{3}
\tilde{y}_{i,k} · log(p_cnn(x_i; θ)[k])
Where label-smoothed target:
  \tilde{y}_{i,k} = (1−ε) · 1[y_i = k] + ε/3
  ε = 0.1 (smoothing factor - prevents overconfident predictions)
L2 regularization:
  Ω(θ) = λ · ||θ||² λ = 0.001
Total CNN loss:
  L_CNN(θ) = L_CE(θ) + Ω(θ)
Cosine annealing learning rate schedule:
  lr_t = lr_min + 0.5 · (lr_max − lr_min) · (1 + cos(πt / T_max))
  lr_max = 1e−4, lr_min = le−6, T_max = 40 epochs
Layer-wise LR decay (Stage 2):
  Layer4 LR = lr_t
  Layer3 LR = 0.3 · lr_t
  Layer2 LR = 0.1 · lr_t
  Layer1 LR = 0.03 · lr_t
  Conv1 LR = 0.01 · lr_t
```

In various embodiments, the LSTM model can be trained in two phases, as shown for instance in Tables 18 and 19 below.

TABLE 18
Phase A LSTM Training
Phase A - Pre-training on CNN features (CNN weights frozen)

LSTM trained on CNN feature sequences from Stage 1 CNN.
Enables efficient temporal learning without gradient interference.
Loss: Standard cross-entropy | Epochs: 20 | LR: 5e−4

TABLE 19
Phase B LSTM Training
Phase B - End-to-end fine-tuning

CNN (last 2 layers only) + LSTM jointly trained.
Loss: Same label-smoothed CE + L2 as CNN.
LR for CNN layers: 1/10th of LSTM layers.
Epochs: 20 additional | LR: 1e−4 | Grad clip: 1.0

TABLE 20
LSTM Loss Function

| LSTM total loss: | |
|---|---|
| L_LSTM(φ) = −(1/N) Σ_{i=1}\hat{ }{N} Σ_{k=1}\hat{ }{3} | |
| \tilde{y}_{i,k} · log(p_lstm(X_i; φ)[k]) | |
| + λ · \|\|φ\|\|² | |
| Gradient clipping (prevents exploding gradients in LSTM): | |
| if \|\|∇\|\|_2 > clip_val: ∇L ← ∇L · (clip_val / \|\|∇L\|\|_2) | |
| clip_val = 1.0 | |
| Adam optimizer (both CNN and LSTM): | |
| m_t = β1 · m_{t−1} + (1−β1) · g_t | [1st moment] |
| v_t = β2 · v_{t−1} + (1−β2) · g_t² | [2nd moment] |
| \hat{m}_t = m_t / (1 − β1\hat{ }t) | [bias correction] |

```
  \hat{v}_t = v_t / (1 − β2\hat{ }t)
  θ_t = θ_{t−1} − lr · \hat{m}_t / (√\hat{v}_t + ε)
  β1=0.9, β2=0.999, ε=1e−8
```

In various embodiments, during inferencing, outcome determination and probabilities can be calculated. Below are example operations executed at inference time, from raw video frames to a final confidence-routed decision.

TABLE 21
End-to-End Inference Pipeline

| Step | Operation | Math/Output | Latency | |
|---|---|---|---|---|
| 1 | Frame extraction | F = {f_1 . . . f_70} at adaptive intervals. Final 10 | ~50 | ms |
| | | from last 30 s. | | |
| 2 | Preprocess each | Resize 224 × 224, normalize (μ, σ ImageNet). | ~10 | ms/frame |
| | frame | ROI detect. | | |
| 3 | CNN encode all | h_t = CNN_encoder(f_t) ∈ R\hat{ }2048. Batch | ~300 | ms GPU |
| | frames | [70, 3, 224, 224]→[70, 2048] | | |
| 4 | CNN classify | p_cnn_t = softmax(W · h_t). p_cnn = (1/70)Σ | ~5 | ms |
| | (aggregate) | p_cnn_t | | |
| 5 | BiLSTM + | H = [h_1 . . . h_70]→BiLSTM→Attention→p_lstm | ~80 | ms GPU |
| | Attention | ∈ R\hat{ }3 | | |
| 6 | Weighted fusion | p_ens = α · p_cnn + (1 − α) · p_lstm (α from game | <1 | ms |
| | | registry) | | |
| 7 | Platt calibration | p_cal = sigmoid(a · log(p_ens[ŷ]/(1 − | <1 | ms |
| | | p_ens[ŷ])) + b) | | |
| 8 | Confidence | ≥0.95→Auto \| 0.80-0.95→Review \| | <1 | ms |
| | routing | <0.80→Dual-consent | | |

The complete derivation of the output probability for class k=A_win can be represented as follows.

TABLE 22
Full Probability Derivation

```
CNN path:
  p_cnn[A_win] = exp(z_cnn[A_win]) / (Σ_j exp(z_cnn[j]))
  where z_cnn = W_out · h_fused + b_out ∈ R\hat{ }3 (logits)
LSTM path:
  p_lstm[A_win] = exp(z_lstm[A_win]) / (Σ_j exp(z_lstm[j]))
  where z_1stm = W_out · c + b_out ∈ R\hat{ }3
  c = attention-weighted context from BiLSTM
Ensemble:
  p_ens[A_win] = α · p_cnn[A_win] + (1−α) · p_lstm[A_win]
Calibrated probability:
  logit_ens = log(p_ens[A_win]) − log(1 − p_ens[A_win])
  p_cal[A_win] = 1 / (1 + exp(−(a · logit_ens + b)))
Final decision:
```

| | |
|---|---|
| ŷ = argmax_k p_ens[k] | (pre-calibration, for class selection) |

| | |
|---|---|
| conf = p_cal[ŷ] | (calibrated confidence for routing) |

```
Worked example:
  p_cnn = [0.82, 0.14, 0.04] (A_win, B_win, Draw)
  p_lstm = [0.71, 0.23, 0.06]
  α = 0.72 (from EA Sports FC game registry)
  p_ens = 0.72·[0.82,0.14,0.04] + 0.28·[0.71,0.23,0.06]
    = [0.590, 0.101, 0.029] + [0.199, 0.064, 0.017]
    = [0.789, 0.165, 0.046]
  ŷ = A_win (argmax)
  logit = log(0.789/(1−0.789)) = log(3.755) = 1.324
  p_cal = sigmoid(1.05 · 1.324 + 0.12) = sigmoid(1.510) = 0.819
  → Confidence 81.9% → Manual review queue (0.80 ≤ 0.819 < 0.95)
```

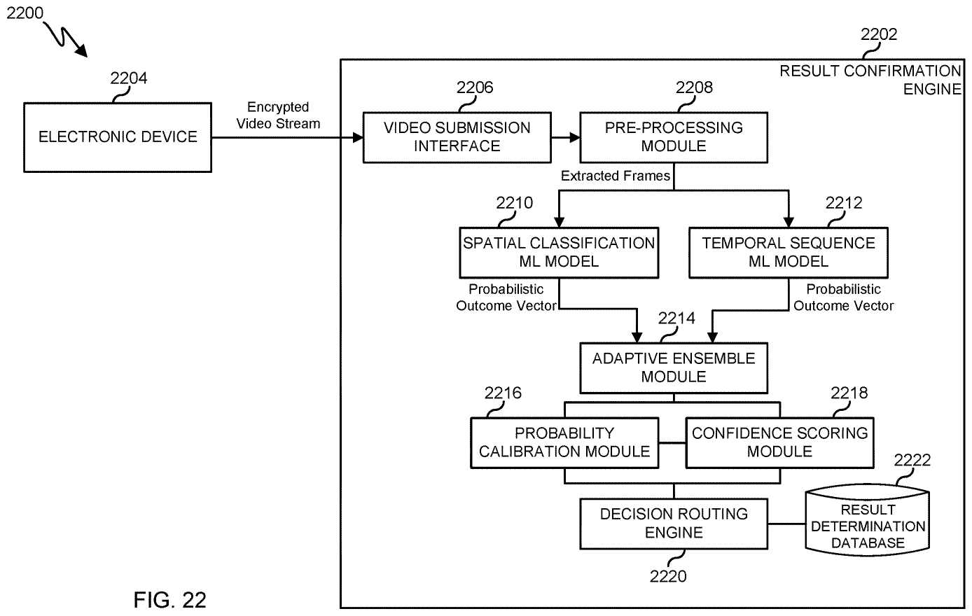

FIG. 22 illustrates an example confirmation engine system architecture 2200 in accordance with this disclosure. For ease of explanation, the architecture 2200 shown in FIG. 22 can be described as being performed or implemented by using the server 106 in the network configuration 100 of FIG. 1. However, the architecture 2200 could be performed or implemented using any other suitable device(s), such as the electronic device 101 or a combination of devices, and in any other suitable system(s).

As shown in FIG. 22, the architecture 2200 includes a result confirmation engine 2202, which may executed by one or more servers, such as the server 106. As shown in FIG. 22, an electronic device 2204, such as the electronic device 101 running the PUP application and capturing video of match gameplay, transmits a video stream over an encrypted channel to the server executing the result confirmation engine 2202 via a video submission interface 2206.

In some embodiments, the result confirmation engine employs a hybrid deep learning architecture composed of a frame-level convolutional neural network (CNN), a sequence-level bidirectional LSTM with attention, a per-game weighted ensemble layer, a probability calibration module, and a confidence-based decision router.

For example, as shown in FIG. 22, a preprocessing module 2208 is configured to extract and normalize video frames and detect one or more predefined regions of interest corresponding to game-result indicators. One or more ML/AI models use the frames extracted by the preprocessing model to determine match outcomes based on the video stream. As one example, as shown in FIG. 22, a spatial classification ML model 2210 can be used to analyze visual features of extracted video frames and generate a first probabilistic outcome vector. Additionally or alternatively, a temporal sequence ML model 2212 can be used to process a sequence of frame embeddings and to generate a second probabilistic outcome vector.

As further shown in FIG. 22, an adaptive ensemble module 2214 can be included in the architecture 2200, in embodiments in which both the spatial classification ML model 2210 and the temporal sequence ML model 2212 are both used, to combine the first and second probabilistic outcome vectors using a dynamically optimized weighting parameter, which can be specific to a game title in various embodiments. The architecture 2200 also includes a probability calibration module 2216 configured to adjust probability magnitudes to improve confidence reliability, a confidence scoring module 2218 to compute confidence scores for the determined outcome, and a decision routing engine 2220 configured to automatically confirm, escalate, or defer a result based on one or more confidence thresholds. In some embodiments, the architecture 2200 can include a result determination database 2222 to store/record/log outcome.

In various embodiments, the architecture 2200 processes the submitted gameplay video to produce a probabilistic classification across the outcome space, which can be represented as follows.

$$y ∈ \{ Player A Win , Player B Win , Draw \}$$

The ensemble framework ensures robustness across static UI-based outcome displays (well-handled by CNNs), temporal progression cues and transition effects (well-handled by LSTMs), platform-specific rendering variability, and video compression artifacts and streaming degradation.

Although FIG. 22 illustrates one example of a confirmation engine system architecture 2200, various changes may be made to FIG. 22. For example, various components and functions in FIG. 22 may be combined, removed, further subdivided, replicated, or rearranged according to particular needs. Also, one or more additional components and functions may be included if needed or desired.

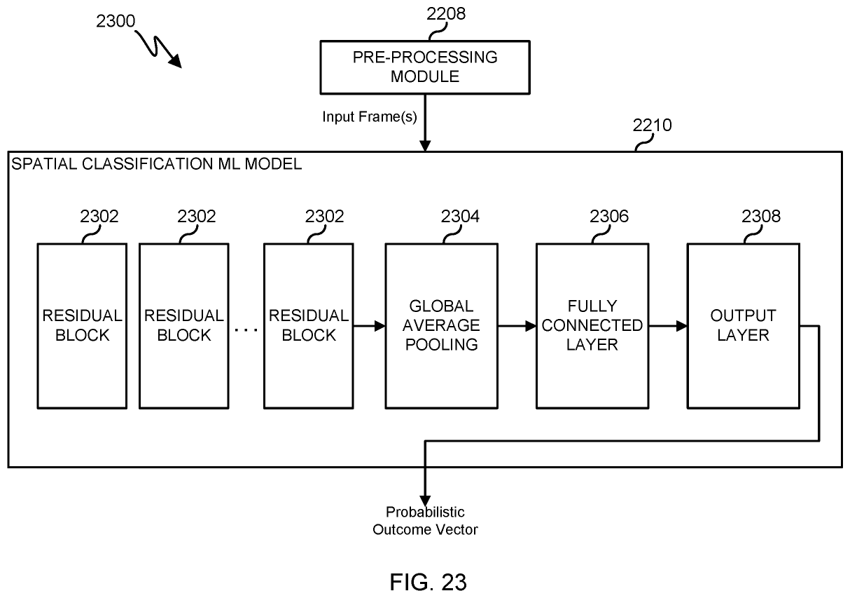

FIG. 23 illustrates an example spatial classification ML model architecture 2300 in accordance with this disclosure. For ease of explanation, the architecture 2300 shown in FIG. 23 can be described as being performed or implemented by using the server 106 in the network configuration 100 of FIG. 1. However, the architecture 2300 could be performed or implemented using any other suitable device(s), such as the electronic device 101 or a combination of devices, and in any other suitable system(s).

As shown in FIG. 23, the architecture 2300 includes the spatial classification ML model 2210 that operates on the frame-level using input frames received from the preprocessing module 2208. In various embodiments, the frame-level CNN architecture 2300 uses a CNN model that operates on high-confidence Regions of Interest (ROI) in captured gameplay videos, such as scoreboards and winner banners. Preprocessing by the preprocessing module 2208 can be used to perform ROI detection and cropping, resizing frames to a fixed resolution (e.g., 224×224×3), and data normalization.

The CNN architecture can also include a backbone that includes a residual convolutional architecture (e.g., ResNet-50 class). For example, as shown in FIG. 23, the spatial classification ML model 2210 can include a plurality of residual blocks 2302 (which can include operations such as convolution, batch normalization (Batch Norm) and/or rectified linear units (ReLU) operations). In various embodiments, the spatial classification ML model 2210 can also include a global average pooling layer 2304, a fully connected layer 2306, and an output layer 2308 that outputs the probabilistic outcome vector. It will be understood that other layers or layer features of the architecture 2300 could be used, and that the CNN architectures shown in FIG. 23 can come in variety of structural variations without departing from the scope of this disclosure.

As shown in FIG. 23, the spatial classification ML model 2210 comprises a multi-layer convolutional neural network that extracts invariant spatial features from detected result-display regions. The network outputs a normalized probability distribution across predefined match outcomes. In various embodiments, the output layer 2308 generates the output probabilities using a softmax function applied to learned log its. In various embodiments, spatial classification ML model 2210 uses residual connections, batch normalization, and/or dropout regularization. In various embodiments, the spatial classification ML model 2210 performs processing of cropped score display regions.

The convolutional architecture extracts invariant feature representations, which can be represented as follows.

$$ϕ = {f}_{c nn} ( x )$$

Here, x is the processed frame and φ∈ [symbol] ^{d} is the learned feature embedding.

In various embodiments, the CNN architecture can include a classification head, which can be represented as follows.

$$\begin{matrix}{z}^{( c )} = {W}_{c} ϕ + {b}_{c} \\ {P}_{CNN} ( y = k \vert x ) = \frac{{e}^{{z}_{k}^{( c )}}}{{\sum }_{j = 1}^{3} {e}^{{z}_{j}^{( c )}}}\end{matrix}$$

In various embodiments, The CNN is optimized to detect high-signal UI elements and is particularly effective when outcome information is visually explicit.

Although FIG. 23 illustrates one example of a spatial classification ML model architecture 2300, various changes may be made to FIG. 23. For example, various components and functions in FIG. 23 may be combined, removed, further subdivided, replicated, or rearranged according to particular needs. Also, one or more additional components and functions may be included if needed or desired.

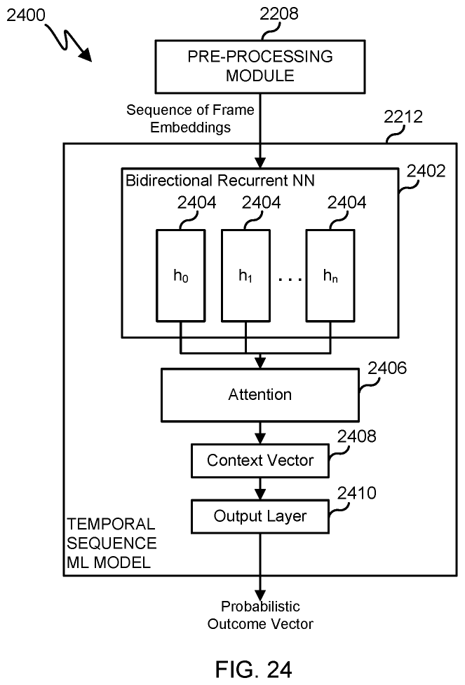

FIG. 24 illustrates an example temporal sequence ML model architecture 2400 in accordance with this disclosure. For ease of explanation, the architecture 2400 shown in FIG. 24 can be described as being performed or implemented by using the server 106 in the network configuration 100 of FIG. 1. However, the architecture 2400 could be performed or implemented using any other suitable device(s), such as the electronic device 101 or a combination of devices, and in any other suitable system(s).

As shown in FIG. 24, the architecture 2400 includes the spatial classification ML model 2212 that operates on the sequence-level using input frames received from the preprocessing module 2208. In various embodiments, the sequence-level temporal model (e.g., BiLSTM+Attention) can be used to capture temporal consistency and sequence-level context, and sampled frame features are passed into a bidirectional LSTM network.

As shown in FIG. 24, the temporal sequence ML model 2212 receives a sequence of frame-level feature embeddings. A bidirectional recurrent neural network 2402 encodes temporal dependencies using a plurality of hidden states 2404 that each receive a time sequence input with respect to the sequence of video frames. An attention mechanism 2406 computes weighted importance values across time steps, and a context vector 2408 is generated and mapped to a probabilistic outcome distribution. An output layer, which can be configured to perform a softmax function, outputs the probabilistic outcome vector for the spatial classification ML model 2212. In various embodiments, the spatial classification ML model 2212 provides for temporal consistency validation, attention-based weighting of match-ending frames, and/or sequence-level fraud resistance. It will be understood that other layers or layer features of the architecture 2400 could be used, and that the LSTM architectures shown in FIG. 24 can come in variety of structural variations without departing from the scope of this disclosure.

A feature sequence can be used for the sequence-level temporal model, which can be represented as follows.

$$For frames t = 1 … T$$

$${ϕ}_{t} = {f}_{cnn} ( {x}_{t} )$$

In various embodiments, the operation of the bidirectional LSTM can be represented as follows.

$${h}_{t} = BiLSTM ( {ϕ}_{t} , {h}_{t - 1} )$$

This captures forward and backward temporal dependencies.

In various embodiments, the attention mechanism of the LSTM uses attention scores, which can be represented as follows.

$${α}_{c} = \frac{exp ( s ( {h}_{c} ) )}{{\sum }_{i = 1}^{T} exp ( s ( {h}_{i} ) )}$$

In various embodiments, the context vector for the LSTM can be represented as follows.

$$c = {\sum }_{t = 1}^{T} {α}_{t} {h}_{t}$$

In various embodiments, the output layer of the LSTM can be represented as follows.

$$\begin{matrix}{z}^{( ℓ )} = {W}_{ℓ} c + {b}_{ℓ} \\ {P}_{LSTM} ( y = k ) = \frac{{e}^{{z}_{k}^{( ℓ )}}}{{\sum }_{j = 1}^{3} {e}^{{z}_{j}^{( ℓ )}}}\end{matrix}$$

The LSTM model can be particularly effective for end-of-match transition animations, sequential score evolution validation, and temporal anti-spoof consistency checks.

Although FIG. 24 illustrates one example of a temporal sequence ML model architecture 2400, various changes may be made to FIG. 24. For example, various components and functions in FIG. 24 may be combined, removed, further subdivided, replicated, or rearranged according to particular needs. Also, one or more additional components and functions may be included if needed or desired.

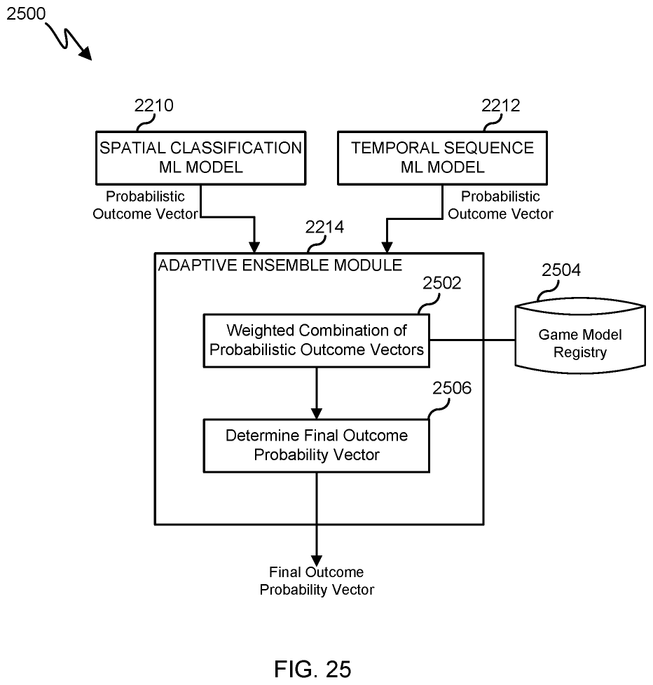

FIG. 25 illustrates an example adaptive ensemble process 2500 in accordance with this disclosure. For ease of explanation, the process 2500 shown in FIG. 25 can be described as being performed or implemented by using the server 106 in the network configuration 100 of FIG. 1. However, the process 2500 could be performed or implemented using any other suitable device(s), such as the electronic device 101 or a combination of devices, and in any other suitable system(s).

In various embodiments of this disclosure only one of the spatial classification ML model 2210 or the temporal sequence ML model 2212 can be used to determine match outcomes. In some embodiments, both the spatial classification ML model 2210 and the temporal sequence ML model 2212 can be used along with ensemble integration in which the CNN and LSTM outputs are combined using a per-game weighted probabilistic ensemble. As shown in FIG. 25, the adaptive ensemble module 2214 receives a first probabilistic outcome vector from the spatial classification ML model 2210 and a second probabilistic outcome vector from the temporal sequence ML model 2212.

In various embodiments, a weighting parameter w_{g} can be specific to a game title, optimized using validation performance metrics, and constrained within a bounded interval. The weighting parameter can be stored in a game model registry 2504 in various embodiments. In some embodiments, the weight parameter can be optimized by minimizing a negative log-likelihood objective over labeled validation samples. In some embodiments, the weight is periodically recalculated in response to performance drift.

For example, in some embodiments, production inference Outputs can be monitored using a performance monitoring module and/or a drift detection engine, and a revalidation procedure can be performed to adjust and/or re-optimize the weight parameter(s). This may also involve optional model fine-tuning and controlled redeployment of the ML/AI models.

For example, in some embodiments, the system continuously monitors a rolling accuracy, a negative log-likelihoods, a confidence distribution, and/or class imbalance metrics. In various embodiments, a drift detection engine can trigger weight re-optimization, model retraining, and/or calibration adjustment. Updated parameters can be deployed to production under governance controls. Thus, this provides for adaptive learning systems, continuous performance monitoring, and automated model governance in competitive gaming environments.

Using the first and second probabilistic outcome vectors, the adaptive ensemble module computes a weighted combination 2502 of the multiple probabilistic outputs. For example, for a game g:

$${P}_{ens , g} ( y = k ) = {w}_{g} {P}_{CNN , g} ( y = k ) + ( 1 - {w}_{g} ) {P}_{LSTM , g} ( y = k )$$

$$where :$$

$$0 \leq {w}_{g} \leq 1$$

The ensemble integration approach enables adaptation to title-specific characteristics, such as static scoreboard dominance (higher w_{g}), and temporal animation dominance (lower w_{g}).

As also shown in FIG. 25, the adaptive ensemble module 2214 performs a determination 2506 to determine a final outcome probability vector. The final predicted outcome for the ensemble integration approach can be represented as follows.

$$\hat{y} = arg {max}_{k} {P}_{ens , g} ( y = k )$$

Although FIG. 25 illustrates one example of an adaptive ensemble process 2500, various changes may be made to FIG. 25. For example, various components and functions in FIG. 25 may be combined, removed, further subdivided, replicated, or rearranged according to particular needs. Also, one or more additional components and functions may be included if needed or desired.

In various embodiments, the training methodology for the ML/AI models can include using a supervised objective. For example, for labeled dataset (xᵢ′yᵢ), the supervised loss can be represented as follows.

$${ℒ}_{CE} = - {\sum }_{i = 1}^{3} {y}_{ik} log P ( y = k \vert {x}_{i} )$$

The training can further use regularization, which can be represented as follows.

$${ℒ}_{reg} = λ {‖ θ ‖}_{2}^{2}$$

A total loss using both the supervised loss and regularization can be represented as follows.

$$ℒ = {ℒ}_{CE} + {ℒ}_{reg}$$

In various embodiments, the CNN and LSTM models are trained independently or jointly depending on dataset volume and overfitting risk. In various embodiments, per-game weight optimization can be performed where weights w_{g} are optimized using validation performance specific to each game title. The per-game weight optimization can use an objective, which can be represented as follows.

$${w}_{g}^{*} = arg {min}_{w ∈ [ 0 , 1 ]} - {{\sum }_{i = 1}}^{{M}_{g}} log ( w {P}_{CNN , i} ( {y}_{i} ) + ( 1 - w ) {P}_{LSTM , i} ( {y}_{i} ) )$$

Optimization is performed using bounded one-dimensional search.

In various embodiments, a regularized weight update can be used to prevent instability for small validation sets, which can be represented as follows.

$${w}_{g , new} = \frac{{M}_{g}}{{M}_{g} + κ} {w}_{g}^{*} + \frac{κ}{{M}_{g} + κ} {w}_{0}$$

Here, w₀=global prior, κ=smoothing constant, and M_{g}=validation sample size.

Factors influencing weight adjustments/recalibration can include performance drift (e.g., rolling validation NLL or accuracy degradation), game UI updates (e.g., scoreboard layout changes affecting CNN reliability), video quality distribution shifts (e.g., changes in resolution, compression, or frame rate), class imbalance shifts (e.g., altered frequency of draws or rare outcomes), fraud pattern evolution (e.g., adversarial manipulation patterns affecting one model more than the other), and/or platform context changes (e.g., console vs PC vs cloud streaming artifacts).

In various embodiments, an optional extension of the ensemble integration can be represented as follows.

$${P}_{ens} ( y ) = {w}_{g , c} {P}_{CNN} ( y ) + ( 1 - {w}_{g , c} ) {P}_{LSTM} ( y )$$

Here, c represents capture context (e.g., resolution band, platform type, FPS range).

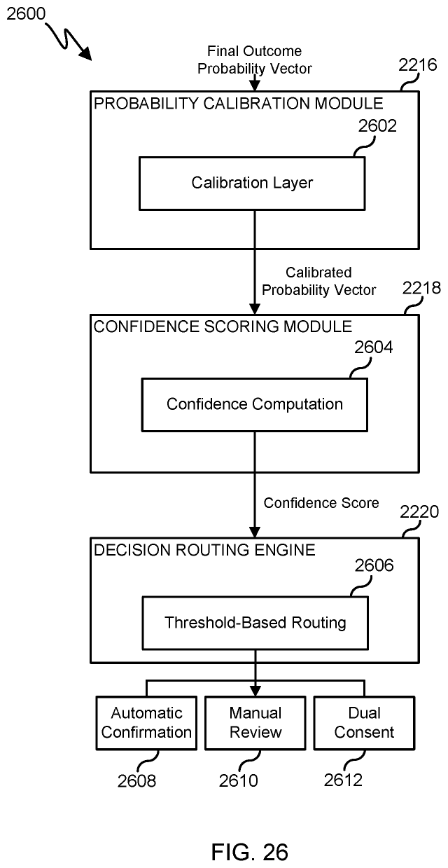

FIG. 26 illustrates an example confidence calibration and decision routing architecture 2600 in accordance with this disclosure. For ease of explanation, the architecture 2600 shown in FIG. 26 can be described as being performed or implemented by using the server 106 in the network configuration 100 of FIG. 1. However, the architecture 2600 could be performed or implemented using any other suitable device(s), such as the electronic device 101 or a combination of devices, and in any other suitable system(s).

As shown in FIG. 26, the architecture 2600 includes the probability calibration module 2216, which can receive a final outcome probability vector, such as from the adaptive ensemble module, or from one of the spatial classification ML model 2210 or the temporal sequence ML model 2212 in embodiments that do not use the adaptive ensemble features. In various embodiments, probability calibration can be performed to ensure reliable confidence scoring. In some embodiments, the probability calibration module 2216 includes a calibration layer 2602 that performs temperature scaling, which given log its z, can be represented as follows.

$${P}_{cal} ( y = k ) = \frac{{e}^{{z}_{k} / T}}{{\sum }_{j} {e}^{{z}_{j} / T}}$$

Here, temperature T is learned on validation data by minimizing negative log-likelihood. Applying temperature scaling to model log its improves probability calibration. This probability calibration can be used to improve threshold routing accuracy, manual review rate stability, and risk-based decision control.

In various embodiments, the architecture 2600 further performs confidence scoring, such as using the confidence scoring module 2604, and decision routing, such as using the decision routing engine 2220. In some embodiments, the confidence scoring module 2604 receives a calibrated probability vector from the probability calibration module 2216, and the confidence scoring module 2218 performs a confidence computation provide a confidence score. The confidence may be computed as a maximum probability to provide a maximum probability value, which can be represented as follows.

$$Conf = {max}_{k} {P}_{final} ( y = k )$$

In some embodiments, confidence may be computed using a entropy-based certainty metric, which can be represented as follows.

$$Conf = 1 - \frac{- {\sum }_{k} {P}_{k} log {P}_{k}}{log 3}$$

The decision routing engine 2220 performs threshold-based routing 2606 by comparing the confidence score to one or more thresholds to determine how to route the result determination. For example, in some embodiments the decision routing engine 2220 compares the confidence score to at least two thresholds to determine automated versus human-mediated resolution. In some embodiments, the decision routing engine can, based on the confidence score as compared to the threshold(s) route to an automatic confirmation 2608 (e.g., based on high confidence), manual review 2610 (e.g., based on a confidence between the automatic confirmation threshold and a dual consent or arbitration threshold), and dual consent (or arbitration) 2612 (e.g., based on low confidence).

For example, this routing logic can include the following.

$$\begin{matrix}Conf \geq {τ}_{auto} \to Automatic confirmation \\ {τ}_{review} \leq Conf < {τ}_{auto} \to Manual review \\ Conf < {τ}_{review} \to Dual - consent or arbitration process\end{matrix}$$

Here, thresholds can be selected to meet target precision and risk tolerance levels.

Although FIG. 26 illustrates one example of a confidence calibration and decision routing architecture 2600, various changes may be made to FIG. 26. For example, various components and functions in FIG. 26 may be combined, removed, further subdivided, replicated, or rearranged according to particular needs. Also, one or more additional components and functions may be included if needed or desired.

The ML/AI models of this disclosure thus provide, in various embodiments, for a combined CNN+BiLSTM architecture with per-game optimized ensemble weighting that offers cross-title adaptability, temporal and spatial robustness, calibrated probabilistic outputs, confidence-driven automation control, and structured drift and update governance, as well as scalable, defensible, and verifiable result confirmation across heterogeneous competitive gaming environments.

In various embodiments, parallel to the classification pipeline, a fraud anomaly score is computed. If this score exceeds threshold τ_fraud, the match is flagged regardless of classification confidence.

TABLE 23
Fraud Detection Scoring

Anomaly score components:

| | |
|---|---|
| s_fps = \|mean_fps − target_fps\| / target_fps | [frame rate deviation] |
| s_comp = compression_artifact_level ∈ [0,1] | [re-encoding detection] |
| s_ui = 1 − UI_element_match_score ∈ [0,1] | [expected UI present?] |
| s_score = score_progression_violation ∈ {0,1} | [impossible score jump?] |

```
  Fraud_score = w1·s_fps + w2·s_comp + w3·s_ui + w4·s_score
  w = [0.15, 0.30, 0.35, 0.20] (trained on adversarial examples)
  Flag if Fraud_score > τ_fraud = 0.60
  (Flagged matches go directly to manual arbitration regardless of conf)
```

Fraud detection integration can include incorporating in the ML pipeline adversarial detection through temporal consistency analysis involving detecting unnatural frame rate variations suggesting video splicing, compression artifact analysis involving identifying re-encoding artifacts indicating video manipulation, UI element verification involving confirming expected game UI elements appear in expected positions, and/or score progression validation involving verifying score changes follow game rules (no impossible scores).

In various embodiments, continuous learning for the ML/AI models can be employed, such as shown below.

TABLE 24
Dataset by Stage

| | Minimum | | |
|---|---|---|---|
| Phase | Matches | Label Source | Notes |
| Cold start | 200 labeled | Manual review team + | α locked at 0.5; coarse |
| (new game) | matches | Option A API (ground | grid search; limited |
| | | truth) | auto-accept |
| Warm (basic | 500 | Mix: API + manual | CNN/LSTM trained; α |
| models) | matches | | optimized; 0.95 auto-accept |
| | | | threshold active |
| Production | 2,000+ | Primarily API; manual | Full pipeline; fraud models |
| (full) | matches | for edge cases | tuned; calibration stable |
| Continuous | +100 | API ground truth | Rolling retrain; α re-optimized; |
| update | matches/month | (primary) | accuracy monitoring active |

TABLE 25
Continuous Learning Trigger Logic

```
Monitor rolling_7d_accuracy (computed nightly):
  rolling_7d_accuracy = TP_7d / N_7d
  where N_7d = matches auto-resolved in last 7 days
    TP_7d = matches where auto-result = Option A ground truth
Trigger retrain if:
  rolling_7d_accuracy < (baseline_accuracy − 0.03)
OR
  new_matches since_last_train ≥ retrain_interval[game_tier]
  game_tier A (>10K matches/mo): retrain_interval = 500
```

| | |
|---|---|
| game_tier B (1K-10K/mo): | retrain interval = 1000 |
| game_tier C (<1K/mo): | retrain interval = 2000 |

Post-retrain: Re-run α optimization on updated val set.
Deploy via blue-green with 10% traffic shadow for 24h before full rollout.

The ML/AI-based result verification system described in this disclosure represents a specific implementation of a generalizable outcome verification framework. This framework can be adapted to verify outcomes across diverse competition types.

TABLE 26
Verification Modalities

| Modality | Data Source | ML Approach | Example Applications |
|---|---|---|---|
| Video | Camera/screen | CNN + temporal | Gaming, physical sports, |
| Analysis | capture | analysis | creative challenges |
| GPS Trace | Mobile device | Trajectory ML, | Running, cycling, |
| Analysis | location | anomaly detection | scavenger hunts |
| Biometric | Wearables, | Time series analysis | Fitness challenges, |
| Data | health APIs | | health goals |
| Audio | Microphone | Speech recognition, | Trivia, spelling, music |
| Analysis | input | audio classification | performance |
| Text | Keyboard input | NLP, typing pattern | Writing challenges, |
| Analysis | | analysis | coding competitions |
| API Data | Third-party | Data validation, | Connected app challenges, |
| Ingestion | services | anomaly detection | professional metrics |
| Multi-Party | Participant | Byzantine fault | Social challenges, |
| Attestation | consensus | tolerance | subjective competitions |

Each verification modality requires calibrated confidence thresholds, as shown below.

TABLE 27
Confidence Calibration by Modality

| | Auto-Accept | Manual Review | Attestation |
|---|---|---|---|
| Modality | Threshold | Threshold | Fallback |
| Video (Gaming) | 95% | 80% | Yes |
| Video (Physical | 90% | 75% | Yes |
| Sports) | | | |
| GPS Trace | 98% | 90% | Yes |
| Biometric (Heart | 85% | 70% | Yes |
| Rate) | | | |
| Audio (Speech) | 92% | 80% | Yes |
| API Data | 99% | 95% | No |
| | | | (authoritative) |
| Multi-Party | 100% consensus | Majority | N/A |
| Attestation | | | |

Each application domain presents unique fraud vectors.

TABLE 28
Fraud Detection by Domain

| Domain | Fraud Vectors | Detection Methods |
|---|---|---|
| Gaming | Screen recording manipulation, | Video authenticity ML, input |
| | account sharing, collusion | pattern analysis, collusion |
| | | network detection |
| Fitness | GPS spoofing, device sharing, | Accelerometer correlation, |
| | mechanical simulation | heartrate plausibility, |
| | | speed/cadence physics |
| Educational | Answer sharing, AI assistance, | Proctoring ML, AI-text detection, |
| | impersonation | keystroke dynamics |
| Creative | Plagiarism, AI generation, | Reverse search, AI generation |
| | prior work submission | detection, metadata analysis |
| Professional | Data manipulation, metric gaming | Anomaly detection, temporal |
| | | pattern analysis, multi-source |
| | | verification |

API endpoints associated with this disclosure can include the following.

TABLE 29
API Endpoints

| Endpoint | Method | Purpose |
|---|---|---|
| /v1/wagers | POST | Create wager offer (fiat, |
| | | crypto, Pony Up Coins) |
| /v1/escrow/hold | POST | Pre-authorize funds, FX |
| | | conversion, tax calculation |
| /v1/match/verify | POST | Submit result payload, |
| | | synchronous/asynchronous |
| | | reporting |
| /v1/escrow/release | POST | Trigger settlement, payout |
| | | options, partner wallet/store |
| | | integration |
| /v1/user/verify | POST | Age, skill-level, and KYC |
| | | verification |
| /v1/social/share | POST | Promote win to social media |
| /api/v1/stream/initiate | POST | Initiates video streaming |
| | | session for ML-based result |
| | | determination, Returns: |
| | | Stream endpoint, session ID, |
| | | auth token |
| /api/v1/stream/upload | POST | Uploads video chunks during |
| | | gameplay, Headers: Session |
| | | ID, auth token, Body: Video |
| | | data (base64 encoded) |
| /api/v1/result/ | GET | Retrieves result determination |
| status/{matchId} | | status, Returns: Status |
| | | (pending/determined), |
| | | confidence score, method |
| | | used |
| /api/v1/result/ | POST | Submits match for manual |
| manual-review | | review when ML confidence |
| | | low, Body: Match ID, user- |
| | | reported outcome, evidence |
| | | (optional) |

Terms that may be applicable to this disclosure include the following, although it will be understood that aspects of this disclosure are not necessarily limited to the below definitions.

TABLE 30
Definitions

| Term | Definition |
|---|---|
| KYC/AML | Know-Your-Customer/Anti-Money- |
| | Laundering |
| SDK | Software Development Kit |
| MAU | Monthly Active Users |
| FX | Foreign Exchange |
| Pony Up Coins | Native digital currency of the Pony Up |
| | platform |
| Community Challenge | Peer-to-peer wager on a real-world or digital |
| | event outside traditional gaming |
| Encoder Service | Server-side component that processes video |
| | streams from clients, extracting frames and |
| | preparing them for ML analysis |
| Classifier Service | ML-powered service that analyzes game |
| | footage to determine match outcomes using |
| | trained neural networks |
| Confidence Scoring | Estimation (e.g., Bayesian) of result |
| | determination reliability, used to route to |
| | automatic acceptance or manual review |
| Dual-Path Verification | System design enabling both API-based and |
| | ML-based result determination with |
| | intelligent selection |
| Stateless Services | Front-door microservices that don't maintain |
| | session state, enabling horizontal scalability |
| Stateful Core Services | Backend engines maintaining state (order |
| | books, escrow balances) with strict access |
| | controls |
| Security Tenant | Isolated security context with dedicated |
| | authentication and authorization rules |
| Hot/Warm/Cold | Tiered data architecture optimizing for real- |
| Data Paths | time, near-real-time, and batch processing |
| | needs |

In various examples of this disclosure, a method comprises receiving, via an encrypted connection and based on a determination that an application programming interface (API) integration is not available for gameplay content, a video stream of the gameplay content captured from a client device, processing the video stream by an encoder to extract key frames from the video stream, applying, using at least one machine learning model and the extracted key frames, machine learning classifiers trained on game-specific visual patterns to determine a gameplay result associated with the video stream, generating, using the at least one machine learning model, a confidence score for the determined gameplay result, and transmitting, to the client device based on a determination that the confidence score is above a threshold, an outcome of a peer-to-peer challenge corresponding to the determined gameplay result.

In one or more of the above examples, generating the confidence score comprises calculating a weighted average of individual model predictions of the at least one machine learning model, wherein weights for the weighted average are dynamically adjusted based on historical accuracy of the at least one machine learning model for a type of gameplay content associated with the gameplay content.

In one or more of the above examples, the at least one machine learning model comprises at least three machine learning models, and wherein generating the confidence score comprises performing a Bayesian inference that combines outputs from the at least three machine learning models to generate a composite confidence score.

In one or more of the above examples, the at least one machine learning model comprises at least one convolutional neural network trained to perform visual pattern recognition of the gameplay content, and at least one recurrent neural network trained to perform temporal sequence analysis of the gameplay content, wherein the at least one convolutional neural network and the at least one recurrent neural network are configured to operate in ensemble to determine the gameplay result.

In one or more of the above examples, the at least one machine learning model is trained using at least one transfer learning model that is pre-trained on general image recognition tasks and fine-tuned on gameplay-specific visual patterns including score displays, winner announcements, and victory screens.

In one or more of the above examples, the determination that the API integration is not available for the gameplay content is based on a pre-match initiation query to a registry database that stores API availability status for a plurality of supported game titles.

In one or more of the above examples, the peer-to-peer challenge is a wager and the method further comprises reporting verified results of the determined gameplay result to an escrow system for automated settlement of the wager between participants of the peer-to-peer challenge.

In one or more of the above examples, the method further comprises performing a detection of video manipulation attempts through analysis of compression artifacts, frame rate inconsistencies, and temporal discontinuities associated with the video stream.

In one or more of the above examples, the method further comprises, to extract the key frames, identifying frames corresponding to game state transitions including a match start, score changes, round completions, and a match conclusion.

In one or more of the above examples, the method further comprises correlating key frames of the extracted key frames supporting the determined gameplay result according to timestamps, and generating an evidentiary package containing the correlated key frames.

In various examples of this disclosure, an electronic device comprises at least one processor configured to receive, via an encrypted connection and based on a determination that an application programming interface (API) integration is not available for gameplay content, a video stream of the gameplay content captured from a client device, process the video stream by an encoder to extract key frames from the video stream, apply, using at least one machine learning model and the extracted key frames, machine learning classifiers trained on game-specific visual patterns to determine a gameplay result associated with the video stream, generate, using the at least one machine learning model, a confidence score for the determined gameplay result, and instruct transmission, to the client device based on a determination that the confidence score is above a threshold, of an outcome of a peer-to-peer challenge corresponding to the determined gameplay result.

In one or more of the above examples, to generate the confidence score, the at least one processor is configured to calculate a weighted average of individual model predictions of the at least one machine learning model, wherein weights for the weighted average are dynamically adjusted based on historical accuracy of the at least one machine learning model for a type of gameplay content associated with the gameplay content.

In one or more of the above examples, the at least one machine learning model comprises at least three machine learning models, and wherein, to generate the confidence score, the at least one processor is configured to perform a Bayesian inference that combines outputs from the at least three machine learning models to generate a composite confidence score.

In one or more of the above examples, the at least one machine learning model comprises at least one convolutional neural network trained to perform visual pattern recognition of the gameplay content, and at least one recurrent neural network trained to perform temporal sequence analysis of the gameplay content, wherein the at least one convolutional neural network and the at least one recurrent neural network are configured to operate in ensemble to determine the gameplay result.

In one or more of the above examples, the at least one machine learning model is trained using at least one transfer learning model that is pre-trained on general image recognition tasks and fine-tuned on gameplay-specific visual patterns including score displays, winner announcements, and victory screens.

In one or more of the above examples, the determination that the API integration is not available for the gameplay content is based on a pre-match initiation query to a registry database that stores API availability status for a plurality of supported game titles.

In one or more of the above examples, the peer-to-peer challenge is a wager and the at least one processor is further configured to report verified results of the determined gameplay result to an escrow system for automated settlement of the wager between participants of the peer-to-peer challenge.

In one or more of the above examples, the at least one processor is further configured to perform a detection of video manipulation attempts through analysis of compression artifacts, frame rate inconsistencies, and temporal discontinuities associated with the video stream.

In one or more of the above examples, the at least one processor is further configured to, to extract the key frames, identify frames corresponding to game state transitions including a match start, score changes, round completions, and a match conclusion.

In one or more of the above examples, the at least one processor is further configured to correlate key frames of the extracted key frames supporting the determined gameplay result according to timestamps, and generate an evidentiary package containing the correlated key frames.

In various examples of this disclosure, a system for determining outcomes of skill-based competitions comprises a first determination pathway utilizing service-to-service API integration with game platform providers, a second determination pathway utilizing machine learning analysis of user-provided gameplay video streams, an intelligent routing mechanism that selects between the first and second pathways based on availability of API integration, a confidence scoring component that validates results from the second pathway, and an interface to an automated escrow settlement service, wherein the system verifies match outcomes without requiring game publisher cooperation, enabling platform-agnostic wagering.

In various examples of this disclosure, a method for determining skill-based competition outcomes comprises capturing a video stream of gameplay from a user device during a wagering match, transmitting the video stream to a remote server via encrypted connection, processing the video stream through an encoder to extract key frames, applying machine learning classifiers trained on game-specific visual patterns to determine match winner, generating a confidence score for the determination, automatically routing to manual review if confidence score below threshold, and reporting verified results to an escrow system for automated settlement, wherein the determination is made without access to game publisher APIs or game telemetry.

In various examples of this disclosure, a distributed system architecture for peer-to-peer wagering comprises a stateless services layer handling user requests, wallet operations, compliance screening, and result determination, a stateful core services layer with restricted access handling atomic order matching and settlement, a security tenant architecture enforcing authentication boundaries between layers, an event-driven communication protocol ensuring atomicity across distributed transactions, a multi-currency wallet supporting fiat, cryptocurrency, and platform-specific currencies, and an automated compliance engine with jurisdictional ruleset evaluation, wherein the architecture enables scalable, secure, compliant wagering across multiple gaming platforms.

In various examples of this disclosure, a computer-implemented method for facilitating peer-to-peer wagering on skill-based competitions across heterogeneous computing platforms, comprises receiving, at a first computing device operated by a first user, a wager creation request specifying competition parameters including game title, stake amount, competition timing, and acceptance criteria, validating the first user's eligibility by querying a compliance engine that evaluates the first user's identity verification status, geographic location, and jurisdictional wagering permissions, reserving the specified stake amount from the first user's multi-currency digital wallet by executing an atomic transfer to an escrow account, generating a cryptographically signed invitation token encoding the competition parameters and transmitting the token to a second user, receiving acceptance of the invitation from a second computing device operated by the second user, wherein the second computing device may operate on a different computing platform than the first computing device, validating the second user's eligibility using the compliance engine and reserving a matching stake amount from the second user's digital wallet to the escrow account, coordinating initiation of the skill-based competition between the first and second users through platform-specific application programming interfaces, determining the competition outcome through at least one of: (i) receiving authenticated result data from a game publisher service, or (ii) analyzing a video stream of the competition using machine learning classifiers, calculating settlement amounts by deducting platform fees and applicable tax withholdings from the combined stake amounts, executing atomic release of the escrow account to credit the winning user's digital wallet with the calculated settlement amount, and recording the complete transaction in an immutable audit ledger.

In various examples of this disclosure, a computer-implemented method for training machine learning models to determine outcomes of skill-based video game competitions comprises collecting a training corpus comprising video recordings of completed matches for a target game title, wherein each recording is labeled with verified match outcomes, preprocessing the training corpus by extracting frames at predetermined intervals and identifying regions of interest corresponding to game user interface elements displaying score information, player identification, and match status indicators, training a first convolutional neural network model to recognize visual patterns indicative of match outcomes including victory screens, defeat indicators, and final score displays, training a second recurrent neural network model to recognize temporal patterns in match progression indicative of match conclusions, combining outputs of the first and second models using an ensemble voting mechanism with learned weights, validating the combined model against a held-out test set and calculating accuracy metrics, deploying the validated model to a production inference service accessible via application programming interface, monitoring production inference accuracy and triggering model retraining when accuracy falls below a predetermined threshold, and continuously expanding the training corpus with newly verified match recordings to improve model performance.

In various examples of this disclosure, a system for facilitating peer-to-peer skill-based challenges across multiple activity domains comprises a challenge definition module enabling users to specify challenge parameters including activity type, verification method, stake amount, timing constraints, and participant eligibility requirements, a verification method registry mapping activity types to appropriate verification modalities selected from the group consisting of: video analysis, GPS trace analysis, biometric data analysis, audio analysis, text analysis, API data ingestion, and multi-party attestation, a modality-specific verification engine for each supported verification modality, each engine comprising machine learning models trained to verify challenge outcomes and detect fraudulent submissions, a confidence-calibrated routing system that directs verification results to automatic acceptance, manual review, or participant attestation based on confidence scores calibrated for each verification modality, an escrow system for holding participant stakes during challenge execution and releasing funds based on verified outcomes, a compliance engine evaluating challenges against jurisdictional regulations including determination of skill-based versus chance-based classification, and an immutable audit system recording challenge definitions, participant consents, verification evidence, and settlement transactions.

In various examples of this disclosure, a computer-implemented method for verifying outcomes of physical location-based challenges comprises defining a challenge route as an ordered sequence of geographic waypoints with acceptable deviation tolerances, collecting GPS location data from a participant's mobile device at a sampling rate of at least one reading per second during challenge execution, collecting accelerometer data from the participant's mobile device contemporaneously with GPS data, analyzing the GPS trace to determine route completion by calculating geometric similarity between the collected trace and the defined route, analyzing the GPS trace to determine timing by extracting timestamps of route start and completion, validating the GPS trace against fraud indicators including: speed values exceeding human physical limits, temporal discontinuities indicating GPS signal manipulation, and inconsistencies between GPS displacement and accelerometer-measured movement, comparing the participant's completion time against other participants or defined benchmarks to determine challenge outcome, generating a confidence score reflecting the reliability of the verification, and reporting the verified outcome to an escrow settlement system when the confidence score exceeds a predetermined threshold.

In one or more of the above examples, the intelligent routing mechanism comprises a registry database storing API availability status for each supported game title, and the routing mechanism queries the registry prior to match initiation to pre-select the determination pathway.

In one or more of the above examples, the confidence scoring component employs Bayesian inference combining outputs from at least three independent machine learning models to generate a composite confidence score.

In one or more of the above examples, the system further comprises an automated fallback mechanism that transitions from the second pathway to a dual-consent verification mode when the confidence score falls below a predetermined threshold.

In one or more of the above examples, the first determination pathway includes anomaly detection algorithms that compare reported match statistics against historical performance baselines to identify potential result manipulation.

In one or more of the above examples, the second determination pathway operates without requiring modification to game software, game publisher cooperation, or access to game telemetry data.

In one or more of the above examples, the machine learning analysis of the second pathway comprises convolutional neural networks for visual pattern recognition and recurrent neural networks for temporal sequence analysis operating in ensemble.

In one or more of the above examples, the automated escrow settlement service executes atomic transactions ensuring that fund transfers to winning participants and platform fee deductions occur as a single indivisible operation.

In one or more of the above examples, the system further comprises a jurisdictional compliance engine that evaluates each wager against location-specific regulatory rulesets prior to settlement.

In one or more of the above examples, capturing the video stream comprises encoding at adaptive bitrates between 720p and 1080p resolution at frame rates between 30 and 60 frames per second based on available network bandwidth.

In one or more of the above examples, the machine learning classifiers comprise transfer learning models pre-trained on general image recognition tasks and fine-tuned on game-specific visual patterns including score displays, winner announcements, and victory screens.

In one or more of the above examples, generating the confidence score comprises calculating a weighted average of individual model predictions, wherein weights are dynamically adjusted based on historical accuracy of each model for the specific game title.

In one or more of the above examples, the method further comprises detecting video manipulation attempts through analysis of compression artifacts, frame rate inconsistencies, and temporal discontinuities.

In one or more of the above examples, extracting key frames comprises identifying frames corresponding to game state transitions including match start, score changes, round completions, and match conclusion.

In one or more of the above examples, the method operates across multiple gaming platforms including but not limited to console systems, personal computers, mobile devices, cloud gaming services, and virtual reality systems without platform-specific modifications to the analysis pipeline.

In one or more of the above examples, the method further comprises generating an evidentiary package containing timestamp-correlated key frames supporting the outcome determination for use in dispute resolution.

In one or more of the above examples, the predetermined threshold for routing to manual review is dynamically adjusted based on wager value, with higher-value wagers requiring higher confidence thresholds.

In one or more of the above examples, the stateless services layer implements horizontal auto-scaling based on request volume metrics.

In one or more of the above examples, the security tenant architecture implements mutual TLS authentication between the stateless and stateful layers with certificate pinning.

In one or more of the above examples, the event-driven communication protocol implements exactly-once delivery semantics using idempotency keys and transactional outbox patterns.

In one or more of the above examples, the multi-currency wallet maintains separate ledger accounts for each currency type with real-time exchange rate integration for cross-currency settlements.

In one or more of the above examples, the automated compliance engine maintains immutable audit logs in append-only data structures for regulatory examination.

Although this disclosure has been described with an exemplary embodiment, various changes and modifications may be suggested to one skilled in the art. It is intended that this disclosure encompass such changes and modifications as fall within the scope of the appended claims.

What is claimed is:

1. A method comprising:
receiving, via an encrypted connection and based on a determination that an application programming interface (API) integration is not available for gameplay content, a video stream of the gameplay content captured from a client device;
processing the video stream by an encoder to extract key frames from the video stream;
applying, using at least one machine learning model and the extracted key frames, machine learning classifiers trained on game-specific visual patterns to determine a gameplay result associated with the video stream;
generating, using the at least one machine learning model, a confidence score for the determined gameplay result; and
transmitting, to the client device based on a determination that the confidence score is above a threshold, an outcome of a peer-to-peer challenge corresponding to the determined gameplay result.

2. The method of claim 1, wherein generating the confidence score comprises calculating a weighted average of individual model predictions of the at least one machine learning model, wherein weights for the weighted average are dynamically adjusted based on historical accuracy of the at least one machine learning model for a type of gameplay content associated with the gameplay content.

3. The method of claim 1, wherein the at least one machine learning model comprises at least three machine learning models, and wherein generating the confidence score comprises performing a Bayesian inference that combines outputs from the at least three machine learning models to generate a composite confidence score.

4. The method of claim 1, wherein the at least one machine learning model comprises:
at least one convolutional neural network trained to perform visual pattern recognition of the gameplay content; and
at least one recurrent neural network trained to perform temporal sequence analysis of the gameplay content,
wherein the at least one convolutional neural network and the at least one recurrent neural network are configured to operate in ensemble to determine the gameplay result.

5. The method of claim 1, wherein the at least one machine learning model is trained using at least one transfer learning model that is pre-trained on general image recognition tasks and fine-tuned on gameplay-specific visual patterns including score displays, winner announcements, and victory screens.

6. The method of claim 1, wherein the determination that the API integration is not available for the gameplay content is based on a pre-match initiation query to a registry database that stores API availability status for a plurality of supported game titles.

7. The method of claim 1, wherein the peer-to-peer challenge is a wager and the method further comprises reporting verified results of the determined gameplay result to an escrow system for automated settlement of the wager between participants of the peer-to-peer challenge.

8. The method of claim 1, further comprising performing a detection of video manipulation attempts through analysis of compression artifacts, frame rate inconsistencies, and temporal discontinuities associated with the video stream.

9. The method of claim 1, further comprising, to extract the key frames, identifying frames corresponding to game state transitions including a match start, score changes, round completions, and a match conclusion.

10. The method of claim 1, further comprising:
correlating key frames of the extracted key frames supporting the determined gameplay result according to timestamps; and
generating an evidentiary package containing the correlated key frames.

11. An electronic device comprising:
at least one processor configured to:
receive, via an encrypted connection and based on a determination that an application programming interface (API) integration is not available for gameplay content, a video stream of the gameplay content captured from a client device;
process the video stream by an encoder to extract key frames from the video stream;
apply, using at least one machine learning model and the extracted key frames, machine learning classifiers trained on game-specific visual patterns to determine a gameplay result associated with the video stream;
generate, using the at least one machine learning model, a confidence score for the determined gameplay result; and
instruct transmission, to the client device based on a determination that the confidence score is above a threshold, of an outcome of a peer-to-peer challenge corresponding to the determined gameplay result.

12. The electronic device of claim 11, wherein, to generate the confidence score, the at least one processor is configured to calculate a weighted average of individual model predictions of the at least one machine learning model, wherein weights for the weighted average are dynamically adjusted based on historical accuracy of the at least one machine learning model for a type of gameplay content associated with the gameplay content.

13. The electronic device of claim 11, wherein the at least one machine learning model comprises at least three machine learning models, and wherein, to generate the confidence score, the at least one processor is configured to perform a Bayesian inference that combines outputs from the at least three machine learning models to generate a composite confidence score.

14. The electronic device of claim 11, wherein the at least one machine learning model comprises:
at least one convolutional neural network trained to perform visual pattern recognition of the gameplay content; and
at least one recurrent neural network trained to perform temporal sequence analysis of the gameplay content,
wherein the at least one convolutional neural network and the at least one recurrent neural network are configured to operate in ensemble to determine the gameplay result.

15. The electronic device of claim 11, wherein the at least one machine learning model is trained using at least one transfer learning model that is pre-trained on general image recognition tasks and fine-tuned on gameplay-specific visual patterns including score displays, winner announcements, and victory screens.

16. The electronic device of claim 11, wherein the determination that the API integration is not available for the gameplay content is based on a pre-match initiation query to a registry database that stores API availability status for a plurality of supported game titles.

17. The electronic device of claim 11, wherein the peer-to-peer challenge is a wager and the at least one processor is further configured to report verified results of the determined gameplay result to an escrow system for automated settlement of the wager between participants of the peer-to-peer challenge.

18. The electronic device of claim 11, wherein the at least one processor is further configured to perform a detection of video manipulation attempts through analysis of compression artifacts, frame rate inconsistencies, and temporal discontinuities associated with the video stream.

19. The electronic device of claim 11, wherein the at least one processor is further configured to, to extract the key frames, identify frames corresponding to game state transitions including a match start, score changes, round completions, and a match conclusion.

20. The electronic device of claim 11, wherein the at least one processor is further configured to:
correlate key frames of the extracted key frames supporting the determined gameplay result according to timestamps; and
generate an evidentiary package containing the correlated key frames.
